(19) United States
(12) Patent Application Publication
(10) Pub. No.: US 2009/0016990 A1
(43) Pub. Date: Jan. 15, 2009

(54) Antimicrobial Compositions

(76) Inventors: Randall S. Alberte, Estero, FL (US); Marc W. Mittelman, Canton, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/019,377

(22) Filed: Jan. 24, 2008

Related U.S. Application Data
(60) Provisional application No. 60/897,147, filed on Jan. 24, 2007.

(51) Int. Cl. A01N 43/62; A01N 37/10; A01N 37/00; A01N 59/12; A01P 1/00; A01N 59/00; A01N 59/20; A01N 37/18

(52) U.S. Cl. 424/85.5; 514/544; 514/616; 514/218; 514/8; 424/85.6; 424/670; 424/616; 424/638; 424/617

(57) ABSTRACT

The present invention relates in part to a composition comprising a compound of Formula I or Formula II and at least one other antimicrobial agent. The invention also relates in part to a pharmaceutical composition comprising the composition of claim 1 and a pharmaceutically acceptable carrier or excipient. The invention further relates in part to a method of treating a subject with a microbial illness comprising administering to a subject in need thereof the aforementioned pharmaceutical composition. The invention further relates in part to a method of disinfecting a surface comprising administering to the surface the aforementioned a composition. The invention also relates in part to a coating comprising the aforementioned composition.

### RELATED APPLICATIONS

This application claims the benefit of priority to U.S. Provisional Patent Application Ser. No. 60/897,147, filed on Jan. 24, 2007, which is hereby incorporated by reference in its entirety.

### BACKGROUND OF THE INVENTION

Infections caused by or related to microbial agents are a major cause of human illness worldwide, and the frequency of resistance to standard antimicrobial agents has risen dramatically over the last decade. Microbial agents include but are not limited to bacteria, viruses, and fungi.

For example, methicillin resistant Staphylococcus aureus (MRSA) have become a major public health concern. Increasing numbers of individuals, and particularly the young and elderly, test positive for MRSA strains of this Gram positive bacterium common to blood stream infections, cutaneous infections and medical device biofilms. Antibiotic resistance is also common in Gram negative bacteria including entercocci and Pseudomonas aeruginosa. The entercocci are causative agents of many gastrointestinal tract disorders, and stains of vancomycin-resistant Enterococcus faecalis and E. faecium (VRE) have become common in processed foods and meat, and in public bathing areas. Yesim Cetinkaya, Pamela Falk, and C. Glen Mayhall, 2000. Clin. Microbiol. Rev. 13:686-707). Pseudomonas aeruginosa infections of the upper respiratory tract is the major cause of morbidity and mortality in adult patients with cystic fibrosis (CF). Hoiby, N., and C. Koch. Thorax, 1990, 45:881-884. Recent advances in antimicrobial therapy against lung pathogens have dramatically contributed to increased life expectancy of CF patients. However, frequent and prolonged antibiotic courses are likely to be a major factor in the selection of highly antibiotic-resistant P. aeruginosa strains. Similar resistance issues have arisen for human fungal pathogens. The resistance problems are enhanced in HIV patients and other individuals with compromised immune systems due to chemotherapy, organ transplants, and long-term hospitalization. M A. Ghannoum and L B. Rice. 1999. Antifungal Agents: Mode of Action, Mechanisms of Resistance, and Correlation of These Mechanisms with Bacterial Resistance. Clin. Microbiol. Rev. 12:501-517.

A viral infection begins when a virion comes into contact with a host cell and attaches or adsorbs, to it. The viral (DNA or RNA) then crosses the plasma membrane into the cytoplasm and eventually enter into the nucleus. In the case of retrovirus, the viral RNA is reverse transcribed into DNA. Viral DNA is then integrated into the chromosomal DNA of the infected cell. Integration is mediated by an integration protein, integrase. All integrated proviruses are required for the subsequent transcription process which is acted upon by the host cell transcription factors. The integrated DNA is transcribed by the cell's own machinery into mRNA, or replicated and becomes enclosed in a virion. For retrovirus, the integrated DNA is transcribed into RNA that either acts as mRNA or become enclosed in a virion. This completes the virus life cycle. In the past two decades, the emergence of human immunodeficiency virus type 1 (HIV-1), Human Influenza (H1N1), Avian Flu (H5N1), Dengue, and West Nile virus as an important human pathogens has led to a resurgence of scientific interest in retroviruses and other viruses. Current antivirals target, for the most part, various steps in the viral replication cycle, and resistance to these agents is significant, particularly with patients with HIV-1 infections. Pillay D. 1998. Emergence and control of resistance to antiviral drugs in resistance in herpes viruses, hepatitis B virus, and HIV. Commun Dis Public Health 1:5-13; Larder B A. 1996. Nucleoside and foscarnet-mechanisms. In: Richman D D, ed. Antiviral drug resistance. London: Wiley, pp. 169-190.

Plants are constantly challenged by a wide variety of pathogenic organisms including fungi, viruses, and bacteria. Attempts have been made to control plant disease by means of disinfections, replacement of the soil, various cultural practices, genetic engineering of the plant, and control by chemicals. Some plants suffer from detrimental soil-spread diseases, which have not been possible to control owing to restrictions of use of chemical control agents and hazard periods due to possible residues or lack of sufficiently effective products. Extensive use of a broad range of anti-fungal agents on crops has lead to increasing rates of resistance, and current resistance to potato blight and soybean rust pathogens may have significant impacts of global food production. Eds. H. Lyr, P. E. Russell & H. D. Sisler. 1996. Modern fungicides and antifungal compounds. Intercept Ltd, Andover, Hants, 578 pp.

Protozoa and related eukaryotic parasites are major causes of disease including malaria, Giardia and other water-borne protozoans, certain sexually transmitted diseases, sleeping sickness (Trypanosomiasis), Leishmania, and a host of worm parasites. Quellette, M. 2001. Biochemical and molecular mechanisms of drug resistance in parasites. Trop. Med. Internatl. Health 60:874-882; White, N J. 2004. Anti-malarial drug resistance. J. Clin. Internatl. 110: 1084-1092. It has been estimated that at least one-third of the world's human population is threatened by protozoan parasites. Resistance to such anti-protozoan drugs such as the sulfonamides, Chloroquine, Benimadazole, and Ivermectin is found world-wide and rates of resistance are increasing at an alarming rate. New drug targets, modes-of-action, and combination of drugs for anti-protozoan drugs are desperately needed that can not only overcome rapid resistance generation, but that minimize side effects and are cost effective.

In many industrial processes and operations, for example cooling towers, heat exchangers, biofilms lead to rapid deterioration of systems and compromise efficiencies and functions. Many commonly used biocidal agents have created unacceptable environmental risks, many are ineffective against microbial biofilms, some cause direct deterioration of certain systems like enhanced metal corrosion, and in some cases resistance to known treatments has been identified. Flemming H-C. 2004. Biofouling in water systems—cases, causes and countermeasures. Appl. Microbiol. Biotech. 59:629-640; McDonnell, G and Russell, A D. 2002. Appl. Microbiol. Rev. 92:1S-3S.

There exists an unmet need and demand for new agents and new therapeutic targets against microbial targets. The present invention provides, in part, compositions comprising antimicrobial combinations. The combinations include a compound of the present invention and a known antimicrobial agent such as an antibacterial, antivirus, or antifungal agent. The effectiveness of certain antimicrobial compositions is more than the effective sum of the components.

### SUMMARY OF INVENTION

The present invention is directed in part towards novel compositions that kill, reduce, or otherwise interfere with the normal life cycle of microbial agents such as bacteria, viruses, and fungi, and methods of using the same. The compositions comprise a compound of the present invention and an additional antimicrobial agent. Surprisingly, many of the compositions exhibit a synergistic effect wherein the antimicrobial effect is greater than the sum of the parts. The subject compositions may be administered by one of a variety of means known to those of skill in the art.

In one aspect, the present invention relates to a composition comprising a compound and at least one other antimicrobial agent, wherein the compound is represented by formula I:

### Formula I:

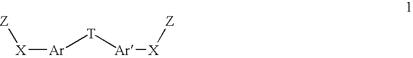 [0012] wherein
X represents independently for each occurrence a bond, O, S, or NR′;
Z represents independently for each occurrence H, S(O)₂OH, or optionally substituted alkyl, alkenyl, alkynyl, aryl, heteroaryl, acyl, trialkylsilyl, alkylsulfonyl, fluoroalkylsulfonyl, or arylsulfonyl;
Ar and Ar′ are independently selected from the group consisting of optionally substituted aryl and heteroaryl;
T represents a covalent linker connecting Ar and Ar′, wherein said covalent linker comprises at least one amide, ether, amine or ester moiety;
R′ represents independently for each occurrence H, formyl, or sulfonyl, or optionally substituted alkyl, alkenyl, aryl, aralkyl, acyl, or —(CH₂)ₘ—R₈₀;
R₈₀ represents independently for each occurrence aryl, cycloalkyl, cycloalkenyl, or heterocyclyl; and
m is an integer in the range 0 to 8 inclusive;
or a pharmaceutically acceptable salt thereof;
or wherein the compound is represented by formula II:

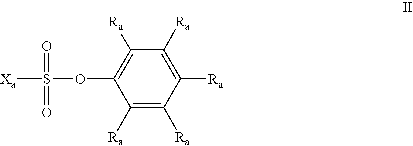

wherein, independently for each occurrence:
Xₐ represents OH, Cl, F, Br, or I; and
Rₐ represents independently for each occurrence H, alkyl, alkenyl, alkynyl, allyl, aryl, aralkyl, heteroaryl, heteroaralkyl, halo, amino, hydroxyl, alkoxyl, thiol, cyano, ester, amido, nitro, formyl, keto, or carboxyl, or pharmaceutically acceptable salts thereof.

In one embodiment, the antimicrobial compositions of the present invention have a MIC of less than 256 μg/mL. In other embodiments, the antimicrobial compositions of the present invention may have a MIC value of less than 128 μg/mL, or even less than 64 μg/mL.

In another aspect, the present invention relates to a pharmaceutical composition comprising a composition of the present invention and a pharmaceutically acceptable carrier or excipient.

In another aspect, the present invention relates to a method of treating a subject with a microbial illness comprising administering to a subject in need thereof a pharmaceutical composition of the present invention.

In certain embodiments, the present invention provides antimicrobial compositions of the present invention, and methods of using the same, for the reduction and abatement of at least one of the microbial caused disorders or conditions based on a therapeutic regimen. In certain aspects, the present invention contemplates monitoring such disorders or conditions as part of any therapeutic regimen, which may be administered over the short-term and/or long-term. These aspects of the invention may be particularly helpful in preventive care regimes.

In another aspect of the present invention, the antimicrobial compositions of the present invention may be used in the manufacture of a medicament to treat any of the foregoing microbial related conditions or diseases. In certain embodiments, the present invention is directed to a method for formulating compositions of the present invention in a pharmaceutically acceptable excipient.

In another aspect, the present invention relates to a method of disinfecting a surface comprising administering to the surface a composition of the present invention.

In another aspect, the present invention relates to a coating comprising a composition of the present invention and a coating material.

In another aspect, the present invention relates to an article comprising on its surface a composition of the present invention.

In another aspect, the present invention also provides for kits containing at least one dose of a subject composition, and often many doses, and other materials for a treatment regimen. For example, in one embodiment, a kit of the present invention contains sufficient subject composition for from five to thirty days and optionally equipment and supplies necessary to measure one or more indices relevant to the treatment regiment. In another embodiment, kits of the present invention contain all the materials and supplies, including subject compositions, for carrying out any methods of the present invention. In still another embodiment, kits of the present invention, as described above, additionally include instructions for the use and administration of the subject compositions.

As explained herein in greater detail, the invention will readily enable the design and implementation of trials in warm-blooded animals, including humans and mammals, necessary for easily determining or tailoring the form and dose for any composition of the present invention.

These embodiments of the present invention, other embodiments, and their features and characteristics, will be apparent from the description, drawings and claims that follow.

### BRIEF DESCRIPTION OF DRAWINGS

FIG. 1 depicts MIC and MBEC plate results for antibiotic combinations with compounds 9 and 6.

FIG. 2 depicts MIC and MBEC plate results for antibiotic combinations with compounds 3 and 2.

FIG. 3 depicts MIC and MBEC plate results for antibiotic combinations with compounds 7 and 1.

FIG. 4 depicts MIC and MBEC plate results for antibiotic combinations with salts of compounds 2 and 6.

FIG. 5 depicts additional TSB controls and a summary table of breakpoint determination.

FIG. 6 depicts the synergistic effect of ZA with Kathon and ZA with HOCl against P. Aeruginosa.

### DETAILED DESCRIPTION OF INVENTION

### I. Definitions

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” are used herein to refer to one or to more than one (i.e., to at least one) of the grammatical object of the article. By way of example, “an element” means one element or more than one element.

The terms “comprise” and “comprising” are used in the inclusive, open sense, meaning that additional elements may be included.

The term “including” is used to mean “including but not limited to”. “Including” and “including but not limited to” are used interchangeably.

The term “antibiotic agent” shall mean any drug or chemical substance that is useful in treating, preventing, or otherwise reducing the severity of any bacterial, fungal, or viral disorder, or any complications thereof, including any of the conditions, disease, or complications arising therefrom and/or described herein. Antibiotic agents include, for example, cephalosporins, quinolones and fluoroquinolones, penicillins and beta lactamase inhibitors, carbepenems, monobactams, macrolides and lincosamines, glycopeptides, rifampin, oxazolidonones, tetracyclines, aminoglycosides, streptogramins, sulfonamides, and the like. Other general categories of antibiotic agents which may be part of a subject composition include those agents known to those of skill in the art as antibiotics and that qualify as (with defined terms being in quotation marks): “drug articles” recognized in the official United States Pharmacopoeia or official National Formulary (or any supplement thereto); “new drug” and “new animal drug” approved by the FDA of the U.S. as those terms are used in Title 21 of the United States Code; any drug that requires approval of a government entity, in the U.S. or abroad (“approved drug”); any drug that it is necessary to obtain regulatory approval so as to comply with 21 U.S.C. §355(a) (“regulatory approved drug”); any agent that is or was subject to a human drug application under 21 U.S.C. §379(g) (“human drug”). (All references to statutory code for this definition refer to such code as of the original filing date of this provisional application.) Other antibiotic agents are disclosed herein, and are known to those of skill in the art.

The term “synergistic” is art recognized and refers to two or more components working together so that the total effect is greater than the sum of the components.

The term “illness” as used herein refers to any illness caused by or related to infection by an organism.

The term “bacterial illness” as used herein refers to any illness caused by or related to infection by bacteria.

The term “biocide” and “biocidal agents,” as used herein refer to chemicals that kill all forms of life, including spore forming organisms, the microbe envelope or membrane so as to kill the microbe.

The term “antiviral agent” is recognized in the art to be any agent or chemical that blocks viral entry, replication, or host cell release or other step interfering with progression of viral infections and viral disease development.

The term “anti-fungal agent” is recognized in the art to be any agent or chemical that interferes with fungal infection through blocking spore germination, adhesion to substrates, or interfering with any metabolic process or step that is required for growth and development of the fungus or its spores.

The term “anti-protozoal” as used herein refers to any chemical or agent that interferes with the parasitic or other life cycle features of a broad range of eukaryotic microbes and invertebrate worms. The agent or chemical might block protein synthesis, essential lipid production, respiratory processes or other metabolic events or growth control steps.

The term “cis” is art-recognized and refers to the arrangement of two atoms or groups around a double bond such that the atoms or groups are on the same side of the double bond. Cis configurations are often labeled as (Z) configurations.

The term “trans” is art-recognized and refers to the arrangement of two atoms or groups around a double bond such that the atoms or groups are on the opposite sides of a double bond. Trans configurations are often labeled as (E) configurations.

The term “covalent bond” is art-recognized and refers to a bond between two atoms where electrons are attracted electrostatically to both nuclei of the two atoms, and the net effect of increased electron density between the nuclei counterbalances the internuclear repulsion. The term covalent bond includes coordinate bonds when the bond is with a metal ion.

The term “therapeutic agent” is art-recognized and refers to any chemical moiety that is a biologically, physiologically, or pharmacologically active substance that acts locally or systemically in a subject. Examples of therapeutic agents, also referred to as “drugs”, are described in well-known literature references such as the Merck Index, the Physicians Desk Reference, and The Pharmacological Basis of Therapeutics, and they include, without limitation, medicaments; vitamins; mineral supplements; substances used for the treatment, prevention, diagnosis, cure or mitigation of a disease or illness; substances which affect the structure or function of the body; or pro-drugs, which become biologically active or more active after they have been placed in a physiological environment. Antibiotic agents and Fab I inhibitors are examples of therapeutic agents.

The term “therapeutic effect” is art-recognized and refers to a local or systemic effect in animals, particularly mammals, and more particularly humans caused by a pharmacologically active substance. The term thus means any substance intended for use in the diagnosis, cure, mitigation, treatment or prevention of disease or in the enhancement of desirable physical or mental development and/or conditions in an animal or human. The phrase “therapeutically-effective amount” means that amount of such a substance that produces some desired local or systemic effect at a reasonable benefit/risk ratio applicable to any treatment. The therapeutically effective amount of such substance will vary depending upon the subject and disease condition being treated, the weight and age of the subject, the severity of the disease condition, the manner of administration and the like, which can readily be determined by one of ordinary skill in the art. For example, certain compositions of the present invention may be administered in a sufficient amount to produce a at a reasonable benefit/risk ratio applicable to such treatment.

The terms “combinatorial library” or “library” are art-recognized and refer to a plurality of compounds, which may be termed “members,” synthesized or otherwise prepared from one or more starting materials by employing either the same or different reactants or reaction conditions at each reaction in the library. There are a number of other terms of relevance to combinatorial libraries (as well as other technologies). The term “identifier tag” is art-recognized and refers to a means for recording a step in a series of reactions used in the synthesis of a chemical library. The term “immobilized” is art-recognized and, when used with respect to a species, refers to a condition in which the species is attached to a surface with an attractive force stronger than attractive forces that are present in the intended environment of use of the surface, and that act on the species. The term “solid support” is art-recognized and refers to a material which is an insoluble matrix, and may (optionally) have a rigid or semi-rigid surface. The term “linker” is art-recognized and refers to a molecule or group of molecules connecting a support, including a solid support or polymeric support, and a combinatorial library member. The term “polymeric support” is art-recognized and refers to a soluble or insoluble polymer to which a chemical moiety can be covalently bonded by reaction with a functional group of the polymeric support. The term “functional group of a polymeric support” is art-recognized and refers to a chemical moiety of a polymeric support that can react with a chemical moiety to form a polymer-supported amino ester.

The term “synthetic” is art-recognized and refers to production by in vitro chemical or enzymatic synthesis.

The term “meso compound” is art-recognized and refers to a chemical compound which has at least two chiral centers but is achiral due to a plane or point of symmetry.

The term “chiral” is art-recognized and refers to molecules which have the property of non-superimposability of the mirror image partner, while the term “achiral” refers to molecules which are superimposable on their mirror image partner. A “prochiral molecule” is a molecule which has the potential to be converted to a chiral molecule in a particular process.

The term “stereoisomers” is art-recognized and refers to compounds which have identical chemical constitution, but differ with regard to the arrangement of the atoms or groups in space. In particular, “enantiomers” refer to two stereoisomers of a compound which are non-superimposable mirror images of one another. “Diastereomers”, on the other hand, refers to stereoisomers with two or more centers of dissymmetry and whose molecules are not mirror images of one another.

Furthermore, a “stereoselective process” is one which produces a particular stereoisomer of a reaction product in preference to other possible stereoisomers of that product. An “enantioselective process” is one which favors production of one of the two possible enantiomers of a reaction product.

The term “regioisomers” is art-recognized and refers to compounds which have the same molecular formula but differ in the connectivity of the atoms. Accordingly, a “regioselective process” is one which favors the production of a particular regioisomer over others, e.g., the reaction produces a statistically significant increase in the yield of a certain regioisomer.

The term “epimers” is art-recognized and refers to molecules with identical chemical constitution and containing more than one stereocenter, but which differ in configuration at only one of these stereocenters.

The term “ED₅₀” is art-recognized. In certain embodiments, ED₅₀ means the dose of a drug which produces 50% of its maximum response or effect, or alternatively, the dose which produces a pre-determined response in 50% of test subjects or preparations. The term “LD₅₀” is art-recognized. In certain embodiments, LD₅₀ means the dose of a drug which is lethal in 50% of test subjects. In other embodiments, IC₅₀ means to dose that yields 50% of the activity inhibited. The term “therapeutic index” is an art-recognized term which refers to the therapeutic index of a drug, defined as LD₅₀/ED₅₀.

The term “structure-activity relationship” or “(SAR)” is art-recognized and refers to the way in which altering the molecular structure of a drug or other compound alters its interaction with a receptor, enzyme, nucleic acid or other target and the like.

The term “aliphatic” is art-recognized and refers to a linear, branched, cyclic alkane, alkene, or alkyne. In certain embodiments, aliphatic groups in the present invention are linear or branched and have from 1 to about 20 carbon atoms.

The term “alkyl” is art-recognized, and includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C₁-C₃₀ for straight chain, C₃-C₃₀ for branched chain), and alternatively, about 20 or fewer. Likewise, cycloalkyls have from about 3 to about 10 carbon atoms in their ring structure, and alternatively about 5, 6 or 7 carbons in the ring structure. The term “alkyl” is also defined to include halosubstituted alkyls.

The term “aralkyl” is art-recognized and refers to an alkyl group substituted with an aryl group (e.g., an aromatic or heteroaromatic group).

The terms “alkenyl” and “alkynyl” are art-recognized and refer to unsaturated aliphatic groups analogous in length and possible substitution to the alkyls described above, but that contain at least one double or triple bond respectively.

Unless the number of carbons is otherwise specified, “lower alkyl” refers to an alkyl group, as defined above, but having from one to about ten carbons, alternatively from one to about six carbon atoms in its backbone structure. Likewise, “lower alkenyl” and “lower alkynyl” have similar chain lengths.

The term “heteroatom” is art-recognized and refers to an atom of any element other than carbon or hydrogen. Illustrative heteroatoms include boron, nitrogen, oxygen, phosphorus, sulfur and selenium.

The term “aryl” is art-recognized and refers to 5-, 6- and 7-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics.” The aromatic ring may be substituted at one or more ring positions with such substituents as described above, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “aryl” also includes polycyclic ring systems having two or more cyclic rings in which two or more carbons are common to two adjoining rings (the rings are “fused rings”) wherein at least one of the rings is aromatic, e.g., the other cyclic rings may be cycloalkyls, cycloalkenyls, cycloalkynyls, aryls and/or heterocyclyls.

The terms ortho, meta and para are art-recognized and refer to 1,2-, 1,3- and 1,4-disubstituted benzenes, respectively. For example, the names 1,2-dimethylbenzene and ortho-dimethylbenzene are synonymous.

The terms “heterocyclyl” or “heterocyclic group” are art-recognized and refer to 3- to about 10-membered ring structures, alternatively 3- to about 7-membered rings, whose ring structures include one to four heteroatoms. Heterocycles may also be polycycles. Heterocyclyl groups include, for example, thiophene, thianthrene, furan, pyran, isobenzofuran, chromene, xanthene, phenoxanthene, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, pyrimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring may be substituted at one or more positions with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The terms “polycyclyl” or “polycyclic group” are art-recognized and refer to two or more rings (e.g., cycloalkyls, cycloalkenyls, cycloalkynyls, aryls and/or heterocyclyls) in which two or more carbons are common to two adjoining rings, e.g., the rings are “fused rings”. Rings that are joined through non-adjacent atoms are termed “bridged” rings. Each of the rings of the polycycle may be substituted with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The term “carbocycle” is art-recognized and refers to an aromatic or non-aromatic ring in which each atom of the ring is carbon.

The term “nitro” is art-recognized and refers to —NO₂; the term “halogen” is art-recognized and refers to —F, —Cl, —Br or —I; the term “sulfhydryl” is art-recognized and refers to —SH; the term “hydroxyl” means —OH; and the term “sulfonyl” is art-recognized and refers to —SO₂—. “Halide” designates the corresponding anion of the halogens, and “pseudohalide” has the definition set forth on 560 of “Advanced Inorganic Chemistry” by Cotton and Wilkinson.

The terms “amine” and “amino” are art-recognized and refer to both unsubstituted and substituted amines, e.g., a moiety that may be represented by the general formulas:

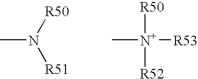

wherein R50, R51 and R52 each independently represent a hydrogen, an alkyl, an alkenyl, —(CH₂)ₘ—R61, or R50 and R51, taken together with the N atom to which they are attached complete a heterocycle having from 4 to 8 atoms in the ring structure; R61 represents an aryl, a cycloalkyl, a cycloalkenyl, a heterocycle or a polycycle; and m is zero or an integer in the range of 1 to 8. In certain embodiments, only one of R50 or R51 may be a carbonyl, e.g., R50, R51 and the nitrogen together do not form an imide. In other embodiments, R50 and R51 (and optionally R52) each independently represent a hydrogen, an alkyl, an alkenyl, or —(CH₂)ₘ—R61. Thus, the term “alkylamine” includes an amine group, as defined above, having a substituted or unsubstituted alkyl attached thereto, i.e., at least one of R50 and R51 is an alkyl group.

The term “acylamino” is art-recognized and refers to a moiety that may be represented by the general formula:

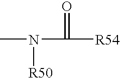

wherein R50 is as defined above, and R54 represents a hydrogen, an alkyl, an alkenyl or —(CH₂)ₘ—R61, where m and R61 are as defined above.

The term “amido” is art recognized as an amino-substituted carbonyl and includes a moiety that may be represented by the general formula:

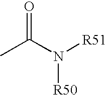

wherein R50 and R51 are as defined above. Certain embodiments of the amide in the present invention will not include imides which may be unstable.

The term “alkylthio” refers to an alkyl group, as defined above, having a sulfur radical attached thereto. In certain embodiments, the “alkylthio” moiety is represented by one of —S-alkyl, —S-alkenyl, —S-alkynyl, and —S—(CH₂)ₘ—R61, wherein m and R61 are defined above. Representative alkylthio groups include methylthio, ethyl thio, and the like.

The term “carbonyl” is art recognized and includes such moieties as may be represented by the general formulas:

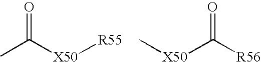

wherein X50 is a bond or represents an oxygen or a sulfur, and R55 and R56 represents a hydrogen, an alkyl, an alkenyl, —(CH₂)ₘ—R61 or a pharmaceutically acceptable salt, R56 represents a hydrogen, an alkyl, an alkenyl or —(CH₂)ₘ—R61, where m and R61 are defined above. Where X50 is an oxygen and R55 or R56 is not hydrogen, the formula represents an “ester”. Where X50 is an oxygen, and R55 is as defined above, the moiety is referred to herein as a carboxyl group, and particularly when R55 is a hydrogen, the formula represents a “carboxylic acid”. Where X50 is an oxygen, and R56 is hydrogen, the formula represents a “formate”. In general, where the oxygen atom of the above formula is replaced by sulfur, the formula represents a “thiolcarbonyl” group. Where X50 is a sulfur and R55 or R56 is not hydrogen, the formula represents a “thiolester.” Where X50 is a sulfur and R55 is hydrogen, the formula represents a “thiolcarboxylic acid.” Where X50 is a sulfur and R56 is hydrogen, the formula represents a “thiolformate.” On the other hand, where X50 is a bond, and R55 is not hydrogen, the above formula represents a “ketone” group. Where X50 is a bond, and R55 is hydrogen, the above formula represents an “aldehyde” group.

The terms “alkoxyl” or “alkoxy” are art-recognized and refer to an alkyl group, as defined above, having an oxygen radical attached thereto. Representative alkoxyl groups include methoxy, ethoxy, propyloxy, tert-butoxy and the like. An “ether” is two hydrocarbons covalently linked by an oxygen. Accordingly, the substituent of an alkyl that renders that alkyl an ether is or resembles an alkoxyl, such as may be represented by one of —O-alkyl, —O-alkenyl, —O-alkynyl, —O—(CH₂)ₘ—R61, where m and R61 are described above.

The term “sulfonate” is art recognized and refers to a moiety that may be represented by the general formula:

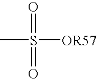

in which R57 is an electron pair, hydrogen, alkyl, cycloalkyl, or aryl.

The term “sulfate” is art recognized and includes a moiety that may be represented by the general formula:

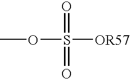

in which R57 is as defined above.

The term “sulfonamido” is art recognized and includes a moiety that may be represented by the general formula:

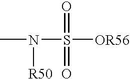

in which R50 and R56 are as defined above.

The term “sulfamoyl” is art-recognized and refers to a moiety that may be represented by the general formula:

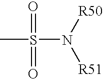

in which R50 and R51 are as defined above.

The term “sulfonyl” is art-recognized and refers to a moiety that may be represented by the general formula:

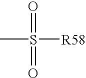

in which R58 is one of the following: hydrogen, alkyl, alkenyl, alkynyl, cycloalkyl, heterocyclyl, aryl or heteroaryl.

The term “sulfoxido” is art-recognized and refers to a moiety that may be represented by the general formula:

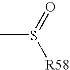

in which R58 is defined above.

The term “phosphoryl” is art-recognized and may in general be represented by the formula:

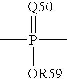

wherein Q50 represents S or O, and R59 represents hydrogen, a lower alkyl or an aryl. When used to substitute, e.g., an alkyl, the phosphoryl group of the phosphorylalkyl may be represented by the general formulas:

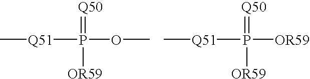

wherein Q50 and R59, each independently, are defined above, and Q51 represents O, S or N. When Q50 is S, the phosphoryl moiety is a “phosphorothioate”.

The term “phosphoramidite” is art-recognized and may be represented in the general formulas:

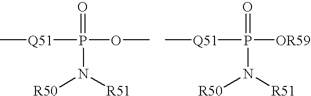

wherein Q51, R50, R51 and R59 are as defined above.

The term “phosphonamidite” is art-recognized and may be represented in the general formulas:

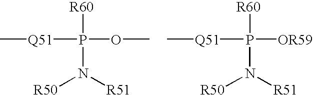

wherein Q51, R50, R51 and R59 are as defined above, and R60 represents a lower alkyl or an aryl.

Analogous substitutions may be made to alkenyl and alkynyl groups to produce, for example, aminoalkenyls, aminoalkynyls, amidoalkenyls, amidoalkynyls, iminoalkenyls, iminoalkynyls, thioalkenyls, thioalkynyls, carbonyl-substituted alkenyls or alkynyls.

The definition of each expression, e.g. alkyl, m, n, and the like, when it occurs more than once in any structure, is intended to be independent of its definition elsewhere in the same structure.

The term “selenoalkyl” is art-recognized and refers to an alkyl group having a substituted seleno group attached thereto. Exemplary “selenoethers” which may be substituted on the alkyl are selected from one of —Se-alkyl, —Se-alkenyl, —Se-alkynyl, and —Se—(CH₂)ₘ—R61, m and R61 being defined above.

The terms triflyl, tosyl, mesyl, and nonaflyl are art-recognized and refer to trifluoromethanesulfonyl, p-toluenesulfonyl, methanesulfonyl, and nonafluorobutanesulfonyl groups, respectively. The terms triflate, tosylate, mesylate, and nonaflate are art-recognized and refer to trifluoromethanesulfonate ester, p-toluenesulfonate ester, methanesulfonate ester, and nonafluorobutanesulfonate ester functional groups and molecules that contain said groups, respectively.

The abbreviations Me, Et, Ph, Tf, Nf, Ts, and Ms represent methyl, ethyl, phenyl, trifluoromethanesulfonyl, nonafluorobutanesulfonyl, p-toluenesulfonyl and methanesulfonyl, respectively. A more comprehensive list of the abbreviations utilized by organic chemists of ordinary skill in the art appears in the first issue of each volume of the Journal of Organic Chemistry; this list is typically presented in a table entitled Standard List of Abbreviations.

Certain compounds contained in compositions of the present invention may exist in particular geometric or stereoisomeric forms. In addition, polymers of the present invention may also be optically active. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

If, for instance, a particular enantiomer of compound of the present invention is desired, it may be prepared by asymmetric synthesis, or by derivation with a chiral auxiliary, where the resulting diastereomeric mixture is separated and the auxiliary group cleaved to provide the pure desired enantiomers. Alternatively, where the molecule contains a basic functional group, such as amino, or an acidic functional group, such as carboxyl, diastereomeric salts are formed with an appropriate optically-active acid or base, followed by resolution of the diastereomers thus formed by fractional crystallization or chromatographic means well known in the art, and subsequent recovery of the pure enantiomers.

It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, or other reaction.

The term “substituted” is also contemplated to include all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, for example, those described herein above. The permissible substituents may be one or more and the same or different for appropriate organic compounds. For purposes of this invention, the heteroatoms such as nitrogen may have hydrogen substituents and/or any permissible substituents of organic compounds described herein which satisfy the valences of the heteroatoms. This invention is not intended to be limited in any manner by the permissible substituents of organic compounds.

For purposes of this invention, the chemical elements are identified in accordance with the Periodic Table of the Elements, CAS version, Handbook of Chemistry and Physics, 67th Ed., 1986-87, inside cover. Also for purposes of this invention, the term “hydrocarbon” is contemplated to include all permissible compounds having at least one hydrogen and one carbon atom. In a broad aspect, the permissible hydrocarbons include acyclic and cyclic, branched and unbranched, carbocyclic and heterocyclic, aromatic and nonaromatic organic compounds that may be substituted or unsubstituted.

The term “protecting group” is art-recognized and refers to temporary substituents that protect a potentially reactive functional group from undesired chemical transformations. Examples of such protecting groups include esters of carboxylic acids, silyl ethers of alcohols, and acetals and ketals of aldehydes and ketones, respectively. The field of protecting group chemistry has been reviewed by Greene and Wuts in Protective Groups in Organic Synthesis (2^{nd} ed., Wiley: New York, 1991).

The term “hydroxyl-protecting group” is art-recognized and refers to those groups intended to protect a hydrozyl group against undesirable reactions during synthetic procedures and includes, for example, benzyl or other suitable esters or ethers groups known in the art.

The term “carboxyl-protecting group” is art-recognized and refers to those groups intended to protect a carboxylic acid group, such as the C-terminus of an amino acid or peptide or an acidic or hydroxyl azepine ring substituent, against undesirable reactions during synthetic procedures and includes. Examples for protecting groups for carboxyl groups involve, for example, benzyl ester, cyclohexyl ester, 4-nitrobenzyl ester, t-butyl ester, 4-pyridylmethyl ester, and the like.

The term “amino-blocking group” is art-recognized and refers to a group which will prevent an amino group from participating in a reaction carried out on some other functional group, but which can be removed from the amine when desired. Such groups are discussed by in Ch. 7 of Greene and Wuts, cited above, and by Barton, Protective Groups in Organic Chemistry Chap. 2 (McOmie, ed., Plenum Press, New York, 1973). Examples of suitable groups include acyl protecting groups such as, to illustrate, formyl, dansyl, acetyl, benzoyl, trifluoroacetyl, succinyl, methoxysuccinyl, benzyl and substituted benzyl such as 3,4-dimethoxybenzyl, o-nitrobenzyl, and triphenylmethyl; those of the formula —COOR where R includes such groups as methyl, ethyl, propyl, isopropyl, 2,2,2-trichloroethyl, 1-methyl-1-phenylethyl, isobutyl, t-butyl, t-amyl, vinyl, allyl, phenyl, benzyl, p-nitrobenzyl, o-nitrobenzyl, and 2,4-dichlorobenzyl; acyl groups and substituted acyl such as formyl, acetyl, chloroacetyl, dichloroacetyl, trichloroacetyl, trifluoroacetyl, benzoyl, and p-methoxybenzoyl; and other groups such as methanesulfonyl, p-toluenesulfonyl, p-bromobenzenesulfonyl, p-nitrophenylethyl, and p-toluenesulfonyl-aminocarbonyl. Preferred amino-blocking groups are benzyl (—CH₂C₆H₅), acyl [C(O)R1] or SiR1₃ where R1 is C₁-C₄ alkyl, halomethyl, or 2-halo-substituted-(C₂-C₄ alkoxy), aromatic urethane protecting groups as, for example, carbonylbenzyloxy (Cbz); and aliphatic urethane protecting groups such as t-butyloxycarbonyl (Boc) or 9-fluorenylmethoxycarbonyl (FMOC).

The definition of each expression, e.g. lower alkyl, m, n, p and the like, when it occurs more than once in any structure, is intended to be independent of its definition elsewhere in the same structure.

The term “electron-withdrawing group” is art-recognized, and refers to the tendency of a substituent to attract valence electrons from neighboring atoms, i.e., the substituent is electronegative with respect to neighboring atoms. A quantification of the level of electron-withdrawing capability is given by the Hammett sigma (σ) constant. This well known constant is described in many references, for instance, March, Advanced Organic Chemistry pp. 251-59 (McGraw Hill Book Company: New York, 1977). The Hammett constant values are generally negative for electron donating groups (σ(P)=−0.66 for NH₂) and positive for electron withdrawing groups (σ(P)=0.78 for a nitro group), σ(P) indicating para substitution. Exemplary electron-withdrawing groups include nitro, acyl, formyl, sulfonyl, trifluoromethyl, cyano, chloride, and the like. Exemplary electron-donating groups include amino, methoxy, and the like.

The term “amino acid” is art-recognized and refers to all compounds, whether natural or synthetic, which include both an amino functionality and an acid functionality, including amino acid analogs and derivatives.

The terms “amino acid residue” and “peptide residue” are art-recognized and refer to an amino acid or peptide molecule without the —OH of its carboxyl group.

The term “amino acid residue” further includes analogs, derivatives and congeners of any specific amino acid referred to herein, as well as C-terminal or N-terminal protected amino acid derivatives (e.g. modified with an N-terminal or C-terminal protecting group).

The term “small molecule” is art-recognized and refers to a composition which has a molecular weight of less than about 2000 amu, or less than about 1000 amu, and even less than about 500 amu. Small molecules may be, for example, nucleic acids, peptides, polypeptides, peptide nucleic acids, peptidomimetics, carbohydrates, lipids or other organic (carbon containing) or inorganic molecules. Many pharmaceutical companies have extensive libraries of chemical and/or biological mixtures, often fungal, bacterial, or algal extracts, which can be screened with any of the assays of the invention. The term “small organic molecule” refers to a small molecule that is often identified as being an organic or medicinal compound, and does not include molecules that are exclusively nucleic acids, peptides or polypeptides.

The term “treating” is art-recognized and refers to curing as well as ameliorating at least one symptom of any condition or disease.

The term “prophylactic” or “therapeutic” treatment is art-recognized and refers to administration to the host of one or more of the subject compositions. If it is administered prior to clinical manifestation of the unwanted condition (e.g., disease or other unwanted state of the host animal) then the treatment is prophylactic, i.e., it protects the host against developing the unwanted condition, whereas if administered after manifestation of the unwanted condition, the treatment is therapeutic (i.e., it is intended to diminish, ameliorate or maintain the existing unwanted condition or side effects therefrom).

A “patient,” “subject” or “host” to be treated by the subject method may mean either a human or non-human animal.

The term “mammal” is known in the art, and exemplary mammals include humans, primates, bovines, porcines, canines, felines, and rodents (e.g., mice and rats).

The term “bioavailable” is art-recognized and refers to a form of the subject invention that allows for it, or a portion of the amount administered, to be absorbed by, incorporated to, or otherwise physiologically available to a subject or patient to whom it is administered.

The term “pharmaceutically-acceptable salts” is art-recognized and refers to the relatively non-toxic, inorganic and organic acid addition salts of compounds, including, for example, those contained in compositions of the present invention.

The term “pharmaceutically acceptable carrier” is art-recognized and refers to a pharmaceutically-acceptable material, composition or vehicle, such as a liquid or solid filler, diluent, excipient, solvent or encapsulating material, involved in carrying or transporting any subject composition or component thereof from one organ, or portion of the body, to another organ, or portion of the body. Each carrier must be “acceptable” in the sense of being compatible with the subject composition and its components and not injurious to the patient. Some examples of materials which may serve as pharmaceutically acceptable carriers include: (1) sugars, such as lactose, glucose and sucrose; (2) starches, such as corn starch and potato starch; (3) cellulose, and its derivatives, such as sodium carboxymethyl cellulose, ethyl cellulose and cellulose acetate; (4) powdered tragacanth; (5) malt; (6) gelatin; (7) talc; (8) excipients, such as cocoa butter and suppository waxes; (9) oils, such as peanut oil, cottonseed oil, safflower oil, sesame oil, olive oil, corn oil and soybean oil; (10) glycols, such as propylene glycol; (11) polyols, such as glycerin, sorbitol, mannitol and polyethylene glycol; (12) esters, such as ethyl oleate and ethyl laurate; (13) agar; (14) buffering agents, such as magnesium hydroxide and aluminum hydroxide; (15) alginic acid; (16) pyrogen-free water; (17) isotonic saline; (18) Ringer's solution; (19) ethyl alcohol; (20) phosphate buffer solutions; and (21) other non-toxic compatible substances employed in pharmaceutical formulations.

The terms “systemic administration,” “administered systemically,” “peripheral administration” and “administered peripherally” are art-recognized and refer to the administration of a subject composition, therapeutic or other material other than directly into the central nervous system, such that it enters the patient's system and, thus, is subject to metabolism and other like processes, for example, subcutaneous administration.

The terms “parenteral administration” and “administered parenterally” are art-recognized and refer to modes of administration other than enteral and topical administration, usually by injection, and includes, without limitation, intravenous, intramuscular, intraarterial, intrathecal, intracapsular, intraorbital, intracardiac, intradermal, intraperitoneal, transtracheal, subcutaneous, subcuticular, intra-articulare, subcapsular, subarachnoid, intraspinal, and intrasternal injection and infusion.

Contemplated equivalents of the compositions described herein include compositions which otherwise correspond thereto, and which have the same general properties thereof, wherein one or more simple variations of substituents or components are made which do not adversely affect the characteristics of the compositions of interest. In general, the components of the compositions of the present invention may be prepared by the methods illustrated in the general reaction schema as, for example, described below, or by modifications thereof, using readily available starting materials, reagents and conventional synthesis procedures. In these reactions, it is also possible to make use of variants which are in themselves known, but are not mentioned here.

### II. Compounds

In one embodiment, the compositions of the present invention comprise a compound of formula I:

### Formula I:

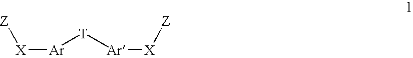 [0128] wherein
X represents independently for each occurrence a bond, O, S, or NR′;
Z represents independently for each occurrence H, S(O)₂OH, or optionally substituted alkyl, alkenyl, alkynyl, aryl, heteroaryl, acyl, trialkylsilyl, alkylsulfonyl, fluoroalkylsulfonyl, or arylsulfonyl;
Ar and Ar′ are independently selected from the group consisting of optionally substituted aryl and heteroaryl;
T represents a covalent linker connecting Ar and Ar′, wherein said covalent linker comprises at least one amide, ether, amine or ester moiety;
R′ represents independently for each occurrence H, formyl, or sulfonyl, or optionally substituted alkyl, alkenyl, aryl, aralkyl, acyl, or —(CH₂)ₘ—R₈₀;
R₈₀ represents independently for each occurrence aryl, cycloalkyl, cycloalkenyl, or heterocyclyl; and
m is an integer in the range 0 to 8 inclusive;
or a pharmaceutically acceptable salt thereof.

In a further embodiment, the present invention includes compositions comprising the aforementioned compounds of formula I and the attendant definitions, wherein X represents O. In other embodiments, Z represents H, S(O)₂OH, or optionally substituted alkylsulfonyl, fluoroalkylsulfonyl or arylsulfonyl. In some embodiments, Z is H. In other embodiments, X represents O and Z represents S(O)₂OH.

In a further embodiment, the present invention includes compositions comprising the aforementioned compounds of formula I and the attendant definitions, wherein Ar and Ar′ independently represent optionally substituted phenyl or naphthyl. In some embodiments, Ar and Ar′ are independently substituted with a halide, such as a Cl.

In a further embodiment, the present invention includes compositions comprising the aforementioned compounds of formula I and the attendant definitions, wherein X represents O, Z represents independently for each occurrence alkylsulfonyl, fluoroalkylsulfonyl, arylsulfonyl, or S(O)₂OH, and Ar and Ar′ independently represent optionally substituted phenyl or naphthyl. In some embodiments, T comprises at least one amido group or at least one amino group.

In a further embodiment, the present invention includes compositions comprising compounds of formula Ia:

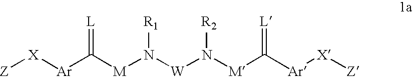

wherein, independently for each occurrence,
X and X′ represent independently a bond, O, S, or NR′;
Z and Z′ represent independently H, S(O)₂OH, or optionally substituted alkylsulfonyl, fluoroalkylsulfonyl or arylsulfonyl, provided that Z and Z′ are not both H;
L and L′ each independently represent O, NR″, or S;
M and M′ independently represent a bond, or a bivalent alkyl or alkenyl chain.
W represents an optionally substituted bivalent alkyl, alkenyl, alkynyl, cycloalkyl, cycloalkenyl, aryl or heteroaryl group, wherein the alkyl, alkenyl or alkynyl groups optionally contain one or more heteroatoms selected from O, S, or NR′″;
R₁ and R₂ represent H, or optionally substituted alkyl, alkenyl, alkynyl, aralkyl, cycloalkyl, aryl or heteroaryl; or R₁ and R₂ may be joined together to form an optionally substituted 4 to 8 membered heterocyclic ring, wherein the ring includes W and the nitrogens to which R₁ and R₂ are attached;
Ar and Ar′ independently represent optionally substituted aryl or heteroaryl;
R′, R″ and R′″ represents independently for each occurrence H, formyl, sulfonyl, or optionally substituted alkyl, alkenyl, aryl, aralkyl, acyl, or —(CH₂)ₘ—R₈₀;
R₈₀ represents independently for each occurrence optionally substituted aryl, cycloalkyl, cycloalkenyl, or heterocyclyl; and
or a pharmaceutically acceptable salt thereof.

In a further embodiment, the present invention includes compositions comprising the aforementioned compounds of formula Ia and the attendant definitions, wherein X represent O.

In a further embodiment, the present invention includes compositions comprising the aforementioned compounds of formula Ia and the attendant definitions, wherein Z and Z′ represent independently for each occurrence H. In another embodiment, Z and Z′ independently represent S(O)₂OH, alkylsulfonyl, fluoroalkylsulfonyl or arylsulfonyl. In another embodiment, Z and Z′ represent S(O)₂OH.

In a further embodiment, the present invention includes compositions comprising the aforementioned compounds of formula Ia and the attendant definitions, wherein Ar and Ar′ independently represent optionally substituted phenyl or naphthyl. In another embodiment, Ar and Ar′ are optionally substituted with at least one member selected from the group consisting of halogen, hydroxy, alkoxy, carboxy, carboxylic ester, nitro, cyano, amino, amido, alkyl, alkenyl, alkynyl, haloalkyl, cycloalkyl, aryl, heteroaryl, oxo, sulfonyl, and sulfonamido. In another embodiment, Ar and Ar′ are optionally substituted with at least one halogen.

In a further embodiment, the present invention includes compositions comprising the aforementioned compounds of formula Ia and the attendant definitions, wherein M and M′ are each a bond. In another embodiment, at least one of M and M′ is —CH═CH—. In another embodiment, one of M and M′ is —CH═CH— and one of M and M′ is a bond.

In a further embodiment, the present invention includes compositions comprising the aforementioned compounds of formula Ia and the attendant definitions, wherein L and L′ independently represent O or NR′.

In a further embodiment, the present invention includes compositions comprising the aforementioned compounds of formula Ia and the attendant definitions, wherein W represents a bivalent alkyl or cycloalkyl group, wherein the alkyl group optionally contains one or more heteroatoms selected from O, S, or NR′″. In another embodiment, W represents a bivalent cyclohexyl group. In another embodiment, W represents —(CH₂)ₙ—, wherein n is an integer ranging from 1 to 12, inclusive. In another embodiment, W represents a bivalent alkyl containing one or more heteroatoms selected from O, S, and NR′″. In another embodiment W represents:
—(CH₂)₂—S(CH₂)₂—, —(CH₂)₂—O—(CH₂)₂—O—(CH₂)₂—, —(CH₂)₃—N(CH₃)—(CH₂)₃—, —CH₂CH═CHCH₂—, —CH₂C(CH₃)₂CH₂—.

In a further embodiment, the present invention includes compositions comprising the aforementioned compounds of formula Ia and the attendant definitions, wherein R₁ and R₂ independently represent H, or optionally substituted alkyl; or R₁ and R₂ may be joined together to form an optionally substituted 4 to 8 membered heterocyclic ring, wherein the ring includes W and the nitrogens to which R₁ and R₂ are attached. In another embodiment, R₁ and R₂ independently represent H, methyl, ethyl, or propyl.

In a further embodiment, the present invention includes compositions comprising the aforementioned compounds of formula Ia and the attendant definitions, wherein W, R₁ and R₂ together form a piperazine or homopiperazine ring.

In a further embodiment, the present invention includes compositions comprising compounds of formula Ib:

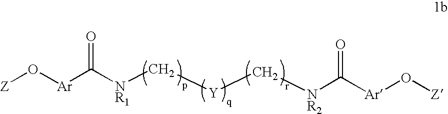

wherein, independently for each occurrence:
Y represents CH₂ or NR′;
R₁ and R₂ independently represent H, or optionally substituted alkyl or aryl, or R₁ and R₂ are joined together to form a optionally substituted 4 to 8 membered heterocyclic ring, wherein the ring includes —(CH₂)ₚ(Y)_{q}(CH₂)ᵣ— and the nitrogens to which R₁ and R₂ are attached;
p and r are 1, 2, or 3;
q is 0 or 1; and
Ar and Ar′ represent substituted phenyl or substituted naphthyl;
Z and Z′ represent independently H, S(O)₂OH, or optionally substituted alkyl, alkenyl, alkynyl, aryl, heteroaryl, acyl, trialkylsilyl, alkylsulfonyl, fluoroalkylsulfonyl or arylsulfonyl, provided that Z and Z′ are not both H;
or a pharmaceutically acceptable salt thereof.

In a further embodiment, the present invention includes compositions comprising the aforementioned compounds of formula Ib and the attendant definitions, wherein R₁ and R₂ independently represent H or alkyl.

In a further embodiment, the present invention includes compositions comprising the aforementioned compounds of formula Ib and the attendant definitions, wherein p and r are each 3.

In a further embodiment, the present invention includes compositions comprising the aforementioned compounds of formula Ib and the attendant definitions, wherein q is 1 and Y is NMe.

In a further embodiment, the present invention includes compositions comprising the aforementioned compounds of formula Ib and the attendant definitions, wherein Ar and Ar′ are independently substituted with at least one member selected from the group consisting of optionally substituted with at least one member selected from the group consisting of halogen, hydroxy, alkoxy, carboxy, carboxylic ester, nitro, cyano, amino, amido, alkyl, alkenyl, alkynyl, haloalkyl, cycloalkyl, aryl, heteroaryl, sulfonyl, and sulfonamido.

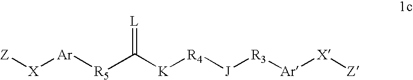

wherein:
Ar and Ar′ represent independently optionally substituted aryl or heteroaryl;
X and X′ represent independently a bond, O, S, or NR′;
Z and Z′ represent independently for each occurrence H, S(O)₂OH, or optionally substituted alkyl, alkenyl, alkynyl, cycloalkyl, aryl, heteroaryl, acyl, trialkylsilyl, alkylsulfonyl, fluoroalkylsulfonyl, or arylsulfonyl;
L represents O, NR′, or S;
J and K independently represent O, S. or NR₆;
R₆ represents independently for each occurrence H, formyl, or sulfonyl, or optionally substituted alkyl, alkenyl, aryl, aralkyl, acyl, or —(CH₂)ₘ—R₈₀;
R₃, R₄ and R₅ represent a bond or optionally substituted bivalent alkyl, alkenyl, alkynyl, aralkyl, cycloalkyl, heterocyclyl, or aryl;
or a pharmaceutically acceptable salt thereof.

In a further embodiment, the present invention includes compositions comprising the aforementioned compounds of formula Ic and the attendant definitions, wherein J is NR₆ and K is O.

In a further embodiment, the present invention includes compositions comprising the aforementioned compounds of formula Ic and the attendant definitions, wherein R₅ is —CH═CH—. In another embodiment, R₃ is methylene. In another embodiment, R₄ is optionally substituted bivalent alkyl, alkenyl, cycloalkyl, heterocyclyl, or aryl.

In a further embodiment, the present invention includes compositions comprising the aforementioned compounds of formula Ic and the attendant definitions, wherein Z and Z′ are each independently H or S(O)₂OH.

In a further embodiment, the present invention includes compositions comprising the aforementioned compounds of formula Ic and the attendant definitions, wherein Ar and Ar′ are each independently optionally substituted phenyl or naphthyl.

In a further embodiment, the present invention includes compositions comprising the aforementioned compounds of formula Ic and the attendant definitions, wherein:
J is NR₆;
K is O;
R₅ is —CH═CH—;
R₃ is methylene;
R₄ is ethylene;
Z and Z′ are each independently H or S(O)₂OH;
and Ar and Ar′ are each independently optionally substituted phenyl or naphthyl.

In a further embodiment, the present invention includes compositions comprising a compound is selected from the group consisting of:

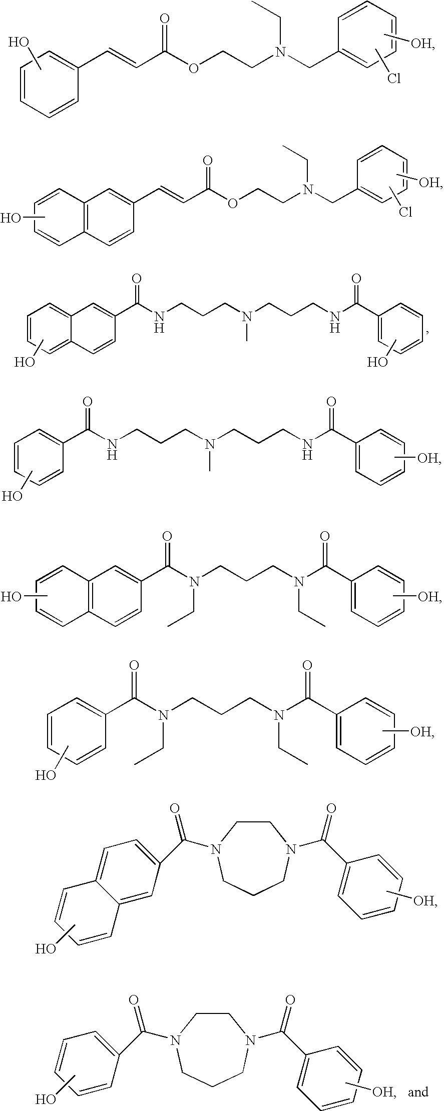

combinations thereof.

The composition of claim 1, wherein the compound is selected from the group consisting of:

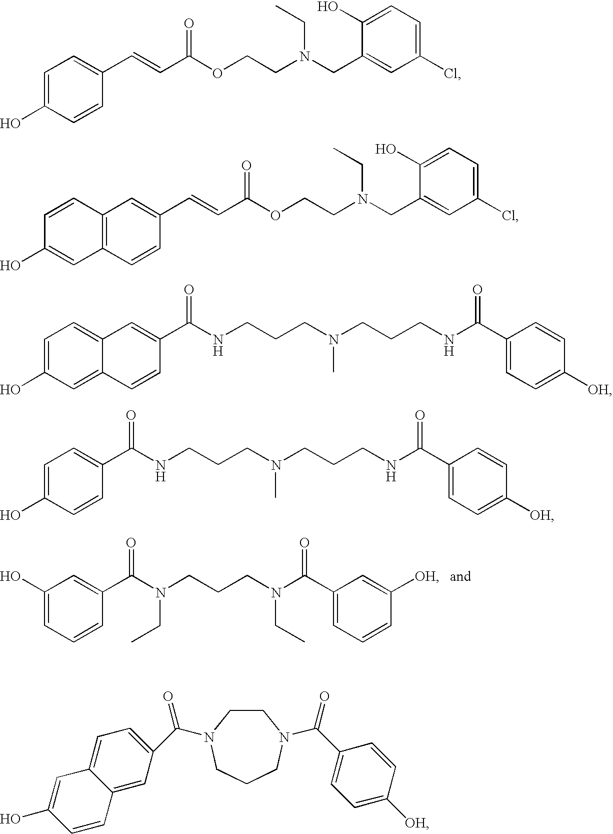

and combinations thereof.

In another embodiment, the compositions of the present invention comprise a compound of formula II:
or wherein the compound is represented by formula II:

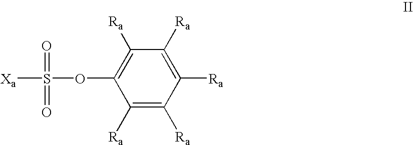

wherein, independently for each occurrence:
Xₐ represents OH, Cl, F, Br, or I; and
Rₐ represents independently for each occurrence H, alkyl, alkenyl, alkynyl, allyl, aryl, aralkyl, heteroaryl, heteroaralkyl, halo, amino, hydroxyl, alkoxyl, thiol, cyano, ester, amido, nitro, formyl, keto, or carboxyl, or pharmaceutically acceptable salts thereof.

In a further embodiment, the present invention includes compositions comprising compounds of formula II and the attendant definitions, wherein Xₐ is OH or Cl.

In a further embodiment, the present invention includes compositions comprising compounds of formula II and the attendant definitions, wherein Xₐ is Cl.

In a further embodiment, the present invention includes compositions comprising compounds of formula II and the attendant definitions, wherein Rₐ represents H, alkyl, or alkenyl.

In a further embodiment, the present invention includes compositions comprising compounds of formula II and the attendant definitions, wherein at least one Rₐ represents alkyl or alkenyl.

In a further embodiment, the present invention includes compositions comprising compounds of formula II and the attendant definitions, wherein at least one Rₐ represents a branched alkyl or substituted alkenyl. In a further embodiment Rₐ represents t-butyl.

In a further embodiment, the present invention includes compositions comprising compounds of formula IIa:

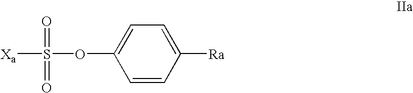

wherein, independently for each occurrence:
Xₐ represents OH or Cl; and
Rₐ represents H, alkyl, alkenyl, alkynyl, allyl, aryl, aralkyl, heteroaryl, heteroaralkyl, halo, amino, hydroxyl, alkoxyl, thiol, cyano, ester, amido, nitro, formyl, keto, or carboxyl.

In a further embodiment, the present invention includes compositions comprising compounds of formula Ia and the attendant definitions, wherein Xₐ represents Cl.

In a further embodiment, the present invention includes compositions comprising compounds of formula Ia and the attendant definitions, wherein Xₐ represents OH.

In a further embodiment, the present invention includes compositions comprising compounds of formula IIa and the attendant definitions, wherein Rₐ represents alkyl.

In a further embodiment, the present invention includes compositions comprising compounds of formula IIa and the attendant definitions, wherein Rₐ represents a branched alkyl.

In a further embodiment, the present invention includes compositions comprising compounds of formula Ia and the attendant definitions, wherein Rₐ represents a substituted alkenyl.

In a further embodiment, the present invention includes compositions comprising compounds of formula Ia and the attendant definitions, wherein Rₐ represents a carboxylic acid substituted alkenyl.

In a further embodiment, the present invention includes compositions comprising a compound selected from the group consisting of compounds 7-10:

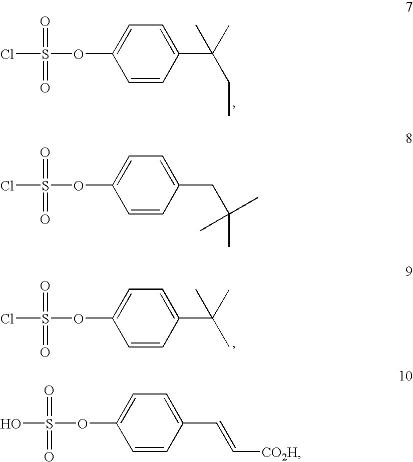

and combinations thereof.

Also included in the compositions of the present invention are addition salts and complexes of the compounds of formulas I-IIa. In cases wherein the compounds may have one or more chiral centers, unless specified, the present invention comprises each unique racemic compound, as well as each unique nonracemic compound.

In cases in which the compounds have unsaturated carbon-carbon double bonds, both the cis (Z) and trans (E) isomers are within the scope of this invention. In cases wherein compounds may exist in tautomeric forms, such as keto-enol tautomers, such as

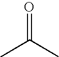

and

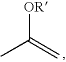

each tautomeric form is contemplated as being included within this invention, whether existing in equilibrium or locked in one form by appropriate substitution with R′. The meaning of any substituent at any one occurrence is independent of its meaning, or any other substituent's meaning, at any other occurrence.

Also included in the compositions of the present invention are prodrugs of the compounds.

The exact mechanism by which the compositions of the present invention achieve their antimicrobial properties is not meant to be limiting. A variety of subject compounds and intermediates of them may be made by a person of ordinary skill in the art using conventional reaction techniques.

Acid addition salts of the compounds of formulas I-IIa can be prepared in a standard manner in a suitable solvent from the parent compound and an excess of an acid, such as hydrochloric, hydrobromic, hydrofluoric, sulfuric, phosphoric, acetic, trifluoroacetic, maleic, succinic or methanesulfonic. Certain of the compounds form inner salts or zwitterions which may be acceptable. Cationic salts may be prepared by treating the parent compound with an excess of an alkaline reagent, such as a hydroxide, carbonate or alkoxide, containing the appropriate cation; or with an appropriate organic amine. Cations such as Li⁺, Na⁺, K⁺, Ca⁺⁺, Mg⁺⁺ and NH₄⁺ are some non-limiting examples of cations present in pharmaceutically acceptable salts.

### III. Compositions

Compositions of the present invention comprise one or more compounds of formulas I-IIa, and one or more antimicrobial agent. Non-limiting examples of antimicrobial agents include antibacterial, antifungal, antiviral agents, and disinfectants. The compositions of the present invention may further comprise a carrier such as a pharmaceutically acceptable carrier or a coating for coating medical devices, plants, animals, insects, machines, and other surfaces, or a coating to be used in personal healthcare products.

Antibiotic Agents

The second component in the compositions of the present invention may be an antibiotic agent other than a compound of formulas I-IIa. Additional components may also be present, including other antibiotic agents.

Non-limiting examples of antibiotic agents that may be used in the antimicrobial compositions of the present invention include cephalosporins, quinolones and fluoroquinolones, penicillins, penicillins and beta lactamase inhibitors, carbepenems, monobactams, macrolides and lincosamines, glycopeptides, rifampin, oxazolidonones, tetracyclines, aminoglycosides, streptogramins, sulfonamides, and others. Each family comprises many members.

Cephalosporins

Cephalosporins are further categorized by generation. Non-limiting examples of cephalosporins by generation include the following. Examples of cephalosporins I generation include Cefadroxil, Cefazolin, Cephalexin, Cephalothin, Cephapirin, and Cephradine. Examples of cephalosporins II generation include Cefaclor, Cefamandol, Cefonicid, Cefotetan, Cefoxitin, Cefprozil, Ceftmetazole, Cefuroxime, Cefuroxime axetil, and Loracarbef. Examples of cephalosporins III generation include Cefdinir, Ceftibuten, Cefditoren, Cefetamet, Cefpodoxime, Cefprozil, Cefuroxime (axetil), Cefuroxime (sodium), Cefoperazone, Cefixime, Cefotaxime, Cefpodoxime proxetil, Ceftazidime, Ceftizoxime, and Ceftriaxone. Examples of cephalosporins IV generation include Cefepime.

Quinolones and Fluoroquinolones

Non-limiting examples of quinolones and fluoroquinolones include Cinoxacin, Ciprofloxacin, Enoxacin, Gatifloxacin, Grepafloxacin, Levofloxacin, Lomefloxacin, Moxifloxacin, Nalidixic acid, Norfloxacin, Ofloxacin, Sparfloxacin, Trovafloxacin, Oxolinic acid, Gemifloxacin, and Perfloxacin.

Penicillins

Non-limiting examples of penicillins include Amoxicillin, Ampicillin, Bacampicillin, Carbenicillin Indanyl, Mezlocillin, Piperacillin, and Ticarcillin.

Penicillins and Beta Lactamase Inhibitors

Non-limiting examples of penicillins and beta lactamase inhibitors include Amoxicillin-Clavulanic Acid, Ampicillin-Sulbactam, Benzylpenicillin, Cloxacillin, Dicloxacillin, Methicillin, Oxacillin, Penicillin G (Benzathine, Potassium, Procaine), Penicillin V, Piperacillin+Tazobactam, Ticarcillin+Clavulanic Acid, and Nafcillin.

Carbepenems

Non-limiting examples of carbepenems include Imipenem-Cilastatin and Meropenem.

Monobactams

A non-limiting example of a monobactam includes Aztreonam.

Macrolides and Lincosamines

Non-limiting examples of macrolides and lincosamines include Azithromycin, Clarithromycin, Clindamycin, Dirithromycin, Erythromycin, Lincomycin, and Troleandomycin.

Glycopeptides

Non-limiting examples of glycopeptides include Teicoplanin and Vancomycin.

Rifampin

Non-limiting examples of rifampins include Rifabutin, Rifampin, and Rifapentine.

Oxazolidonones

A non-limiting example of oxazolidonones includes Linezolid.

Tetracyclines

Non-limiting examples of tetracyclines include Demeclocycline, Doxycycline, Methacycline, Minocycline, Oxytetracycline, Tetracycline, and Chlortetracycline.

Aminoglycosides

Non-limiting examples of aminoglycosides include Amikacin, Gentamicin, Kanamycin, Neomycin, Netilmicin, Streptomycin, Tobramycin, and Paromomycin.

Streptogramins

A non-limiting example of streptogramins includes Quinopristin+Dalfopristin.

Sulfonamides

Non-limiting examples of sulfonamides include Mafenide, Silver Sulfadiazine, Sulfacetamide, Sulfadiazine, Sulfamethoxazole, Sulfasalazine, Sulfisoxazole, Trimethoprim-Sulfamethoxazole, and Sulfamethizole.

Others

Non-limiting examples of other antibiotic agents include Bacitracin, Chloramphenicol, Colistemetate, Fosfomycin, Isoniazid, Methenamine, Metronidazol, Mupirocin, Nitrofurantoin, Nitrofurazone, Novobiocin, Polymyxin B, Spectinomycin, Trimethoprim, Colistin, Cycloserine, Capreomycin, Pyrazinamide, Para-aminosalicyclic acid, and Erythromycin ethylsuccinate+sulfisoxazole.

Non-limiting examples of bacteria that the antimicrobial compositions of the present invention may be used to either destroy or inhibit the growth of include a member of the genus Streptococcus, Staphylococcus, Bordetella, Corynebacterium, Mycobacterium, Neisseria, Haemophilus, Actinomycetes, Streptomycetes, Nocardia, Enterobacter, Yersinia, Francisella, Pasturella, Moraxella, Acinetobacter, Erysipelothrix, Branhamella, Actinobacillus, Streptobacillus, Listeria, Calymmatobacterium, Brucella, Bacillus, Clostridium, Treponema, Escherichia, Salmonella, Klebsiella, Vibrio, Proteus, Erwinia, Borrelia, Leptospira, Spirillum, Campylobacter, Shigella, Legionella, Pseudomonas, Aeromonas, Rickettsia, Chlamydia, Borrelia and Mycoplasma, and further including, but not limited to, a member of the species or group, Group A Streptococcus, Group B Streptococcus, Group C Streptococcus, Group D Streptococcus, Group G Streptococcus, Streptococcus pneumoniae, Streptococcus pyogenes, Streptococcus agalactiae, Streptococcus faecalis, Streptococcus faecium, Streptococcus durans, Neisseria gonorrheae, Neisseria meningitidis, Staphylococcus aureus, Staphylococcus epidermidis, Corynebacterium diptheriae, Gardnerella vaginalis, Mycobacterium tuberculosis, Mycobacterium bovis, Mycobacterium ulcerans, Mycobacterium leprae, Actinomyctes israelii, Listeria monocytogenes, Bordetella pertusis, Bordatella parapertusis, Bordetella bronchiseptica, Escherichia coli, Shigella dysenteriae, Haemophilus influenzae, Haemophilus aegyptius, Haemophilus parainfluenzae, Haemophilus ducreyi, Bordetella, Salmonella typhi, Citrobacter freundii, Proteus mirabilis, Proteus vulgaris, Yersinia pestis, Klebsiella pneumoniae, Serratia marcescens, Serratia liquefaciens, Vibrio cholera, Shigella dysenterii, Shigella flexneri, Pseudomonas aeruginosa, Francisella tularensis, Brucella abortis, Bacillus anthracis, Bacillus cereus, Clostridium perfringens, Clostridium tetani, Clostridium botulinum, Treponema pallidum, Rickettsia rickettsii, Helicobacter pylori or Chlamydia trachomitis.

Non-limiting examples of illnesses caused by an microbial illness include otitis media, conjunctivitis, pneumonia, bacteremia, meningitis, sinusitis, pleural empyema and endocarditis, and meningitis, such as for example infection of cerebrospinal fluid. Also treatable are biofilm based infections as well as non-biofilm applications (e.g. bacterial meningitis, where antibiotics kill the bacteria, but the dead/lysed bacteria induce a very strong inflammatory response because the adhesins still bind to cell receptors causing brain swelling; compositions of the present invention would improve the therapeutic benefit and reduce risks even though no biofilm intervention mode is involved). It has been shown that lysed and/or heat killed bacteria still adhere (and induce inflammatory response) to cell receptors. Compounds of the present invention are capable of preventing such adhesion and prevent biofilm formation. Thus by interfering with the inflammatory cascade, compositions of the present invention are useful for the treatment of such diseases as cystic fibrosis, menegitis, and oral disease. They are also useful for industrial applications where biofilm formation would lead to health related problems such as the food industry or water purification industry.

Antifungal Agents

The second component in the compositions of the present invention may be an antifungal agent other than a compound of formulas I-IIa. Additional components may also be present, including other antifungal agents.

Non-limiting examples of antifungal agents that may be used in the antimicrobial compositions of the present invention include antifungal agents that also act as antibiotics such as polyenes and others, and synthetic antifungal agents such as allylamines, imidazoles, thiocarbamates, triazoles, and others.

Polyenes

Non-limiting examples of polyenes include Amphotericin B, Candicidin, Dermostatin, Filipin, Fungichromin, Hachimycin, Hamycin, Lucensomycin, Mepartricin, Natamycin, nystatin, Pecilocin, and Perimycin.

Allylamines

Non-limiting examples of allylamines include Butenafine, Naftifine, and Terbinafine.

Imidazoles

Non-limiting examples of imidazoles include Bifonazole, Butoconazole, Chlordantoin, Chlormidazole, Cloconazole, Clotrimazole, Econazole, Enilconazole, Fenticonazole, Flutirmazole, Isoconazole, ketoconazole, lanoconazole, Miconazole, Omoconazole, Oxiconazole Nitrate, Sertaconazole, Sulconazole, and Tioconazole.

Thiocarbamates

Non-limiting examples of thiocarbamates include Tolciclate, Tolindate, and Tolnaftate.

Triazoles

Non-limiting examples of triazoles include Fluconazole, Itraconazole, Saperconazole, and Terconazole.

Others

Non-limiting examples of other antifungal agents include Azaserine, Griseofulvin, Oligomycins, Neomycin Undecylenate, PyrroInitrin, Siccanin, Tubercidin, Viridin, Acrisorcin, Amorolfine, Biphenamine, Bromosalicylchloranilide, Buclosamide, Calcium Propionate, Chlorophenesin, Ciclopirox, Cloxyquin, Coparaffinate, Diamthazole dihydrochloride, Exalamide, Flucytosine, Halethazole, Hexetidine, loflucarban, Nifuratel, potassium iodide, propionic acid, Pyrihione, Salicylanilide, sodium propionate, Sulbentine, Tenonitrozole, Triacetin, Ujothion, undecylenic acid, and zinc propionate.

Non-limiting examples of fungi that the antimicrobial compositions of the present invention may be used to either destroy or inhibit the growth of include a member of the genus Botrytis sp. (B. cinerea), Penicillium sp. (P. expansum, P. italicum, P. digitalum), Rhizopus sp. (R. sulonifer, R. nigricans), Alternaria sp. (A. alternata, A. solani), Diploidia sp. (Diploidia natalenses), Monilinia sp. (M. fructicola), Pseudomonas sp. (P. cepacia) Xanthomonas sp., Erwinia sp. and Corynebacterium. Cladosporium sp. (C. fulva), Phytophtora sp. (P. infestans), Colletotricum spp. (C. coccoides C. fragariae, C. gloesporioides), Fusarium spp. (F. lycopersici), Verticillium spp. (V. alboatrum, V. dahliae), Unicula spp. (U. necator), Plasmopara spp. (P. viticola), Guignardia spp. (G. bidwellii), Cercospora spp. (C. arachidicola), Scelrotinia spp. (S. scerotiorum), Puccinia spp. (P. arachidis), Aspergillus spp. (A. favus), Venturia spp (V. inaequalis) Podosphaera spp. (P. leucotricha), Pythiun spp., and Sphaerotheca (S. macularis).

Antiviral Agents

The second component in the compositions of the present invention may be an antiviral agent other than a compound of formulas I-IIa. Additional components may also be present, including other antiviral agents.

Non-limiting examples of antiviral agents that may be used in the antimicrobial compositions of the present invention include Purines/Pyrimidinones and others.

Purines/Pyrimidinones

Non-limiting examples of Purines/Pyrimidinones include Acyclovir, Cidofovir, Cytarabine, Dideoxyadenosine, Didanosine, Edoxudine, Famciclovir, Floxuridine, Inosine Pranobex, Lamivudine, MADU, Penciclovir, Sorivudine, Stavudine, Trifluridine, Valacyclovir, Vidarabine, Zalcitabine, and Zidovudine.

Others

Non-limiting examples of other antiviral agents include Acemannan, Acetylleucine Monothanolamine, Amantadine, Amidinomycin, ATZ, Delavirdine, Foscarnet Sodium, Fuzeon, Indinavir, Interferon-α, Interferon-β, Interferon-γ, Kethoxal, Lysozyme, Methisazone, Moroxydine, Nevirapine, Podophyllotoxin, Ribavirin, Rimantadine, Ritonavir, Saquinavir, Stallimycin, Statolon, Tamiflu, Tromantadine, and Xenazoic Acid.

Compositions of the present invention are also useful to counteract the effect of prions. Prion is short for proteinaceous infectious particle that lacks nucleic acid (by analogy to virion) and is a type of infectious agent made only of protein. Prions are believed to infect and propagate by refolding abnormally into a structure which is able to convert normal molecules of the protein into the abnormally structured form, and they are generally quite resistant to denaturation by protease, heat, radiation, and formalin treatments, although potency or infectivity can be reduced. Qin, K. et al. Neuroscience (2006), 141(1), 1-8. The term does not, however, a priori preclude other mechanisms of transmission. The following diseases in animals are now believed to be caused by prions: scrapie in sheep, bovine spongiform encephalopathy (BSE), transmissible mink encephalopathy (TME), chronic wasting disease (CWD) in elk and mule deer, feline spongiform encephalopathy in cats, exotic ungulate encephalopathy (EUE) in nyala, oryx, and greater kudu. The following diseases in humans are believed to be caused by prions: several varieties of Creutzfeldt-Jakob Disease (CJD), such as Iatrogenic Creutzfeldt-Jakob disease, Variant Creutzfeldt-Jakob disease, Familial Creutzfeldt-Jakob disease, and Sporadic Creutzfeldt-Jakob disease; Gerstmann-Straussler-Scheinker syndrome (GSS), Fatal Familial Insomnia (FFI), Kuru, and Alpers syndrome.

A great deal of our knowledge of how prions work at a molecular level comes from detailed biochemical analysis of yeast prion proteins. A typical yeast prion protein contains a region (protein domain) with many repeats of the amino acids glutamine (Q) and asparagine (N); these Q/N-rich domains form the core of the prion's structure. Ordinarily, yeast prion domains are flexible and lack a defined structure. When they convert to the prion state, several molecules of a particular protein come together to form a highly structured amyloid fiber. The end of the fiber acts as a template for the free protein molecules, causing the fiber to grow. Compounds of the present invention are capable of blocking amyloid plaque formation, including β-amyloid aggregation and assembly of aggregates on neuronal glycoproteins.

TABLE 1
Applications, compositions, and existing ranges for known
antimcrobial classes (Agent I) and for anti-microbials of
the present invention (Agent II).

| | Composition Range | Composition Range |
|---|---|---|
| Application | Agent I | Agent II |
| Anti-bacterial | Human/Animal | Human/Animal |
| | 2.0-30 mg/Kg/day | 1.0-300 mg/Kg/day |
| | IC₅₀ = 30-200 μM | IC₅₀ = 5-3000 μM |
| | | Crop |
| | | 2-6000 mg/L |
| Anti-fungal | Human/Animal | Human/Animal |
| | 1-4 mg/Kg | 1-100 mg/Kg |
| | Crop | Crop |
| | 30-800 mg/L | 30-6000 mg/L |
| Anti-viral | Human/Animal | Human/Animal |
| | 0.1-400 mg/Kg/day | 1-4000 mg/Kg/day |
| | IC₅₀ = 0.2-15 μM | Crop/Insect |
| | Crop/Insect | 50-6000 mg/L |
| | 10-1000 mg/L | |
| Anti-Protozoan | 1.1 to 300 | 5-5000 mg/Kg/day |
| | mg/Kg/day | IC₅₀ = 1-4000 μM |
| | IC₅₀ = 0.1-200 μM | |
| Biocides (medical devices and | 15-100 mg/L | 10-500 mg/L |
| tissues for sterilization) | | |
| Anti-microbial (medical | 1-100 mg/L | 1-1000 mg/L |
| devices and tissue | | |
| dissinfection) | | |
| Anti-microbial (industrial and | 1-100 mg/L | 1-1000 mg/L |
| water treatment) | | |
| Biofouling Control (Hull | 5-80% wt/wt AF | 1-40% wt/wt AF |
| coatings) | active | active |

Disinfectants

The second component in the compositions of the present invention may be a disinfectant other than a compound of formulas I-IIa. Additional components may also be present, including other disinfectants.

Non-limiting examples of at least one other disinfectant includes acid, alkali, alcohol, aldehyde, halogen, phenol, biguanide, peroxygen compound, quaternary ammonium compound, enzyme, amphoterics, surfactants, and combinations thereof.

Acids

Non-limiting examples of acids include acetic acid, phosphoric acid, citric acid, lactic, formic, and propionic acids, hydrochloric acid, sulfuric acid, and nitric acid.

Alkali

Non-limiting examples of alkali include sodium hydroxide, potassium hydroxide, sodium carbonate, and ammonium hydroxide.

Alcohol

Non-limiting examples of alcohols include ethyl alcohol, isopropyl alcohol, and phenol.

Aldehydes

Non-limiting examples of aldeydes include formaldehyde and glutaraldehyde.

Halogens

Non-limiting examples of halogens include chlorine compounds such as hypochlorites, chlorine dioxide, sodium dichloroisocyanurate, and chloramine-T. Iodine compounds such as iodine and iodophors such as povidone-iodine.

Biguanides

Non-limiting examples of biguanides include chlorhexidine.

Peroxygen Compounds

Non-limiting examples of peroxygen compounds include hydrogen peroxide and peracetic acid.

Quaternary Ammonium Compounds (QACs)

Non-limiting examples of QACs include benzalkonium chloride. Ethyl alcohol potentiates the action of QACs.

### IV. Results of MBEC Combination Antimicrobial Testing

The MBEC bioFILM PA panel is designed for use in determining antimicrobial agent susceptibility of both planktonic and biofilm Pseudomonas aeruginosa. This broth dilution antimicrobial susceptibility test has various antimicrobial agents alone and in combination which are diluted in recovery buffer at categorical breakpoint concentrations defined by the Clinical and Laboratory Standard Institute™ (CLSI).

The purpose of running this test is to determine the effects of pre-exposure to compounds of the present invention on MIC (minimum inhibitory concentration) values of Pseudomonas aeruginosa ATCC 27853 (a bacterium isolated from a cystic fibrosis patient) at 3 different concentrations of 8 different test compounds during biofilm formation using the bioFILM PA panel. The panel contains 47 different antibiotic and antibiotic combinations.

The purpose is also to determine the effects of pre-exposure to compounds of the present invention on NBEC (minimum biofilm eradication concentration) values of ATCC 27853 (a bacterium isolated from a cystic fibrosis patient) at 3 different concentrations of 8 different test compounds during biofilm formation using the bioFILM PA panel. The panel contains 47 different antibiotic and antibiotic combinations.

From this test, the minimum antibiotic concentration—in the presence and absence of a compound of the present invention—that will inhibit bacterial growth in solution (“MIC Assay”) is determined. The minimum antibiotic concentration—in the presence and absence of a compound of the present invention—that will prevent attachment of bacteria to a test surface (“MBEC Assay”) is determined. Approximately 1,000,000-10,000,000 bacteria attach in the absence of antibiotics; lesser numbers attach in the presence of antibiotics. MIC and MBEC results are determined following the 18-24 hour incubation from the bioFILM PA panels using a plate reader, which measures growth via a threshold turbidimetric measurement. Table 2 summarizes MBEC data addressing synergy between compounds 1, 2, and 7 and a bank of gram negative antibiotics in various combinations on biofilm development. One can see that when compound 2 was used together with the antibiotic combinations many hits were registered. In many cases 50-75% enhancement in antibiotic activity (killing) was obtained, even when the antibiotic alone had no activity against biofilm development at an assay threshold. These results clearly indicate synergism between the known antibiotics and the compounds of the present invention. In the table, GM=gentamicin, AK=amikacin, CAZ=ceftazidime, CPE=cefepime, T/S=trimethoprim/sulfamethoxazole, P/T=peiperacillin/tazobactam, AZT=astreonam, MER=meropenem, TO=tobramycin, CP=ciprofloxacin, CT=colistin, and C=chloramphenicol.

TABLE 2
Prevention of Pseudomonas aeruginosa biofilm formation.

| | | MBEC, μg/mL | MBEC, μg/mL | MBEC, μg/mL |
|---|---|---|---|---|
| Antibiotic | | (% reduction²) | (% reduction) | (% reduction) |
| Combination | MBEC, μg/mL¹ | +Compound 7 | +Compound 2 | +Compound 1 |
| GM/AZT | 2/4 | >2/4 | <0.25/0.5 (>87.5) | 2/4 |
| GM/CAZ | >2/4 | 1/2 (>50) | <0.25/0.5 (>87.5) | 2/4 (>50) |
| GM/P/T | 2/16/1 | 1/8/0.5 (50) | >2/16/1 | 1/8/0.5 (50) |
| GM/CPE | >2/4 | 1/2 (>50) | 0.5/1-2/4 (>75) | >2/4 |
| GM/MER | 2/2 | 2/2 | <0.25/0.25 (>87.5) | 2/2 |
| GM/CP | >2/0.5 | 1/0.25 (>50) | <0.25/0.0625 | >2/0.5 |
| | | | (>87.5) | |
| GM/CT | >2/1 | 2/1 (>50) | 0.5/0.25-2/1 | >2/1 |
| | | | (>87.5) | |
| AK/AZT | 8/4 | 2/1 (50) | <1/0.5 (>75) | 8/4 |
| AK/CAZ | >8/4 | 8/4 (>50) | <1/0.5 (>75) | 8/4 (>50) |
| AK/CPE | >8/4 | 2/1-8/4 (>50) | <1/0.5 (>75) | 4/2 (>50) |
| AK/MER | 8/2 | 4/1 (50) | data not available³ | 8/2 |
| AK/CP | >8/0.5 | 8/0.5 (>50) | data not available | 4/0.25 (>50) |
| AK/T/S | >8/0.5/9.5 | 2/0.125/2.375 (>75) | data not available | >8/0.5/9.5 |
| AK/CT | >8/1 | 8/1 (>50) | data not available | >8/1 |
| TO/AZT | 2/4 | 0.5/1 (50) | 2/4 | 0.5/1 (75) |
| TO/CAZ | >2/4 | 1/2 (>50) | data not available | 2/4 (>50) |
| TO/P/T | >2/16/1 | 0.5/4/0.25 (>50) | data not available | >2/16/1 |
| TO/CPE | >2/4 | 0.5/1 (>50) | data not available | 0.5/1 (>75) |
| TO/MER | 2/2 | 0.5/0.5 (75) | data not available | 0.5/0.5 (750) |
| TO/CP | >2/0.5 | 1/0.25 (>50) | data not available | >2/0.5 |
| TO/T/S | >2/0.5/9.5 | <0.25/0.0625/1.1875 | data not available | 2/0.5/9.5 (>50) |
| | | (>87.5) | | |
| TO/CT | >2/1 | 0.5/0.25 (>75) | data not available | 0.5/0.25-2/1 |
| | | | | (>50) |
| CP/AZT | 0.5/4 | >0.5/4 | data not available | 0.5/4 |
| CP/CT | >0.5/1 | 0.5/1 (>50) | 0.5/4 | >0.5/1 |
| CP/T/S | >0.5/0.5/9.5 | 0.25/0.25/4.75 (>50) | 0.5/1 (>50) | >0.5/0.5/9.5 |
| CP/MER | >0.5/2 | 0.5/2 (>50) | >0.5/0.5/9.5 | 0.5/2 (>50) |
| CP/P/T | 0.5/16/1 | 0.5/16/1 | >0.5/16/1 | >0.5/16/1 |
| AK | >8 | 2-8 (>50) | >8 | >8 |
| TO | >2 | >2 | >2 | 0.5-2 (>50) |
| CP | >0.5 | 0.5 (>50) | >0.5 | 0.5 (>50) |

¹MBEC is the minimum biofilm eradication concentration, i.e. the concentration required to prevent bacterial biofilm formation; where a “>” symbol is present, the concentration indicated was insufficient to prevent biofilm formation; the MBEC is somewhat analogous to the MBC.
²Refers to reduction (in %) of antibiotic or antibiotic combination required to prevent biofilm formation.
³Growth control or dilution control failure.

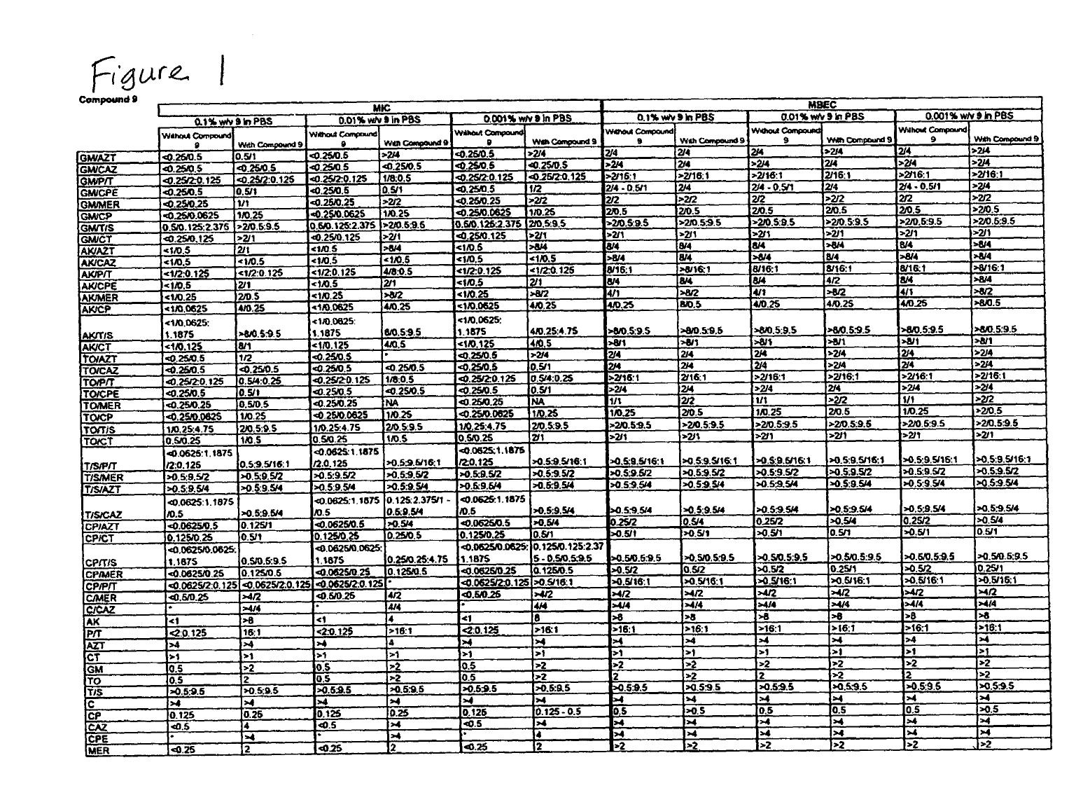

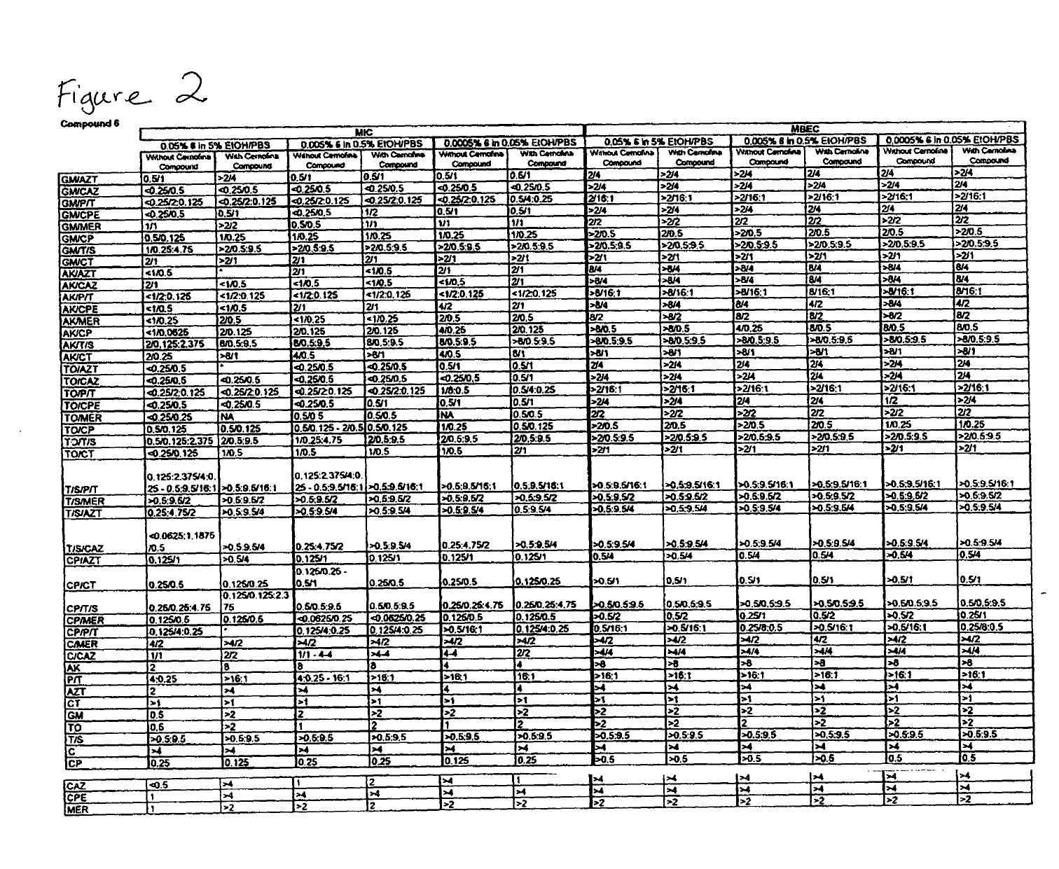

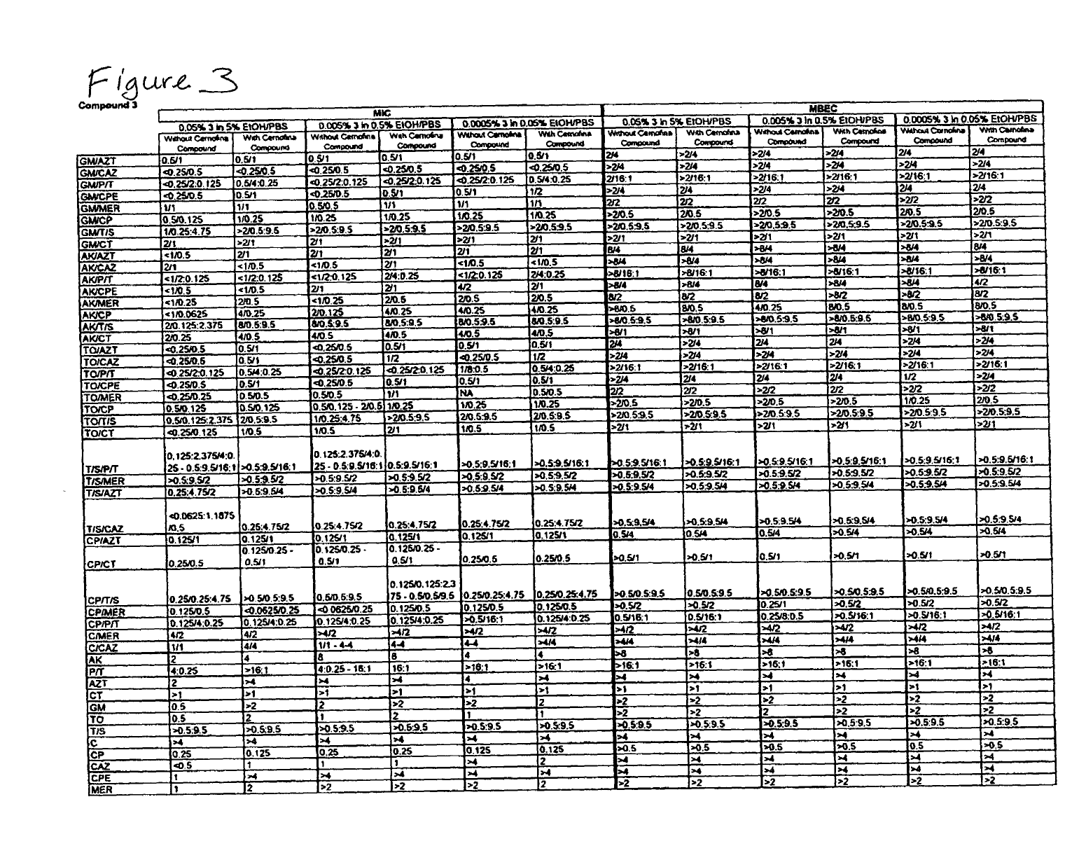

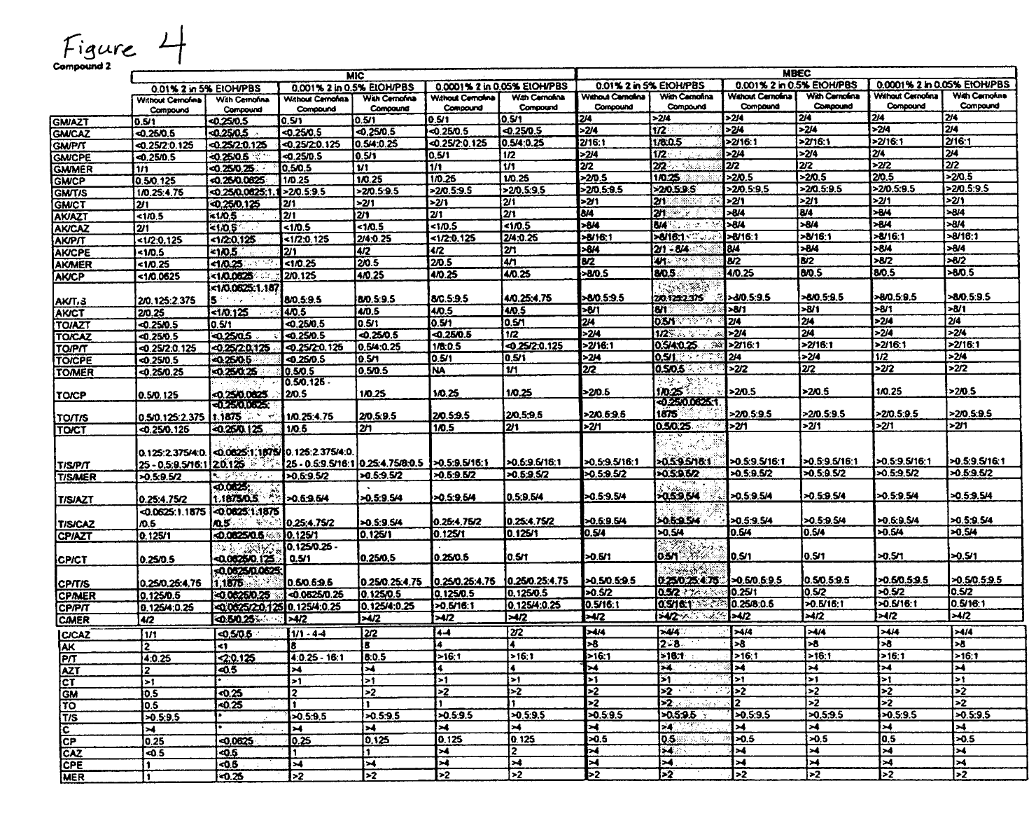

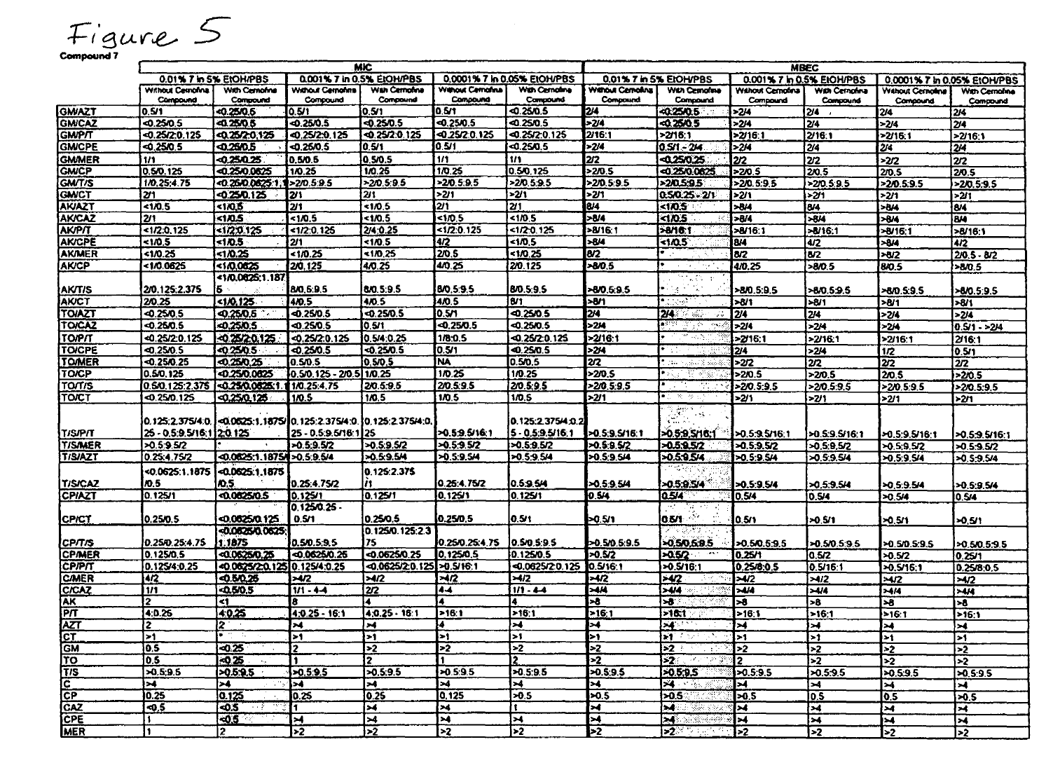

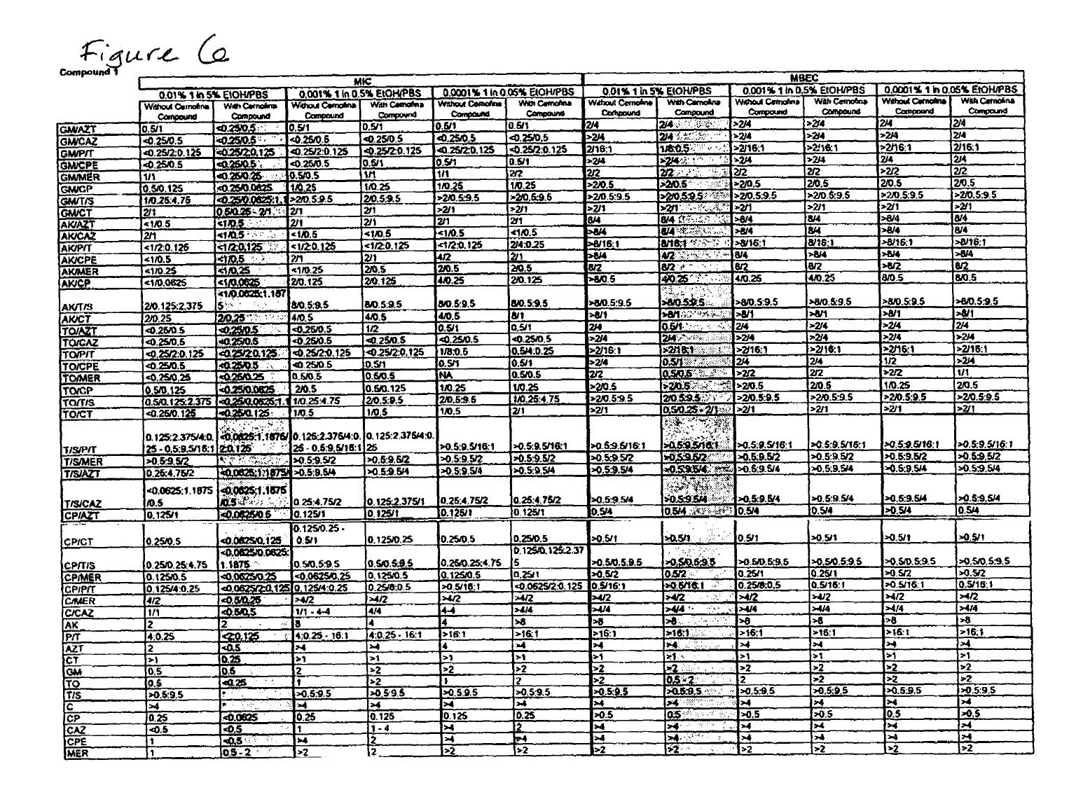

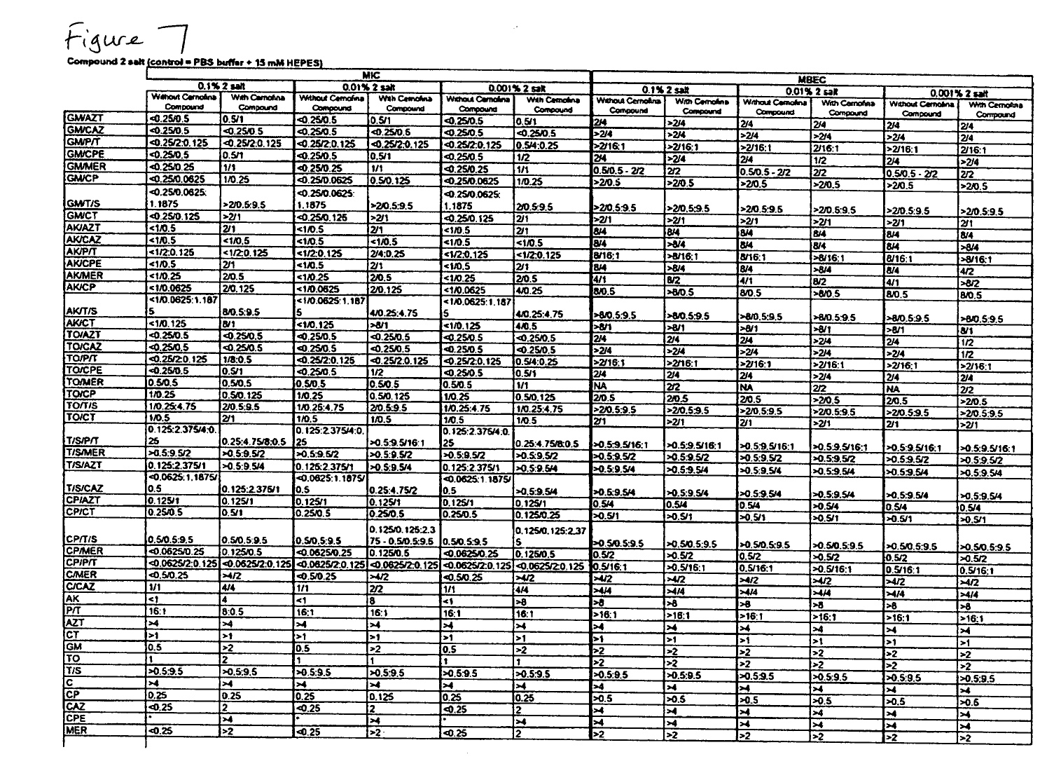

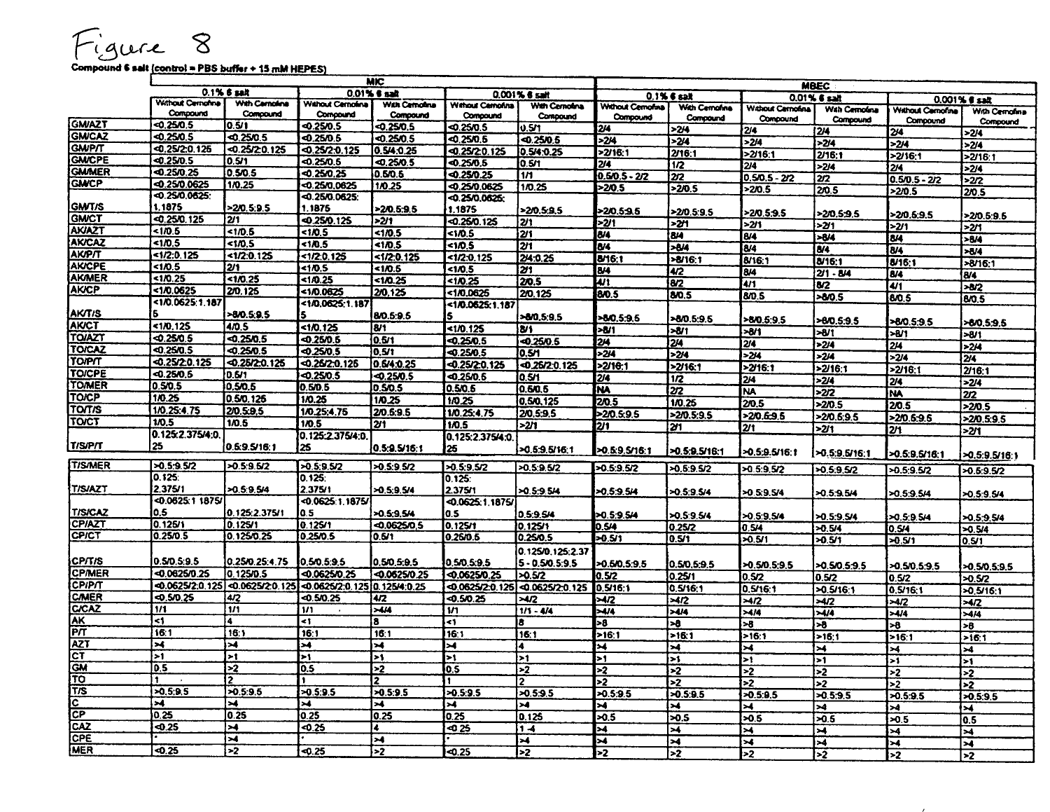

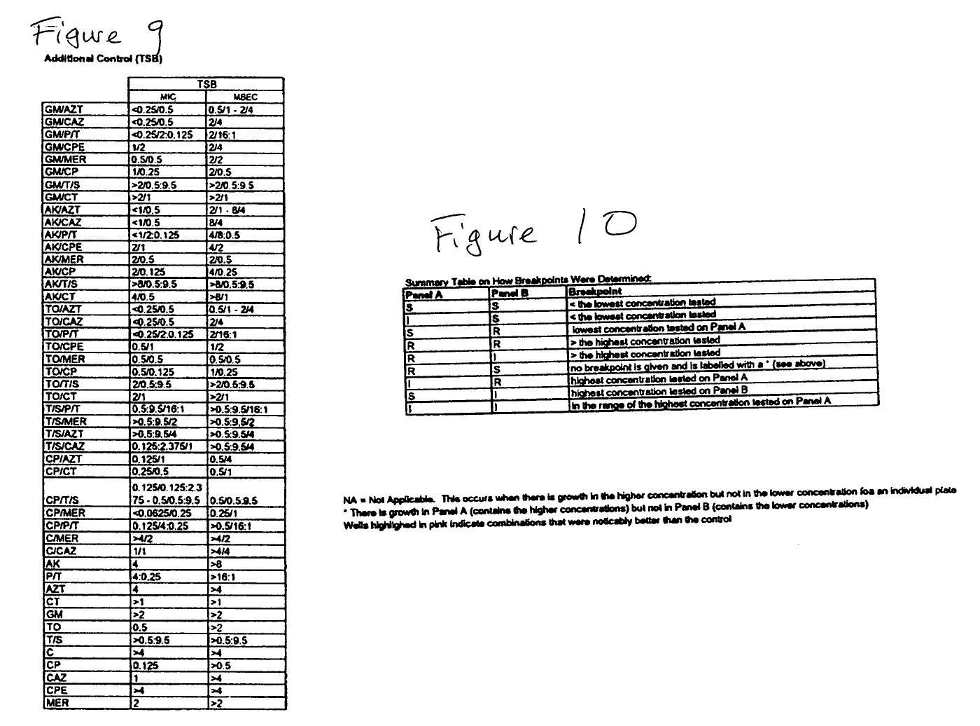

The MIC values for several antibiotics were reduced (i.e., their efficacy was increased) in the presence of compounds 1, 2, and 7 at 0.01%. See FIGS. 1-5 for these results and results for compounds 3, 6, and 9 as well as salts of compounds 2 and 6. Tables 3-10 present additional MBEC-biofilm inhibition and MBEC-biofilm elimination data for compounds 9, 6, 3, 2, 7, 1, and salts of compounds 2 and 6. In these tables, synergism is apparent when the MIC or MBEC concentration is lower in the presence of a compound of the present invention compared to when the compound is absent.

Bacterial attachment to the test surfaces was completely inhibited at lower concentrations of antibiotics in the presence of compounds 1, 2, and 7. These compounds increased the efficacy of antibiotics or antibiotic-combinations by a factor of 2-4× in most cases. For compound 2, 26 of the 47 antibiotics or antibiotic combinations were enhanced in activity; for compound 7, 10 of 47; and for compound 1, 12 of 47. The MBEC values for all compounds were above the highest concentrations tested (0.01-0.1%, depending upon the compound).

Compounds of the present invention enhanced the antimicrobial efficacy of several antibiotics and antibiotic combinations. Both microbial growth and attachment activity were reduced when these compounds were combined with various antibiotics. The MIC findings suggest that the biofilm inhibition may be associated, in whole or in part, with biocidal/biostatic activity. Where MIC values were increased (the antibiotics become less effective) in the presence of the compounds (most notably, with compound 9), charge-charge interactions with some antibiotics may be present. Gentamicin, for example, is a polycationic antimicrobial, which may be influenced by such electrostatic interactions.

TABLE 3
Prevention of Pseudomonas aeruginosa biofilm
formation by compound 9.

| | MBEC¹-Biofilm | | MBEC²-Biofilm | |
|---|---|---|---|---|
| | Inhibition | | Elimination | |
| | | With | | With |
| | | 0.1% w/v | | 0.1% w/v |
| Antibiotic | Without | compound 9 | Without | compound 9 |
| Combination | compound 9 | in PBS | compound 9 | in PBS |
| GM/AZT | 2/4 | 2/4 | >2/4 | >2/4 |
| GM/CAZ | >2/4 | 2/4 | >2/4 | >2/4 |
| GM/P/T | >2/16:1 | >2/16:1 | >2/16/1 | >2/16/1 |
| GM/CPE | 2/4-0.5/1 | 2/4 | >2/4 | >2/4 |
| GM/MER | 2/2 | >2/2 | >2/2 | >2/2 |
| GM/CP | 2/0.5 | 2/0.5 | 2/0.5-0.5/0.125 | >2/0.5 |
| GM/T/S | >2/0.5:9.5 | >2/0.5:9.5 | 2/0.5/9.5 | 2/0.5/9.5 |
| GM/CT | >2/1 | >2/1 | >2/1 | >2/1 |
| AK/AZT | 8/4 | 8/4 | >8/4 | >8/4 |
| AK/CAZ | >8/4 | 8/4 | 8/4 | >8/4 |
| AK/P/T | 8/16:1 | >8/16:1 | 4/8/0.5 | >8/16/1 |
| AK/CPE | 8/4 | 8/4 | 8/4 | >8/4 |
| AK/MER | 4/1 | >8/2 | >8/2 | >8/2 |
| AK/CP | 4/0.25 | 8/0.5 | >8/0.5 | >8/0.5 |
| AK/T/S | >8/0.5:9.5 | >8/0.5:9.5 | 4/0.25/4.75 | 8/0.5/9.5 |
| AK/CT | >8/1 | >8/1 | 8/1 | 8/1 |
| TO/AZT | 2/4 | 2/4 | >2/4 | >2/4 |
| TO/CAZ | 2/4 | 2/4 | <0.25/0.5 | No BP³ |
| TO/P/T | >2/16:1 | 2/16:1 | 1/8/0.5 | <0.25/2/ |
| | | | | 0.125 |
| TO/CPE | >2/4 | 2/4 | 2/4-0.5/1 | 2/4-0.5/1 |
| TO/MER | 1/1 | 2/2 | 0.5/0.5 | 0.5/0.5 |
| TO/CP | 1/0.25 | 2/0.5 | 1/0.25 | >2/0.5 |
| TO/T/S | >2/0.5:9.5 | >2/0.5:9.5 | 2/0.5/9.5 | 1/0.25/4.75 |
| TO/CT | >2/1 | >2/1 | 2/1 | 2/1 |
| T/S/P/T | >0.5:9.5/ | >0.5:9.5/ | >0.5/9.5/16/1 | >0.5/9.5/ |
| | 16:1 | 16:1 | | 16/1 |
| T/S/MER | >0.5:9.5/2 | >0.5:9.5/2 | >0.5/9.5/2 | >0.5/9.5/2 |
| T/S/AZT | >0.5:9.5/4 | >0.5:9.5/4 | >0.5/9.5/4 | >0.5/9.5/4 |
| T/S/CAZ | >0.5:9.5/4 | >0.5:9.5/4 | >0.5/9.5/4 | >0.5/9.5/4 |
| CP/AZT | 0.25/2 | 0.5/4 | >0.5/4 | >0.5/4 |
| CP/CT | >0.5/1 | >0.5/1 | >0.5/1 | >0.5/1 |
| CP/T/S | >0.5/0.5:9.5 | >0.5/0.5:9.5 | 0.5/0.5/9.5 | 0.5/0.5/9.5 |
| CP/MER | >0.5/2 | 0.5/2 | >0.5/2 | 0.5/2 |
| CP/P/T | >0.5/16:1 | >0.5/16:1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | >8 |
| P/T | >16:1 | >16:1 | >16/1 | >16/1 |
| AZT | >4 | >4 | >4 | >4 |
| CT | >1 | >1 | >1 | >1 |
| GM | >2 | >2 | 2 | >2 |
| TO | 2 | >2 | >2 | >2 |
| T/S | >0.5:9.5 | >0.5:9.5 | >0.5/9.5 | >0.5/9.5 |
| C | >4 | >4 | >4 | >4 |
| CP | 0.5 | >0.5 | >0.5 | >0.5 |
| CAZ | >4 | >4 | >4 | >4 |
| CPE | >4 | >4 | >4 | >4 |
| MER | >2 | >2 | >1 | >1 |

TABLE 4
Prevention of Pseudomonas aeruginosa biofilm
formation by compound 6.

| | MBEC¹-Biofilm Inhibition | | | |
|---|---|---|---|---|
| | | With 0.05% | MBEC²-Biofilm Elimination | |
| | | compound | | With 0.05% |
| Antibiotic | Without | 6 in 5% | Without | compound 6 in |
| Combination | compound 6 | EtOH/PBS | compound 6 | 5% EtOH/PBS |
| GM/AZT | 2/4 | >2/4 | 2/4 | >2/4 |
| GM/CAZ | >2/4 | >2/4 | >2/4 | >2/4 |
| GM/P/T | 2/16:1 | >2/16:1 | 2/16/1 | >2/16/1 |
| GM/CPE | >2/4 | >2/4 | >2/4 | >2/4 |
| GM/MER | 2/2 | >2/2 | >2/2 | >2/2 |
| GM/CP | >2/0.5 | 2/0.5 | >2/0.5 | >2/0.5 |
| GM/T/S | >2/0.5:9.5 | >2/0.5:9.5 | 2/0.5/9.5 | >2/0.5/9.5 |
| GM/CT | >2/1 | >2/1 | >2/1 | >2/1 |
| AK/AZT | 8/4 | >8/4 | >8/4 | >8/4 |
| AK/CAZ | >8/4 | >8/4 | 4/2 | No BP |
| AK/P/T | >8/16:1 | >8/16:1 | >8/16/1 | 8/16/1-2/4/0.25 |
| AK/CPE | >8/4 | >8/4 | 8/4 | 8/4 |
| AK/MER | 8/2 | >8/2 | >8/2 | >8/2 |
| AK/CP | >8/0.5 | >8/0.5 | 4/0.25 | 8/0.5 |
| AK/T/S | >8/0.5:9.5 | >8/0.5:9.5 | 8/0.5/9.5 | 8/0.5/9.5 |
| AK/CT | >8/1 | >8/1 | 8/1 | >8/1 |
| TO/AZT | 2/4 | >2/4 | 1/2 | >2/4 |
| TO/CAZ | >2/4 | >2/4 | 0.5/1 | 0.5/1 |
| TO/P/T | >2/16:1 | >2/16:1 | 0.5/4/0.25 | <0.25/2/0.125 |
| TO/CPE | >2/4 | >2/4 | 2/4-0.5/1 | 2/4-0.5/1 |
| TO/MER | 2/2 | >2/2 | 1/1 | >2/2 |
| TO/CP | >2/0.5 | 2/0.5 | 0.5/0.125 | 1/0.25 |
| TO/T/S | >2/0.5:9.5 | >2/0.5:9.5 | 0.5/0.125/ | 1/0.25/4.75 |
| | | | 2.375 | |
| TO/CT | >2/1 | >2/1 | 1/0.5 | 2/1 |
| T/S/P/T | >0.5:9.5/ | >0.5:9.5/ | >0.5/9.5/ | >0.5/9.5/16/1 |
| | 16:1 | 16:1 | 16/1 | |
| T/S/MER | >0.5:9.5/2 | >0.5:9.5/2 | >0.5/9.5/2 | >0.5/9.5/2 |
| T/S/AZT | >0.5:9.5/4 | >0.5:9.5/4 | >0.5/9.5/4 | >0.5/9.5/4 |
| T/S/CAZ | >0.5:9.5/4 | >0.5:9.5/4 | >0.5/9.5/4 | >0.5/9.5/4 |
| CP/AZT | 0.5/4 | >0.5/4 | >0.5/4 | >0.5/4 |
| CP/CT | >0.5/1 | 0.5/1 | 0.5/1 | 0.5/1 |
| CP/T/S | >0.5/0.5:9.5 | 0.5/0.5:9.5 | 0.5/0.5/9.5 | 0.5/0.5/9.5 |
| CP/MER | >0.5/2 | 0.5/2 | >0.5/2 | >0.5/2 |
| CP/P/T | 0.5/16:1 | >0.5/16:1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | >8 |
| P/T | >16:1 | >16:1 | >16/1 | >16/1 |
| AZT | >4 | >4 | >4 | >4 |
| CT | >1 | >1 | >1 | >1 |
| GM | >2 | >2 | >2 | >2 |
| TO | >2 | >2 | >2 | >2 |
| T/S | >0.5:9.5 | >0.5:9.5 | >0.5/9.5 | >0.5/9.5 |
| C | >4 | >4 | >4 | >4 |
| CP | >0.5 | >0.5 | >0.5 | >0.5 |
| CAZ | >4 | >4 | >4 | >4 |
| CPE | >4 | >4 | >4 | >4 |
| MER | >2 | >2 | >1 | >1 |

TABLE 5
Prevention of Pseudomonas aeruginosa biofilm
formation by compound 3.

| | MBEC¹-Biofilm Inhibition | | | |
|---|---|---|---|---|
| | | With 0.05% | MBEC²-Biofilm Elimination | |
| | | compound | | With 0.05% |
| Antibiotic | Without | 3 in 5% | Without | compound 3 in |
| Combination | compound 3 | EtOH/PBS | compound 3 | 5% EtOH/PBS |
| GM/AZT | 2/4 | >2/4 | 2/4 | >2/4 |
| GM/CAZ | >2/4 | >2/4 | >2/4 | >2/4 |
| GM/P/T | 2/16:1 | >2/16:1 | 2/16/1 | 1/8/0.5 |
| GM/CPE | >2/4 | 2/4 | >2/4 | 2/4 |
| GM/MER | 2/2 | 2/2 | >2/2 | >2/2 |
| GM/CP | >2/0.5 | 2/0.5 | >2/0.5 | >2/0.5 |
| GM/T/S | >2/0.5:9.5 | >2/0.5:9.5 | 2/0.5/9.5 | 2/0.5/9.5 |
| GM/CT | >2/1 | >2/1 | >2/1 | 2/1 |
| AK/AZT | 8/4 | 8/4 | >8/4 | >8/4 |
| AK/CAZ | >8/4 | >8/4 | 4/2 | No BP |
| AK/P/T | >8/16:1 | >8/16:1 | >8/16/1 | 4/8/0.5 |
| AK/CPE | >8/4 | >8/4 | 8/4 | 8/4 |
| AK/MER | 8/2 | 8/2 | >8/2 | >8/2 |
| AK/CP | >8/0.5 | 8/0.5 | 4/0.25 | 4/0.25 |
| AK/T/S | >8/0.5:9.5 | >8/0.5:9.5 | 8/0.5/9.5 | 8/0.5/9.5 |
| AK/CT | >8/1 | >8/1 | 8/1 | 8/1 |
| TO/AZT | 2/4 | >2/4 | 1/2 | >2/4 |
| TO/CAZ | >2/4 | >2/4 | 0.5/1 | <0.25/0.5 |
| TO/P/T | >2/16:1 | >2/16:1 | 0.5/4/0.25 | 1/8/0.5 |
| TO/CPE | >2/4 | 2/4 | 2/4-0.5/1 | 2/4-0.5/1 |
| TO/MER | 2/2 | 2/2 | 1/1 | 0.5/0.5 |
| TO/CP | >2/0.5 | >2/0.5 | 0.5/0.125 | 1/0.25 |
| TO/T/S | >2/0.5:9.5 | >2/0.5:9.5 | 0.5/0.125/ | 1/0.25/4.75 |
| | | | 2.375 | |
| TO/CT | >2/1 | >2/1 | 1/0.5 | 2/1 |
| T/S/P/T | >0.5:9.5/ | >0.5:9.5/ | >0.5/9.5/ | >0.5/9.5/16/1 |
| | 16:1 | 16:1 | 16/1 | |
| T/S/MER | >0.5:9.5/2 | >0.5:9.5/2 | >0.5/9.5/2 | >0.5/9.5/2 |
| T/S/AZT | >0.5:9.5/4 | >0.5:9.5/4 | >0.5/9.5/4 | >0.5/9.5/4 |
| T/S/CAZ | >0.5:9.5/4 | >0.5:9.5/4 | >0.5/9.5/4 | >0.5/9.5/4 |
| CP/AZT | 0.5/4 | 0.5/4 | >0.5/4 | >0.5/4 |
| CP/CT | >0.5/1 | >0.5/1 | 0.5/1 | 0.5/1 |
| CP/T/S | >0.5/0.5:9.5 | 0.5/0.5:9.5 | 0.5/0.5/9.5 | 0.5/0.5/9.5 |
| CP/MER | >0.5/2 | >0.5/2 | >0.5/2 | 0.5/2 |
| CP/P/T | 0.5/16:1 | 0.5/16:1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | >8 |
| P/T | >16:1 | >16:1 | >16/1 | >16/1 |
| AZT | >4 | >4 | >4 | >4 |
| CT | >1 | >1 | >1 | >1 |
| GM | >2 | >2 | >2 | >2 |
| TO | >2 | >2 | >2 | >2 |
| T/S | >0.5:9.5 | >0.5:9.5 | >0.5/9.5 | >0.5/9.5 |
| C | >4 | >4 | >4 | >4 |
| CP | >0.5 | >0.5 | >0.5 | >0.5 |
| CAZ | >4 | >4 | >4 | >4 |
| CPE | >4 | >4 | >4 | >4 |
| MER | >2 | >2 | >1 | 1 |

TABLE 6
Prevention of Pseudomonas aeruginosa biofilm formation by compound 2.

| | MBEC¹-Biofilm Inhibition | | MBEC²-Biofilm Elimination | |
|---|---|---|---|---|
| | | With 0.01% | | With 0.01% |
| Antibiotic | Without | compound 2 in 5% | Without | compound 2 in |
| Combination | compound 2 | EtOH/PBS | compound 2 | 5% EtOH/PBS |
| GM/AZT | 2/4 | >2/4 | 2/4 | 2/4 |
| GM/CAZ | >2/4 | 1/2 (>50) | >2/4 | 1/2 |
| GM/P/T | 2/16/1 | 1/8/0.5 (50) | 2/16/1 | 0.5/4/0.25 |
| GM/CPE | >2/4 | 1/2 (>50) | >2/4 | >2/4 |
| GM/MER | 2/2 | 2/2 | >2/2 | >2/2 |
| GM/CP | >2/0.5 | 1/0.25 (>50) | >2/0.5 | 2/0.5 |
| GM/T/S | >2/0.5/9.5 | >2/0.5/9.5 | 2/0.5/9.5 | 2/0.5/9.5 |
| GM/CT | >2/1 | 2/1 (≧50) | >2/1 | >2/1 |
| AK/AZT | 8/4 | 2/1 (50) | >8/4 | >8/4 |
| AK/CAZ | >8/4 | 8/4 (≧50) | 4/2 | 2/1 |
| AK/P/T | >8/16/1 | >8/16/1 | >8/16/1 | 2/4/0.25 |
| AK/CPE | >8/4 | 2/1-8/4 (≧50) | 8/4 | 8/4 |
| AK/MER | 8/2 | 4/1 (50) | >8/2 | >8/2 |
| AK/CP | >8/0.5 | 8/0.5 (≧50) | 4/0.25 | 4/0.25 |
| AK/T/S | >8/0.5/9.5 | 2/0.125/2.375 (≧75) | 8/0.5/9.5 | 8/0.5/9.5- |
| | | | | 2/0.125/2.375 |
| AK/CT | >8/1 | 8/1 (≧50) | 8/1 | 8/1 |
| TO/AZT | 2/4 | 0.5/1 (50) | 1/2 | >2/4 |
| TO/CAZ | >2/4 | 1/2 (≧50) | 0.5/1 | <0.25/0.5 |
| TO/P/T | >2/16/1 | 0.5/4/0.25 (≧50) | 0.5/4/0.25 | <0.25/2/0.125 |
| TO/CPE | >2/4 | 0.5/1 (≧50) | 2/4-0.5/1 | 2/4-0.5/1 |
| TO/MER | 2/2 | 0.5/0.5 (75) | 1/1 | 0.5/0.5 |
| TO/CP | >2/0.5 | 1/0.25 (≧50) | 0.5/0.125 | <0.25/0.0625 |
| TO/T/S | >2/0.5/9.5 | <0.25/0.0625/1.1875 | 0.5/0.125/2.375 | 0.25/0.625/1.1875 |
| | | (>87.5) | | |
| TO/CT | >2/1 | 0.5/0.25 (≧75) | 1/0.5 | 2/1-0.5/0.25 |
| T/S/P/T | >0.5/9.5/16:1 | >0.5/9.5/16/1 | >0.5/9.5/16/1 | >0.5/9.5/16/1 |
| T/S/MER | >0.5/9.5/2 | >0.5/9.5/2 | >0.5/9.5/2 | >0.5/9.5/2 |
| T/S/AZT | >0.5/9.5/4 | >0.5/9.5/4 | >0.5/9.5/4 | >0.5/9.5/4 |
| T/S/CAZ | >0.5/9.5/4 | >0.5/9.5/4 | >0.5/9.5/4 | >0.5/9.5/4 |
| CP/AZT | 0.5/4 | >0.5/4 | >0.5/4 | >0.5/4 |
| CP/CT | >0.5/1 | 0.5/1 (≧50) | 0.5/1 | 0.25/0.5 |
| CP/T/S | >0.5/0.5/9.5 | 0.25/0.25/4.75 (≧50) | 0.5/0.5/9.5 | >0.5/0.5/9.5 |
| CP/MER | >0.5/2 | 0.5/2 (≧50) | >0.5/2 | >0.5/2 |
| CP/P/T | 0.5/16/1 | 0.5/16/1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | 2-8 (≧50) | >8 | 8 |
| P/T | >16/1 | >16/1 | >16/1 | >16/1 |
| AZT | >4 | >4 | >4 | >4 |
| CT | >1 | >1 | >1 | 0.5 |
| GM | >2 | >2 | >2 | >2 |
| TO | >2 | >2 | >2 | 1 |
| T/S | >0.5/9.5 | >0.5/9.5 | >0.5/9.5 | >0.5/9.5 |
| C | >4 | >4 | >4 | >4 |
| CP | >0.5 | 0.5 (≧50) | >0.5 | >0.5 |
| CAZ | >4 | >4 | >4 | >4 |
| CPE | >4 | >4 | >4 | >4 |
| MER | >2 | >2 | >1 | >1 |

TABLE 7
Prevention of Pseudomonas aeruginosa biofilm formation by compound 7.

| | MBEC¹-Biofilm Inhibition | | MBEC²-Biofilm Elimination | |
|---|---|---|---|---|
| | | With 0.01% | | With |
| Antibiotic | Without | compound 7 in | Without | 0.01% compound 7 |
| Combination | compound 7 | 5% EtOH/PBS | compound 7 | in 5% EtOH/PBS |
| GM/AZT | 2/4 | <0.25/0.5 | 2/4 | >2/4 |
| | | (>87.5) | | |
| GM/CAZ | >2/4 | <0.25/0.5 | >2/4 | 2/4 |
| | | (>87.5) | | |
| GM/P/T | 2/16/1 | >2/16/1 | 2/16/1 | 1/8/0.5 |
| GM/CPE | >2/4 | 0.5/1-2/4 (>75) | >2/4 | >2/4 |
| GM/MER | 2/2 | <0.25/0.25 | >2/2 | >2/2 |
| | | (≧87.5) | | |
| GM/CP | >2/0.5 | <0.25/0.0625 | >2/0.5 | 1/0.25 |
| | | (>87.5) | | |
| GM/T/S | >2/0.5/9.5 | >2/0.5/9.5 | 2/0.5/9.5 | >2/0.5/9.5 |
| GM/CT | >2/1 | 0.5/0.25-2/1 | >2/1 | >2/1 |
| | | (>87.5) | | |
| AK/AZT | 8/4 | <1/0.5 (>75) | >8/4 | >8/4 |
| AK/CAZ | >8/4 | <1/0.5 (>75) | 4/2 | <1/0.5 |
| AK/P/T | >8/16/1 | >8/16/1 | >8/16/1 | 8/16/1-2/4/0.25 |
| AK/CPE | >8/4 | <1/0.5 (>75) | 8/4 | >8/4 |
| AK/MER | 8/2 | data not available | >8/2 | >8/2 |
| AK/CP | >8/0.5 | data not available | 4/0.25 | 2/0.125 |
| AK/T/S | >8/0.5/9.5 | data not available | 8/0.5/9.5 | 8/0.5/9.5- |
| | | | | 2/0.125/2.375 |
| AK/CT | >8/1 | data not available | 8/1 | >8/1 |
| TO/AZT | 2/4 | 2/4 | 1/2 | >2/4 |
| TO/CAZ | >2/4 | data not available | 0.5/1 | <0.25/0.5 |
| TO/P/T | >2/16/1 | data not available | 0.5/4/0.25 | <0.25/2/0.125 |
| TO/CPE | >2/4 | data not available | 2/4-0.5/1 | <0.25/0.5 |
| TO/MER | 2/2 | data not available | 1/1 | 0.5/0.5 |
| TO/CP | >2/0.5 | data not available | 0.5/0.125 | <0.25/0.0625 |
| TO/T/S | >2/0.5/9.5 | data not available | 0.5/0.125/2.375 | 0.25/0.625/1.1875 |
| TO/CT | >2/1 | data not available | 1/0.5 | 2/1-0.5/0.25 |
| T/S/P/T | >0.5/9.5/16:1 | >0.5/9.5/16/1 | >0.5/9.5/16/1 | >0.5/9.5/16/1 |
| T/S/MER | >0.5/9.5/2 | >0.5/9.5/2 | >0.5/9.5/2 | >0.5/9.5/2 |
| T/S/AZT | >0.5/9.5/4 | >0.5/9.5/4 | >0.5/9.5/4 | >0.5/9.5/4 |
| T/S/CAZ | >0.5/9.5/4 | >0.5/9.5/4 | >0.5/9.5/4 | >0.5/9.5/4 |
| CP/AZT | 0.5/4 | 0.5/4 | >0.5/4 | >0.5/4 |
| CP/CT | >0.5/1 | 0.5/1 (>50) | 0.5/1 | 0.5/1 |
| CP/T/S | >0.5/0.5/9.5 | >0.5/0.5/9.5 | 0.5/0.5/9.5 | >0.5/0.5/9.5 |
| CP/MER | >0.5/2 | >0.5/2 | >0.5/2 | >0.5/2 |
| CP/P/T | 0.5/16/1 | >0.5/16/1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | 8 |
| P/T | >16/1 | >16/1 | >16/1 | >16/1 |
| AZT | >4 | >4 | >4 | >4 |
| CT | >1 | >1 | >1 | 1 |
| GM | >2 | >2 | >2 | 2 |
| TO | >2 | >2 | >2 | 0.5 |
| T/S | >0.5/9.5 | >0.5/9.5 | >0.5/9.5 | >0.5/9.5 |
| C | >4 | >4 | >4 | >4 |
| CP | >0.5 | >0.5 | >0.5 | >0.5 |
| CAZ | >4 | >4 | >4 | >4 |
| CPE | >4 | >4 | >4 | >4 |
| MER | >2 | >2 | >1 | >1 |

TABLE 8
Prevention of Pseudomonas aeruginosa biofilm
formation by compound 1.

| | MBEC¹-Biofilm Inhibition | | | |
|---|---|---|---|---|
| | | With 0.01% | MBEC²-Biofilm Elimination | |
| | | compound | | With 0.01% |
| Antibiotic | Without | 1 in 5% | Without | compound 1 in |
| Combination | compound 1 | EtOH/PBS | compound 1 | 5% EtOH/PBS |
| GM/AZT | 2/4 | 2/4 | 2/4 | >2/4 |
| GM/CAZ | >2/4 | 2/4 (≧50) | >2/4 | >2/4 |
| GM/P/T | 2/16/1 | 1/8/0.5 (50) | 2/16/1 | 2/16/1 |
| GM/CPE | >2/4 | >2/4 | >2/4 | >2/4 |
| GM/MER | 2/2 | 2/2 | >2/2 | >2/2 |
| GM/CP | >2/0.5 | >2/0.5 | >2/0.5 | >2/0.5 |
| GM/T/S | >2/0.5/9.5 | >2/0.5/9.5 | 2/0.5/9.5 | >2/0.5/9.5 |
| GM/CT | >2/1 | >2/1 | >2/1 | >2/1 |
| AK/AZT | 8/4 | 8/4 | >8/4 | >8/4 |
| AK/CAZ | >8/4 | 8/4 (>50) | 4/2 | 4/2 |
| AK/P/T | >8/16/1 | 8/16/1 (≧50) | >8/16/1 | 2/4/0.25 |
| AK/CPE | >8/4 | 4/2 (>50) | 8/4 | >8/4 |
| AK/MER | 8/2 | 8/2 | >8/2 | >8/2 |
| AK/CP | >8/0.5 | 4/0.25 (>50) | 4/0.25 | 4/0.25 |
| AK/T/S | >8/0.5/9.5 | >8/0.5/9.5 | 8/0.5/9.5 | 8/0.5/9.5- |
| | | | | 2/0.125/2.375 |
| AK/CT | >8/1 | >8/1 | 8/1 | >8/1 |
| TO/AZT | 2/4 | 0.5/1 (75) | 1/2 | >2/4 |
| TO/CAZ | >2/4 | 2/4 (≧50) | 0.5/1 | No BP |
| TO/P/T | >2/16/1 | >2/16/1 | 0.5/4/0.25 | <0.25/2/0.125 |
| TO/CPE | >2/4 | 0.5/1 (>75) | 2/4-0.5/1 | >2/4 |
| TO/MER | 2/2 | 0.5/0.5 (750 | 1/1 | >2/2 |
| TO/CP | >2/0.5 | >2/0.5 | 0.5/0.125 | <0.25/0.0625 |
| TO/T/S | >2/0.5/9.5 | 2/0.5/9.5 | 0.5/0.125/ | No BP |
| | | (≧50) | 2.375 | |
| TO/CT | >2/1 | 0.5/0.25-2/1 | 1/0.5 | 2/1-0.5/0.25 |
| | | (≧50) | | |
| T/S/P/T | >0.5/9.5/ | >0.5/9.5/ | >0.5/9.5/ | >0.5/9.5/16/1 |
| | 16:1 | 16/1 | 16/1 | |
| T/S/MER | >0.5/9.5/2 | >0.5/9.5/2 | >0.5/9.5/2 | >0.5/9.5/2 |
| T/S/AZT | >0.5/9.5/4 | >0.5/9.5/4 | >0.5/9.5/4 | >0.5/9.5/4 |
| T/S/CAZ | >0.5/9.5/4 | >0.5/9.5/4 | >0.5/9.5/4 | >0.5/9.5/4 |
| CP/AZT | 0.5/4 | 0.5/4 | >0.5/4 | >0.5/4 |
| CP/CT | >0.5/1 | >0.5/1 | 0.5/1 | 0.5/1- |
| | | | | 0.125/0.25 |
| CP/T/S | >0.5/0.5/9.5 | >0.5/0.5/9.5 | 0.5/0.5/9.5 | 0.5/0.5/9.5 |
| CP/MER | >0.5/2 | 0.5/2 (≧50) | >0.5/2 | >0.5/2 |
| CP/P/T | 0.5/16/1 | >0.5/16/1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | >8 |
| P/T | >16/1 | >16/1 | >16/1 | >16/1 |
| AZT | >4 | >4 | >4 | >4 |
| CT | >1 | >1 | >1 | 1 |
| GM | >2 | >2 | >2 | 2 |
| TO | >2 | 0.5-2 (≧50) | >2 | >2 |
| T/S | >0.5/9.5 | >0.5/9.5 | >0.5/9.5 | >0.5/9.5 |
| C | >4 | >4 | >4 | >4 |
| CP | >0.5 | 0.5 (≧50) | >0.5 | >0.5 |
| CAZ | >4 | >4 | >4 | >4 |
| CPE | >4 | >4 | >4 | >4 |
| MER | >2 | >2 | >1 | >1 |

TABLE 9
Prevention of Pseudomonas aeruginosa biofilm
formation by salt of compound 2.

| | MBEC¹-Biofilm | | | |
|---|---|---|---|---|
| | Inhibition | | MBEC²-Biofilm Elimination | |
| | Without | With | Without | |
| Antibiotic | salt of | 0.1% salt of | salt of | With 0.1% salt |
| Combination | compound 2 | compound 2 | compound 2 | of compound 2 |
| GM/AZT | 2/4 | >2/4 | >2/4 | 2/4 |
| GM/CAZ | >2/4 | >2/4 | >2/4 | >2/4 |
| GM/P/T | >2/16:1 | >2/16:1 | No BP | 2/16/1 |
| GM/CPE | 2/4 | >2/4 | >2/4 | >2/4 |
| GM/MER | 0.5/0.5-2/2 | 2/2 | >2/2 | >2/2 |
| GM/CP | >2/0.5 | >2/0.5 | >2/0.5 | 2/0.5 |
| GM/T/S | >2/0.5:9.5 | >2/0.5:9.5 | >2/0.5/9.5 | 2/0.5/9.5 |
| GM/CT | >2/1 | >2/1 | >2/1 | >2/1 |
| AK/AZT | 8/4 | 8/4 | >8/4 | >8/4 |
| AK/CAZ | 8/4 | >8/4 | 4/2 | 2/1 |
| AK/P/T | 8/16:1 | >8/16:1 | >8/16/1 | 2/4/0.25 |
| AK/CPE | 8/4 | >8/4 | >8/4 | >8/4 |
| AK/MER | 4/1 | 8/2 | >8/2 | >8/2 |
| AK/CP | 8/0.5 | >8/0.5 | 8/0.5 | 4/0.25 |
| AK/T/S | >8/0.5:9.5 | >8/0.5:9.5 | 8/0.5/9.5 | 8/0.5/9.5 |
| AK/CT | >8/1 | >8/1 | 8/1 | >8/1 |
| TO/AZT | 2/4 | 2/4 | >2/4 | >2/4 |
| TO/CAZ | >2/4 | >2/4 | 1/2 | <0.25/0.5 |
| TO/P/T | >2/16:1 | >2/16:1 | 0.5/4/0.25 | <0.25/2/0.125 |
| TO/CPE | 2/4 | 2/4 | 2/4-0.5/1 | 2/4-0.5/1 |
| TO/MER | No BP | 2/2 | 0.5/0.5 | >2/2 |
| TO/CP | 2/0.5 | 2/0.5 | 1/0.25 | >2/0.5 |
| TO/T/S | >2/0.5:9.5 | >2/0.5:9.5 | 1/0.25/4.75 | 1/0.25/4.75 |
| TO/CT | 2/1 | >2/1 | 2/1 | >2/1 |
| T/S/P/T | >0.5:9.5/ | >0.5:9.5/ | >0.5/9.5/ | >0.5/9.5/16/1 |
| | 16:1 | 16:1 | 16/1 | |
| T/S/MER | >0.5:9.5/2 | >0.5:9.5/2 | >0.5/9.5/2 | >0.5/9.5/2 |
| T/S/AZT | >0.5:9.5/4 | >0.5:9.5/4 | >0.5/9.5/4 | >0.5/9.5/4 |
| T/S/CAZ | >0.5:9.5/4 | >0.5:9.5/4 | >0.5/9.5/4 | >0.5/9.5/4 |
| CP/AZT | 0.5/4 | 0.5/4 | >0.5/4 | >0.5/4 |
| CP/CT | >0.5/1 | >0.5/1 | 0.5/1 | >0.5/1 |
| CP/T/S | >0.5/0.5:9.5 | >0.5/0.5:9.5 | 0.5/0.5/9.5 | >0.5/0.5/9.5 |
| CP/MER | 0.5/2 | >0.5/2 | 0.5/2 | >0.5/2 |
| CP/P/T | 0.5/16:1 | >0.5/16:1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | 8 |
| P/T | >16:1 | >16:1 | >16/1 | >16/1 |
| AZT | >4 | >4 | >4 | >4 |
| CT | >1 | >1 | >1 | >1 |
| GM | >2 | >2 | >2 | >2 |
| TO | >2 | >2 | >2 | >2 |
| T/S | >0.5:9.5 | >0.5:9.5 | >0.5/9.5 | >0.5/9.5 |
| C | >4 | >4 | >4 | >4 |
| CP | >0.5 | >0.5 | >0.5 | 0.5 |
| CAZ | >4 | >4 | >4 | >4 |
| CPE | >4 | >4 | >4 | >4 |
| MER | >2 | >2 | >1 | >1 |

TABLE 10
Prevention of Pseudomonas aeruginosa biofilm
formation by salt of compound 6.

| | MBEC¹-Biofilm | | | |
|---|---|---|---|---|
| | Inhibition | | MBEC²-Biofilm Elimination | |
| | Without | With | Without | |
| Antibiotic | salt of | 0.1% salt of | salt of | With 0.1% salt |
| Combination | compound 6 | compound 6 | compound 6 | of compound 6 |
| GM/AZT | 2/4 | >2/4 | >2/4 | >2/4 |
| GM/CAZ | >2/4 | >2/4 | >2/4 | >2/4 |
| GM/P/T | >2/16:1 | 2/16:1 | No BP | >2/16/1 |
| GM/CPE | 2/4 | 1/2 | >2/4 | >2/4 |
| GM/MER | 0.5/0.5-2/2 | 2/2 | >2/2 | >2/2 |
| GM/CP | >2/0.5 | >2/0.5 | >2/0.5 | >2/0.5 |
| GM/T/S | >2/0.5:9.5 | >2/0.5:9.5 | >2/0.5/9.5 | >2/0.5/9.5 |
| GM/CT | >2/1 | >2/1 | >2/1 | >2/1 |
| AK/AZT | 8/4 | 8/4 | >8/4 | >8/4 |
| AK/CAZ | 8/4 | >8/4 | 4/2 | >8/4 |
| AK/P/T | 8/16:1 | >8/16:1 | >8/16/1 | 4/8/0.5 |
| AK/CPE | 8/4 | 4/2 | >8/4 | 8/4 |
| AK/MER | 4/1 | 8/2 | >8/2 | >8/2 |
| AK/CP | 8/0.5 | 8/0.5 | 8/0.5 | 8/0.5 |
| AK/T/S | >8/0.5:9.5 | >8/0.5:9.5 | 8/0.5/9.5 | 8/0.5/9.5 |
| AK/CT | >8/1 | >8/1 | 8/1 | 8/1 |
| TO/AZT | 2/4 | 2/4 | >2/4 | >2/4 |
| TO/CAZ | >2/4 | >2/4 | 1/2 | >2/4 |
| TO/P/T | >2/16:1 | >2/16:1 | 0.5/4/0.25 | 0.5/4/0.25 |
| TO/CPE | 2/4 | 1/2 | 2/4-0.5/1 | 2/4-0.5/1 |
| TO/MER | NA | 2/2 | 0.5/0.5 | 0.5/0.5 |
| TO/CP | 2/0.5 | 1/0.25 | 1/0.25 | 0.5/0.125 |
| TO/T/S | >2/0.5:9.5 | >2/0.5:9.5 | 1/0.25/4.75 | 1/0.25/4.75 |
| TO/CT | 2/1 | 2/1 | 2/1 | 2/1 |
| T/S/P/T | >0.5:9.5/ | >0.5:9.5/ | >0.5/9.5/ | >0.5/9.5/16/1 |
| | 16:1 | 16:1 | 16/1 | |
| T/S/MER | >0.5:9.5/2 | >0.5:9.5/2 | >0.5/9.5/2 | >0.5/9.5/2 |
| T/S/AZT | >0.5:9.5/4 | >0.5:9.5/4 | >0.5/9.5/4 | >0.5/9.5/4 |
| T/S/CAZ | >0.5:9.5/4 | >0.5:9.5/4 | >0.5/9.5/4 | >0.5/9.5/4 |
| CP/AZT | 0.5/4 | 0.25/2 | >0.5/4 | >0.5/4 |
| CP/CT | >0.5/1 | 0.5/1 | 0.5/1 | 0.25/0.5 |
| CP/T/S | >0.5/0.5:9.5 | 0.5/0.5:9.5 | 0.5/0.5/9.5 | >0.5/0.5/9.5 |
| CP/MER | 0.5/2 | 0.25/1 | 0.5/2 | 0.5/2 |
| CP/P/T | 0.5/16:1 | 0.5/16:1 | >0.5/16/1 | >0.5/16/1 |
| C/MER | >4/2 | >4/2 | >4/2 | >4/2 |
| C/CAZ | >4/4 | >4/4 | >4/4 | >4/4 |
| AK | >8 | >8 | >8 | 8 |
| P/T | >16:1 | >16:1 | >16/1 | >16/1 |
| AZT | >4 | >4 | >4 | >4 |
| CT | >1 | >1 | >1 | >1 |
| GM | >2 | >2 | >2 | >2 |
| TO | >2 | >2 | >2 | >2 |
| T/S | >0.5:9.5 | >0.5:9.5 | >0.5/9.5 | >0.5/9.5 |
| C | >4 | >4 | >4 | >4 |
| CP | >0.5 | >0.5 | >0.5 | >0.5 |
| CAZ | >4 | >4 | >4 | >4 |
| CPE | >4 | >4 | >4 | >4 |
| MER | >2 | >2 | >1 | >1 |

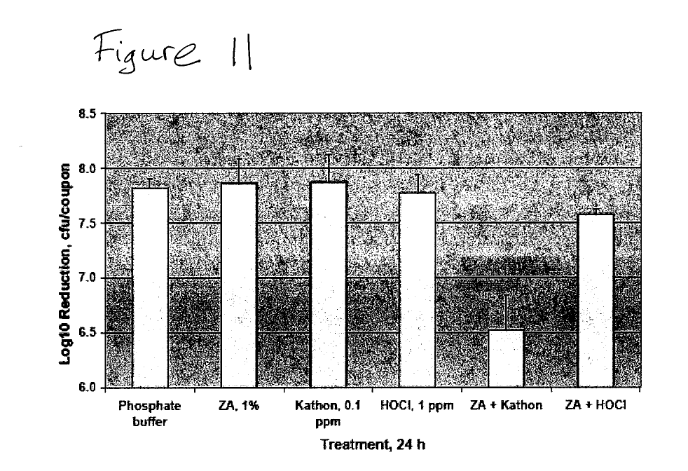

Tables 11 and 12 demonstrate the synergistic effect of ZA with Katho and ZA with HOCl. FIG. 6 is a chart further exemplifying this effect.

TABLE 11
Synergy of Zosteric Acid (ZA) with Kathon vs. P aeruginosa
Synergy of Zosteric Acid (ZA) with Kathon vs.
P aeruginosa 10145 in M9GY

| MIC at 24 hours | | | MIC at 48 hours | | |
|---|---|---|---|---|---|
| (ppm) | | | (ppm) | | |
| Q_{ZA} | Q_{Kath} | SI-Kathon | Q_{ZA} | Q_{Kath} | SI-Kathon |
| 10,000 | 0.8 | | 10,000 | 1 | |
| Q_{za} | Qₖₐₜₕ | | Q_{za} | Qₖₐₜₕ | |
| 0 | 0.8 | 1 | 0 | 1 | 1 |
| 250 | 0.8 | 1.025 | 250 | 0.8 | 0.825 |
| 500 | 0.8 | 1.05 | 500 | 1 | 1.05 |
| 1000 | 1 | 1.35 | 1000 | 1 | 1.1 |
| 2500 | 0.8 | 1.25 | 2500 | 0.8 | 1.05 |
| 5000 | 0.8 | 1.5 | 5000 | 0.8 | 1.3 |
| 7500 | 0.08 | 0.85 | 7500 | 0.1 | 0.85 |
| 10000 | 0.08 | 1.1 | 10000 | 0.08 | 1.08 |

TABLE 12
Synergy of Zosteric Acid (ZA) with HOCL vs. P aeruginosa
Synergy of Zosteric Acid (ZA) with HOCL vs.
P aeruginosa 10145 in M9GY

| MIC at 24 hours | | | MIC at 48 hours | | |
|---|---|---|---|---|---|
| (ppm) | | | (ppm) | | |
| Q_{ZA} | Q_{HOCL} | SI-HOCL | Q_{ZA} | Q_{HOCL} | SI-HOCL |
| 10,000 | 40 | | 10,000 | 40 | |
| Q_{za} | Q_{hocl} | | Q_{za} | Q_{hocl} | |
| 0 | 50 | 1.25 | 0 | 60 | 1.5 |
| 250 | 30 | 0.775 | 250 | 30 | 0.775 |
| 500 | 50 | 1.3 | 500 | 50 | 1.3 |
| 1000 | 50 | 1.35 | 1000 | 50 | 1.35 |
| 2500 | 50 | 1.5 | 2500 | 50 | 1.5 |
| 5000 | 40 | 1.5 | 5000 | 40 | 1.5 |
| 7500 | 40 | 1.75 | 7500 | 50 | 2 |
| 10000 | 60 | 2.5 | 10000 | 60 | 2.5 |

Note:
MIC for ZA is greater than 10,000 ppm, but since it was the highest value tested it was used for SI calculations.

### V. Applications

The antimicrobial compositions of the present invention comprise antimicrobial components that interact synergistically or non-synergistically (non-synergistic compositions have efficiencies that are the sum of the parts or less than the sum of the parts). Novel formulations having adjustable properties based on a particular need can therefore be prepared by selecting what combination yields what effect. Non-limiting applications for such combinations include pharmaceutical and personal healthcare, coatings, and antimicrobial surfaces on such objects as machinery, medical devices, insects, and plants.

Pharmaceutical and Personal Healthcare Formulations

The antimicrobial compositions of the present invention may be administered by various means, depending on their intended use, as is well known in the art. For example, if compositions of the present invention are to be administered orally, they may be formulated as tablets, capsules, granules, powders or syrups. Alternatively, formulations of the present invention may be administered parenterally as injections (intravenous, intramuscular or subcutaneous), drop infusion preparations or suppositories. For application by the ophthalmic mucous membrane route, compositions of the present invention may be formulated as eyedrops or eye ointments. These formulations may be prepared by conventional means, and, if desired, the compositions may be mixed with any conventional additive, such as an excipient, a binder, a disintegrating agent, a lubricant, a corrigent, a solubilizing agent, a suspension aid, an emulsifying agent or a coating agent.

In formulations of the subject invention, wetting agents, emulsifiers and lubricants, such as sodium lauryl sulfate and magnesium stearate, as well as coloring agents, release agents, coating agents, sweetening, flavoring and perfuming agents, preservatives and antioxidants may be present in the formulated agents.

Subject compositions may be suitable for oral, nasal, topical (including buccal and sublingual), rectal, vaginal, aerosol and/or parenteral administration. The formulations may conveniently be presented in unit dosage form and may be prepared by any methods well known in the art of pharmacy. The amount of composition that may be combined with a carrier material to produce a single dose vary depending upon the subject being treated, and the particular mode of administration.

Methods of preparing these formulations include the step of bringing into association compositions of the present invention with the carrier and, optionally, one or more accessory ingredients. In general, the formulations are prepared by uniformly and intimately bringing into association agents with liquid carriers, or finely divided solid carriers, or both, and then, if necessary, shaping the product.

Formulations suitable for oral administration may be in the form of capsules, cachets, pills, tablets, lozenges (using a flavored basis, usually sucrose and acacia or tragacanth), powders, granules, or as a solution or a suspension in an aqueous or non-aqueous liquid, or as an oil-in-water or water-in-oil liquid emulsion, or as an elixir or syrup, or as pastilles (using an inert base, such as gelatin and glycerin, or sucrose and acacia), each containing a predetermined amount of a subject composition thereof as an active ingredient. Compositions of the present invention may also be administered as a bolus, electuary, or paste.

In solid dosage forms for oral administration (capsules, tablets, pills, dragees, powders, granules and the like), the subject composition is mixed with one or more pharmaceutically acceptable carriers, such as sodium citrate or dicalcium phosphate, and/or any of the following: (1) fillers or extenders, such as starches, lactose, sucrose, glucose, mannitol, and/or silicic acid; (2) binders, such as, for example, carboxymethylcellulose, alginates, gelatin, polyvinyl pyrrolidone, sucrose and/or acacia; (3) humectants, such as glycerol; (4) disintegrating agents, such as agar-agar, calcium carbonate, potato or tapioca starch, alginic acid, certain silicates, and sodium carbonate; (5) solution retarding agents, such as paraffin; (6) absorption accelerators, such as quaternary ammonium compounds; (7) wetting agents, such as, for example, acetyl alcohol and glycerol monostearate; (8) absorbents, such as kaolin and bentonite clay; (9) lubricants, such a talc, calcium stearate, magnesium stearate, solid polyethylene glycols, sodium lauryl sulfate, and mixtures thereof; and (10) coloring agents. In the case of capsules, tablets and pills, the compositions may also comprise buffering agents. Solid compositions of a similar type may also be employed as fillers in soft and hard-filled gelatin capsules using such excipients as lactose or milk sugars, as well as high molecular weight polyethylene glycols and the like.

A tablet may be made by compression or molding, optionally with one or more accessory ingredients. Compressed tablets may be prepared using binder (for example, gelatin or hydroxypropylmethyl cellulose), lubricant, inert diluent, preservative, disintegrant (for example, sodium starch glycolate or cross-linked sodium carboxymethyl cellulose), surface-active or dispersing agent. Molded tablets may be made by molding in a suitable machine a mixture of the subject composition moistened with an inert liquid diluent. Tablets, and other solid dosage forms, such as dragees, capsules, pills and granules, may optionally be scored or prepared with coatings and shells, such as enteric coatings and other coatings well known in the pharmaceutical-formulating art.

Liquid dosage forms for oral administration include pharmaceutically acceptable emulsions, microemulsions, solutions, suspensions, syrups and elixirs. In addition to the subject composition, the liquid dosage forms may contain inert diluents commonly used in the art, such as, for example, water or other solvents, solubilizing agents and emulsifiers, such as ethyl alcohol, isopropyl alcohol, ethyl carbonate, ethyl acetate, benzyl alcohol, benzyl benzoate, propylene glycol, 1,3-butylene glycol, oils (in particular, cottonseed, groundnut, corn, germ, olive, castor and sesame oils), glycerol, tetrahydrofuryl alcohol, polyethylene glycols and fatty acid esters of sorbitan, and mixtures thereof.

Suspensions, in addition to the subject composition, may contain suspending agents as, for example, ethoxylated isostearyl alcohols, polyoxyethylene sorbitol and sorbitan esters, microcrystalline cellulose, aluminum metahydroxide, bentonite, agar-agar and tragacanth, and mixtures thereof.

Formulations for rectal or vaginal administration may be presented as a suppository, which may be prepared by mixing a subject composition with one or more suitable non-irritating excipients or carriers comprising, for example, cocoa butter, polyethylene glycol, a suppository wax or a salicylate, and which is solid at room temperature, but liquid at body temperature and, therefore, will melt in the body cavity and release the active agent. Formulations which are suitable for vaginal administration also include pessaries, tampons, creams, gels, pastes, foams or spray formulations containing such carriers as are known in the art to be appropriate.

Dosage forms for transdermal administration of a subject composition includes powders, sprays, ointments, pastes, creams, lotions, gels, solutions, patches and inhalants. The active component may be mixed under sterile conditions with a pharmaceutically acceptable carrier, and with any preservatives, buffers, or propellants which may be required.

The ointments, pastes, creams and gels may contain, in addition to a subject composition, excipients, such as animal and vegetable fats, oils, waxes, paraffins, starch, tragacanth, cellulose derivatives, polyethylene glycols, silicones, bentonites, silicic acid, talc and zinc oxide, or mixtures thereof.

Powders and sprays may contain, in addition to a subject composition, excipients such as lactose, talc, silicic acid, aluminum hydroxide, calcium silicates and polyamide powder, or mixtures of these substances. Sprays may additionally contain customary propellants, such as chlorofluorohydrocarbons and volatile unsubstituted hydrocarbons, such as butane and propane.

Compositions of the present invention may alternatively be administered by aerosol. This is accomplished by preparing an aqueous aerosol, liposomal preparation or solid particles containing the compound. A non-aqueous (e.g., fluorocarbon propellant) suspension could be used. Sonic nebulizers may be used because they minimize exposing the agent to shear, which may result in degradation of the compounds contained in the subject compositions.

Ordinarily, an aqueous aerosol is made by formulating an aqueous solution or suspension of a subject composition together with conventional pharmaceutically acceptable carriers and stabilizers. The carriers and stabilizers vary with the requirements of the particular subject composition, but typically include non-ionic surfactants (Tweens, Pluronics, or polyethylene glycol), innocuous proteins like serum albumin, sorbitan esters, oleic acid, lecithin, amino acids such as glycine, buffers, salts, sugars or sugar alcohols. Aerosols generally are prepared from isotonic solutions.

Pharmaceutical compositions of this invention suitable for parenteral administration comprise a subject composition in combination with one or more pharmaceutically-acceptable sterile isotonic aqueous or non-aqueous solutions, dispersions, suspensions or emulsions, or sterile powders which may be reconstituted into sterile injectable solutions or dispersions just prior to use, which may contain antioxidants, buffers, bacteriostats, solutes which render the formulation isotonic with the blood of the intended recipient or suspending or thickening agents.

Examples of suitable aqueous and non-aqueous carriers which may be employed in the pharmaceutical compositions of the invention include water, ethanol, polyols (such as glycerol, propylene glycol, polyethylene glycol, and the like), and suitable mixtures thereof, vegetable oils, such as olive oil, and injectable organic esters, such as ethyl oleate. Proper fluidity may be maintained, for example, by the use of coating materials, such as lecithin, by the maintenance of the required particle size in the case of dispersions, and by the use of surfactants.

The dosage of any compositions of the present invention will vary depending on the symptoms, age and body weight of the patient, the nature and severity of the disorder to be treated or prevented, the route of administration, and the form of the subject composition. Any of the subject formulations may be administered in a single dose or in divided doses. Dosages for the compositions of the present invention may be readily determined by techniques known to those of skill in the art or as taught herein.

In certain embodiments, the dosage of the subject compounds will generally be in the range of about 0.01 ng to about 10 g per kg body weight, specifically in the range of about 1 ng to about 0.1 g per kg, and more specifically in the range of about 100 ng to about 10 mg per kg.

An effective dose or amount, and any possible affects on the timing of administration of the formulation, may need to be identified for any particular composition of the present invention. This may be accomplished by routine experiment as described herein, using one or more groups of animals (preferably at least 5 animals per group), or in human trials if appropriate. The effectiveness of any subject composition and method of treatment or prevention may be assessed by administering the composition and assessing the effect of the administration by measuring one or more applicable indices, and comparing the post-treatment values of these indices to the values of the same indices prior to treatment.

The precise time of administration and amount of any particular subject composition that will yield the most effective treatment in a given patient will depend upon the activity, pharmacokinetics, and bioavailability of a subject composition, physiological condition of the patient (including age, sex, disease type and stage, general physical condition, responsiveness to a given dosage and type of medication), route of administration, and the like. The guidelines presented herein may be used to optimize the treatment, e.g., determining the optimum time and/or amount of administration, which will require no more than routine experimentation consisting of monitoring the subject and adjusting the dosage and/or timing.

While the subject is being treated, the health of the patient may be monitored by measuring one or more of the relevant indices at predetermined times during the treatment period. Treatment, including composition, amounts, times of administration and formulation, may be optimized according to the results of such monitoring. The patient may be periodically reevaluated to determine the extent of improvement by measuring the same parameters. Adjustments to the amount(s) of subject composition administered and possibly to the time of administration may be made based on these reevaluations.

Treatment may be initiated with smaller dosages which are less than the optimum dose of the compound. Thereafter, the dosage may be increased by small increments until the optimum therapeutic effect is attained.

The use of the subject compositions may reduce the required dosage for any individual agent contained in the compositions because the onset and duration of effect of the different agents may be complimentary.

Toxicity and therapeutic efficacy of subject compositions may be determined by standard pharmaceutical procedures in cell cultures or experimental animals, e.g., for determining the LD₅₀ and the ED₅₀.

The data obtained from the cell culture assays and animal studies may be used in formulating a range of dosage for use in humans. The dosage of any subject composition lies preferably within a range of circulating concentrations that include the ED₅₀ with little or no toxicity. The dosage may vary within this range depending upon the dosage form employed and the route of administration utilized. For compositions of the present invention, the therapeutically effective dose may be estimated initially from cell culture assays.

Applications include cosmetics and other over-the-counter products for human and animal application. Preservatives are used to prevent the growth of bacteria and fungi that may result in product contamination and deterioration. Compounds of the present invention can be used in combination with an existing preservative such as: alcohols; benzoic acid; chlorhexidine; diazolidinyl urea; dimethylol dimethylhydantoin-1,3-bis; isothiazolones; mercurials; parabens; phenolic compounds; quaternary ammonium compounds; and triclosan. Treatment concentrations could be reduced when these agents are used in combination with compounds of the present invention.

Coatings

Coating refers to any temporary, semipermanent or permanent layer, covering or surface. Examples of coatings include polishes, surface cleaners, caulks, adhesives, finishes, paints, waxes polymerizable compositions (including phenolic resins, silicone polymers, chlorinated rubbers, coal tar and epoxy combinations, epoxy resin, polyamide resins, vinyl resins, elastomers, acrylate polymers, fluoropolymers, polyesters and polyurethanes, latex). Silicone resins, silicone polymers (e.g. RTV polymers) and silicone heat cured rubbers are suitable coatings for use in the invention and described for example in the Encyclopedia of Polymer Science and Engineering (1989) 15: 204 et seq. Coatings can be ablative or dissolvable, so that the dissolution rate of the matrix controls the rate at which the antimicrobial agents are delivered to the surface. Coatings can also be non-ablative, and rely on diffusion principles to deliver the antimicrobial agents to the surface. Non-ablative coatings can be porous or non-porous. A coating containing an antimicrobial agent freely dispersed in a polymer binder is referred to as “monolithic” coating. Elasticity can be engineered into coatings to accommodate pliability, e.g. swelling or shrinkage, of the surface to be coated. The coating may also simply be an aqueous solution or suspension.

In one embodiment, the coating is a silicone, polyurethane, resin, or aqueous coating.

Antimicrobial Surfaces

Certain naturally derived processed materials will be determined by artisans in these fields to especially suitable for the application or incorporation of compounds of the invention. A material can be contacted with the claimed compounds in a variety of ways including immersion and coating. In forms where the material has interstices, an antimicrobial composition can reside therein as a liquid or as a gel. Fibrillar preparations can permit the fibers to be coated with the compound. Solid articles such as reconstructive blocks of hydroxyapatite can be painted with a coating of the compound for additional protection. These temporary means of application are appropriate for these materials because they only reside in the body temporarily, to be resorbed or replaced.

Implantable medical devices, using artificial materials alone or in combination with naturally-derived materials, can be treated with compounds either by surface coating or by incorporation. Metals may be suitably treated with surface coats while retaining their biological properties. In certain embodiments of the present invention, metals may be treated with paints or with adherent layers of polymers or ceramics that incorporate the compounds of the invention. Certain embodiments treated in this manner may be suitable for orthopedic applications, for example, pins, screws, plates or parts of artificial joints. Methods for surface treatment of metals for biological use are well-known in the relevant arts. Other materials besides metals can be treated with surface coats of compounds according to the present invention as the medical application requires.

Implantable devices may comprise materials suitable for the incorporation of the instant claimed compounds. Embodiments whose components incorporate compositions of the invention can include polymers, ceramics and other substances. Materials fabricated from artificial materials can also be destined for resorption when they are placed in the body. Such materials can be called bioabsorbable. As an example, polyglycolic acid polymers can be used to fabricate sutures and orthopedic devices. Those of ordinary skill in these arts will be familiar with techniques for incorporating agents into the polymers used to shape formed articles for medical applications. Antimicrobial compositions can also be incorporated into glues, cements or adhesives, or in other materials used to fix structures within the body or to adhere implants to a body structure. Examples include polymethylmethacrylate and its related compounds, used for the affixation of orthopedic and dental prostheses within the body. The presence of the compounds of the instant invention can decrease biofilm formation in those structures in contact with the glue, cement, or adhesive. Alternatively, a compound of the invention can coat or can permeate the formed article. In these compositions, the formed article allows diffusion of the compound, or functional portion thereof, into the surrounding environment, thereby preventing fouling of the appliance itself. Microcapsules bearing compounds can also be imbedded in the material. Materials incorporating compounds are adaptable to the manufacture of a wide range of medical devices, some of which are disclosed below. Other examples will be readily apparent to those practitioners of ordinary skill in the art.

In one embodiment, compounds of the invention can be applied to or incorporated in certain medical devices that are intended to be left in position permanently to replace or restore vital functions. As one example, ventriculoatrial or ventriculoperitoneal shunts are devised to prevent cerebrospinal fluid from collecting in the brain of patients whose normal drainage channels are impaired. As long as the shunt functions, fluid is prevented from accumulating in the brain and normal brain function can continue. If the shunt ceases to function, fluid accumulates and compresses the brain, with potentially life-threatening effect. If the shunt becomes infected, it causes an infection to enter the central portions of the brain, another life-threatening complication. These shunts commonly include a silicone elastomer or another polymer as part of their fabrication. Silicones are understood to be especially suited for combination with compounds according to the present invention.

Another shunt that has life-saving import is a dialysis shunt, a piece of polymeric tubing connecting an artery and a vein in the forearm to provide the kidney failure patient a means by which the dialysis equipment can cleanse the bloodstream. Even though this is a high-flow conduit, it is susceptible to the formation of biofilms and subsequent infection. If a shunt becomes infected, it requires removal and replacement. Since dialysis may be a lifelong process, and since there are a limited number of sites where shunts can be applied, it is desirable to avoid having to remove one through infectious complications. Imbedding or otherwise contacting the compounds of the invention with the shunt material can have this desired effect.

Heart valves comprising artificial material are understood to be vulnerable to the dangerous complication of prosthetic valve endocarditis. Once established, it carries a mortality rate as high as 70%. Biofilms are integrally involved in the development of this condition. At present, the only treatment for established contamination is high-dose antibiotic therapy and surgical removal of the device. The contaminated valve must be immediately replaced, since the heart cannot function without it. Because the new valve is being inserted in a recently contaminated area, it is common for prosthetic valve endocarditis to affect the replacement valve as well. Artificial heart valves comprised of the compounds of the invention may reduce the incidence of primary and recurrent prosthetic valve endocarditis. Compounds of the invention can be applied to the synthetic portions or the naturally-derived portions of heart valves.

Pacemakers and artificial implantable defibrillators commonly comprise metallic parts in combination with other synthetic materials. These devices, which may be coated with a polymeric substance such as silicone are typically implanted in subcutaneous or intramuscular locations with wires or other electrical devices extending intrathoracically or intravascularly. If the device becomes colonized with microorganisms and infected, it must be removed. A new device can be replaced in a different location, although there are a finite number of appropriate implantation sites on the body. Devices comprising the compounds of the invention may inhibit contamination and infection, or substantially reduce the risk thereof.

Devices implanted into the body either temporarily or permanently to pump pharmacological agents into the body can comprise metallic parts in combination with other synthetic materials. Such devices, termed infusion pumps, can be entirely implanted or can be partially implanted. The device may be partially or entirely covered with a polymeric substance, and may comprise other polymers used as conduits or tubes. Incorporating antimicrobial compositions according to the present invention into the coating materials imposed upon these devices or into the materials used for the devices themselves, their conduits or their tubing may inhibit their contamination and infection.

Equally lifesaving are the various vascular grafting prostheses and stents intended to bypass blocked arteries or substitute for damaged arteries. Vascular grafting prostheses, made of Teflon, dacron, Gore-tex®, expanded polytetrafluoroethylene (e-PTFE), and related materials, are available for use on any major blood vessel in the body. Commonly, for example, vascular grafting prostheses are used to bypass vessels in the leg and are used to substitute for a damaged aorta. They are put in place by being sewn into the end or the side of a normal blood vessel upstream and downstream of the area to be bypassed or replaced, so that blood flows from a normal area into the vascular grafting prosthesis to be delivered to other normal blood vessels. Stents comprising metallic frames covered with vascular grafting prosthesis fabric are also available for endovascular application, to repair damaged blood vessels.

When a vascular grafting prosthesis becomes infected, it can spread infection through the entire bloodstream. Furthermore, the infection can weaken the attachment of the vascular grafting prosthesis to the normal blood vessel upstream or downstream, so that blood can leak out of it. If the attachment ruptures, there can be life-threatening hemorrhage. When a vascular grafting prosthesis becomes infected, it needs to be removed. It is especially dangerous to put another vascular grafting prosthesis in the same spot because of the risk of another infection, but there are often few other options. Vascular grafting prostheses comprising compounds of the invention can resist infections, thereby avoiding these devastating complications.

Vascular grafting prostheses of small caliber are particularly prone to clotting. A vascular grafting prosthesis comprising a compound of the invention may not only prevent biofilm formation, but also inhibit clotting as described above, allowing a smaller diameter vascular grafting prosthesis to be more reliable. A common site for clotting is the junction point between the vascular grafting prosthesis and the normal vessel, called the anastomosis. Even if an artificial vascular grafting prosthesis is not used, anywhere that two vessels are joined or anywhere there is a suture line that penetrates a natural blood vessel, there is a potential for clotting to take place. A clot in a vessel can occlude the vessel entirely or only partially; in the latter case, blood clots can be swept downstream, damaging local tissues. Using suture comprised of the compounds of the invention may inhibit clotting at these various suture lines. The smaller the vessel, the more likely that a clot forming within it will lead to a total occlusion of the vessel. This can have disastrous results: if the main vessel feeding a tissue or an organ becomes totally occluded, that structure loses its blood supply and can die. Microsurgery provides dramatic examples of the damage that can occur with anastomotic clotting. In microsurgery, typically only a single tiny vessel is feeding an entire tissue structure like a finger or a muscle. If the vessel clots off, the tissue structure can quickly die. Microsurgery typically involves vessels only one to four millimeters in diameter. It is understood that the sutures penetrating the vessel at the anastomosis are likely sites for clots to form. Microsurgical sutures comprising a compound of the invention would result in localized administration of an anticoagulant at the site most likely to be damaged by clotting.

Suture material used to anchor vascular grafting prostheses to normal blood vessels or to sew vessels or other structures together can also harbor infections. Sutures used for these purposes are commonly made of prolene, nylon or other monofilamentous nonabsorbable materials. An infection that begins at a suture line can extend to involve the vascular grafting prosthesis. Suture materials comprising a compound of the invention would have increased resistance to infection.

A suture comprising a compound of the invention would be useful in other areas besides the vasculature. Wound infections at surgical incisions may arise from microorganisms that lodge in suture materials placed at various levels to close the incision. General surgery uses both nonabsorbable and absorbable sutures. Materials for nonabsorbable sutures include prolene and nylon. Absorbable sutures include materials like treated catgut and polyglycolic acid. Absorbable sutures retain tensile strength for periods of time from days to months and are gradually resorbed by the body. Fabricating an absorbable or a nonabsorbable suture comprising a compound of the invention and which retains the handling and tensile characteristics of the material is within the skill of artisans in the field.

A general principle of surgery is that when a foreign object becomes infected, it most likely needs to be removed so that the infection can be controlled. So, for example, when sutures become infected, they may need to be surgically removed to allow the infection to be controlled. Any area where surgery is performed is susceptible to a wound infection. Wound infections can penetrate to deeper levels of the tissues to involve foreign material that has been used as part of the operation. As an example, hernias are commonly repaired by suturing a plastic screening material called mesh in the defect. A wound infection that extends to the area where the mesh has been placed can involve the mesh itself, requiring that the mesh be removed. Surgical meshes comprising a compound of the invention can have increased resistance to infection. Surgical meshes are made of substances like Gore-tex®, teflon, nylon and Marlex®. Surgical meshes are used to close deep wounds or to reinforce the enclosure of body cavities. Removing an infected mesh can leave an irreparable defect, with life-threatening consequences. Avoiding infection of these materials is of paramount importance in surgery. Materials used for meshes and related materials can be formulated to include the claimed compounds of the instant invention.

Materials similar to vascular grafting prostheses and surgical meshes are used in other sites in the body. Medical devices used in these locations similarly can benefit from the compounds of the invention; when these devices are located in the bloodstream, these agents' anticoagulant effects provide further benefit. Examples include hepatic shunts, vena caval filters and atrial septal defect patches, although other examples will be apparent to practitioners in these arts.

Certain implantable devices intended to restore structural stability to body parts can be advantageously treated with the instant claimed compounds. A few examples follow, and others will be readily identified by ordinary skilled artisans. Implantable devices, used to replace bones or joints or teeth, act as prostheses or substitutes for the normal structure present at that anatomic site. Metallics and ceramics are commonly used for orthopedic and dental prostheses. Implants may be anchored in place with cements like polymethylmethacrylate. Prosthetic joint surfaces can be fabricated from polymers such as silicones or Teflon™. Entire prosthetic joints for fingers, toes or wrists can be made from polymers.

Medical prostheses comprising compounds of the invention would be expected to have reduced contamination and subsequent local infection, thereby obviating or reducing the need to remove the implant with the attendant destruction of local tissues. Destruction of local tissues, especially bones and ligaments, can make the tissue bed less hospitable for supporting a replacement prosthesis. Furthermore, the presence of contaminating microorganisms in surrounding tissues makes recontamination of the replacement prosthesis easily possible. The effects of repeated contamination and infection of structural prosthetics is significant: major reconstructive surgery may be required to rehabilitate the area in the absence of the prosthesis, potentially including free bone transfers or joint fusions. Furthermore, there is no guarantee that these secondary reconstructive efforts will not meet with infectious complications as well. Major disability, with possible extremity amputation, is the outcome from contamination and infection of a structural prosthesis.

Certain implantable devices are intended to restore or enhance body contours for cosmetic or reconstructive applications. A well-known example of such a device is the breast implant, a gel or fluid containing sac made of a silicone elastomer. Other polymeric implants exist that are intended for permanent cosmetic or reconstructive uses. Solid silicone blocks or sheets can be inserted into contour defects. Other naturally occurring or synthetic biomaterials are available for similar applications. Craniofacial surgical reconstruction can involve implantable devices for restoring severely deformed facial contours in addition to the techniques used for restructuring natural bony contours. These devices, and other related devices well-known in the field, are suitable for coating with or impregnation with antimicrobial compositions to reduce their risk of contamination, infection and subsequent removal.

Tissue expanders are sacs made of silicone elastomers adapted for gradual filling with a saline solution, whereby the filling process stretches the overlying tissues to generate an increased area of tissue that can be used for other reconstructive applications. Tissue expanders can be used, for example, to expand chest wall skin and muscle after mastectomy as a step towards breast reconstruction. Tissue expanders can also be used in reconstructing areas of significant skin loss in burn victims. A tissue expander is usually intended for temporary use: once the overlying tissues are adequately expanded, they are stretched to cover their intended defect. If a tissue expander is removed before the expanded tissues are transposed, though, all the expansion gained over time is lost and the tissues return nearly to their pre-expansion state. The most common reason for premature tissue expander removal is infection. These devices are subjected to repeated inflations of saline solution, introduced percutaneously into remote filling devices that communicate with the expander itself. Bacterial contamination of the device is thought to occur usually from the percutaneous inflation process. Once contamination is established and a biofilm forms, local infection is likely. Expander removal, with the annulment of the reconstructive effort, is needed to control the infection. A delay of a number of months is usually recommended before a new tissue expander can be inserted in the affected area. The silicone elastomer used for these devices is especially suitable for integrating with the antimicrobial compositions of the present invention. Use of these agents in the manufacture of these articles may reduce the incidence of bacterial contamination, biofilm development and subsequent local infection.

Insertable devices include those objects made from synthetic materials applied to the body or partially inserted into the body through a natural or an artificial site of entry. Examples of articles applied to the body include contact lenses and stoma appliances. An artificial larynx is understood to be an insertable device in that it exists in the airway, partially exposed to the environment and partially affixed to the surrounding tissues. An endotracheal or tracheal tube, a gastrostomy tube or a catheter are examples of insertable devices partially existing within the body and partially exposed to the external environment. The endotracheal tube is passed through an existing natural orifice. The tracheal tube is passed through an artificially created orifice. Under any of these circumstances, the formation of biofilm on the device permits the ingress of microorganisms along the device from a more external anatomic area to a more internal anatomic area. The ascent of microorganisms to the more internal anatomic area commonly causes local and systemic infections.

As an example, biofilm formation on soft contact lenses is understood to be a risk factor for contact-lens associated corneal infection. The eye itself is vulnerable to infections due to biofilm production. Incorporating an antifouling agent in the contact lens itself and in the contact lens case can reduce the formation of biofilms, thereby reducing risk of infection. The antimicrobial compositions of the present invention can also be incorporated in ophthalmic preparations that are periodically instilled in the eye.

As another example, biofilms are understood to be responsible for infections originating in tympanostomy tubes and in artificial larynxes. Biofilms further reside in tracheostomy tubes and in endotracheal tubes, permitting the incursion of pathogenic bacteria into the relatively sterile distal airways of the lung. These devices are adaptable to the incorporation or the topical application of antimicrobial compositions to reduce biofilm formation and subsequent infectious complications.

As another example, a wide range of vascular catheters are fabricated for vascular access. Temporary intravenous catheters are placed distally, while central venous catheters are placed in the more proximal large veins. Catheter systems can include those installed percutaneously whose hubs are external to the body, and those whose access ports are buried beneath the skin. Examples of long-term central venous catheters include Hickman catheters and Port-a-caths. Catheters permit the infusion of fluids, nutrients and medications; they further can permit the withdrawal of blood for diagnostic studies or the transfusion of blood or blood products. They are prone to biofilm formation, increasingly so as they reside longer within a particular vein. Biofilm formation in a vascular access device can lead to the development of a blood-borne infection as planktonic organisms disseminate from the biofilm into the surrounding bloodstream. Further, biofilm formation can contribute to the occlusion of the device itself, rendering it non-functional. If the catheter is infected, or if the obstruction within it cannot be cleared, the catheter must be removed. Commonly, patients with these devices are afflicted with serious medical conditions. These patients are thus poorly able to tolerate the removal and replacement of the device. Furthermore, there are only a limited number of vascular access sites. A patient with repeated catheter placements can run out of locations where a new catheter can be easily and safely placed. Incorporation of antimicrobial compositions within catheter materials or application of these agents to catheter materials can reduce fouling and biofilm formation, thereby contributing to prolonged patency of the devices and minimizing the risk of infectious complications.

As another example, a biliary drainage tube is used to drain bile from the biliary tree to the body's exterior if the normal biliary system is blocked or is recovering from a surgical manipulation. Drainage tubes can be made of plastics or other polymers. A biliary stent, commonly fabricated of a plastic material, can be inserted within a channel of the biliary tree to keep the duct open so that bile can pass through it. Biliary sludge which forms as a result of bacterial adherence and biofilm formation in the biliary system is a recognized cause of blockage of biliary stents. Pancreatic stents, placed to hold the pancreatic ducts open or to drain a pseudocyst of the pancreas, can also become blocked with sludge. Biofilms are furthermore implicated in the ascent of infections into the biliary tree along a biliary drainage tube. Ascending infections in the biliary tree can result in the dangerous infectious condition called cholangitis. Incorporation of compounds of the invention in the materials used to form biliary drainage tubes and biliary stents can reduce the formation of biofilms, thereby decreasing risk of occlusions and infections.

As another example, a peritoneal dialysis catheter is used to remove bodily wastes in patients with renal failure by using fluids instilled into and then removed from the peritoneal cavity. This form of dialysis is an alternative to hemodialysis for certain renal failure patients. Biofilm formation on the surfaces of the peritoneal dialysis catheter can contribute to blockage and infection. An infection entering the peritoneal cavity is termed a peritonitis, an especially dangerous type of infection. Peritoneal dialysis catheters, generally made of polymeric materials like polyethylene, can be coated with or impregnated with the antimicrobial compositions to reduce the formation of biofilms.

As yet another example, a wide range of urological catheters function to provide drainage of the urinary system. These catheters can either enter the natural orifice of the urethra to drain the bladder, or they can be adapted for penetration of the urinary system through an iatrogenically created insertion site. Nephrostomy tubes and suprapubic tubes represent examples of the latter. Catheters can be positioned in the ureters on a semipermanent basis to hold the ureter open; such a catheter is called a ureteral stent. Urological catheters can be made from a variety of polymeric products. Latex and rubber tubes have been used, as have silicones. All catheters are susceptible to biofilm formation. This leads to the problem of ascending urinary tract infections, where the biofilm can spread proximally, carrying pathogenic organisms, or where the sessile organisms resident in the biofilm can propagate planktonic organisms that are capable of tissue and bloodstream invasion. Organisms in the urinary tract are commonly gram-negative bacteria capable of producing life-threatening bloodstream infections if they spread systemically. Infections wherein these organisms are restricted to the urinary tract can nonetheless be dangerous, accompanied by pain and high fever. Urinary tract infections can lead to kidney infections, called pyelonephritis, which can jeopardize the function of the kidney. Incorporating the antimicrobial compositions can inhibit biofilm formation and may reduce the likelihood of these infectious complications.

A further complication encountered in urological catheters is encrustation, a process by which inorganic compounds comprising calcium, magnesium and phosphorous are deposited within the catheter lumen, thereby blocking it. These inorganic compounds are understood to arise from the actions of certain bacteria resident in biofilms on catheter surfaces. Reducing biofilm formation by the action of antimicrobial compositions may contribute to reducing encrustation and subsequent blockage of urological catheters.

Other catheter-like devices exist that can be treated with antimicrobial compositions. For example, surgical drains, chest tubes, hemovacs and the like can be advantageously treated with materials to impair biofilm formation. Other examples of such devices will be familiar to ordinary practitioners in these arts.

Materials applied to the body can advantageously employ the antimicrobial compositions disclosed herein. Dressing materials can themselves incorporate the antimicrobial compositions, as in a film or sheet to be applied directly to a skin surface. Additionally, antimicrobial compositions of the instant invention can be incorporated in the glue or adhesive used to stick the dressing materials or appliance to the skin. Stoma adhesive or medical-grade glue may, for example, be formulated to include an antimicrobial composition appropriate to the particular medical setting. Stoma adhesive is used to adhere stoma bags and similar appliances to the skin without traumatizing the skin excessively. The presence of infectious organisms in these appliances and on the surrounding skin makes these devices particularly appropriate for coating with antimicrobial compositions, or for incorporating antimicrobial compositions therein. Other affixation devices can be similarly treated. Bandages, adhesive tapes and clear plastic adherent sheets are further examples where the incorporation of an antimicrobial composition in the glue or other adhesive used to affix the object, or incorporation of an antimicrobial composition as a component of the object itself, may be beneficial in reducing skin irritation and infection.

A number of medical devices that are required to be sterilized prior to use can be adversely affected by the effects of heat, ethylene oxide, or electron beam irradiation processes that are typically employed in the practice of sterilization. These types of devices include endoscopic devices such as opthalmoscopes, and bioprocessing devices such as extracorporeal dialysis membranes used in hemodialysis applications. Some implantable devices, such as prosthetic heart valves, are similarly adversely affected by commonly used sterilization methods. Tissues used for transplantation can also be adversely affected by sterilization using heat, ethylene oxide, or electron beam irradiation processes.

Chemical sterilization, using biocides, is an accepted alternative for rendering otherwise labile materials sterile. Commonly used biocides for medical device and tissue sterilization include glutaraldehyde, formaldehyde, orthopthalaldehyde, and peracetic acid. When employed at sufficient concentrations and for sufficient contact times, these (and other) chemicals can render devices and tissues sterile.

Reducing chemical concentrations and contact times used in chemical sterilization processes improves device and tissue functionality, and provides an economic benefit to the manufacturer. Reduction of chemical concentrations can be achieved by forming synergistic compositions of the present invention where reduced amounts of chemical compounds achieve the same antimicrobial effectiveness.

These above examples are offered to illustrate the multiplicity of applications of compounds of the invention in medical devices. Other examples will be readily envisioned by skilled artisans in these fields. The scope of the present invention is intended to encompass all those surfaces where the presence of fouling has adverse health-related consequences. The examples given above represent embodiments where the technologies of the present invention are understood to be applicable. Other embodiments will be apparent to practitioners of these and related arts. Embodiments of the present invention can be compatible for combination with currently employed antiseptic regimens to enhance their antimicrobial efficacy or cost-effective use. Selection of an appropriate vehicle for bearing a compound of the invention will be determined by the characteristics of the particular medical use. Other examples of applications in medical environments to promote antisepsis will be readily envisioned by those of ordinary skill in the relevant arts.

Crop Protection

Compositions of the present invention may also be used to form antimicrobial surfaces on plants. Plants refers to any member of the plant kingdom, at any stage of its life cycle, including seeds, germinated seeds, seedlings, or mature plants. Plant cells refer to a cell from a plant or plant component. Plant component refers to a portion or part of a plant. Examples include: seeds, roots, stems, vascular systems, fruits (further including pip fruits, e.g. apples, pears, quinces), citrus fruits (oranges, lemons, limes, grapefruits, mandarins, nectarines), stone fruits (peaches apricots, plums, cherries, avocados, grapes), berries (strawberries, blueberries, raspberries, blackberries), leaves, grains and vegetables. The compositions of the present invention are effective at protecting plants from various organisms that infect plants or plant components. Examples include molds, fungi and rot that typically use spores to infect plants or plant components (e.g. fruits, vegetables, grains, stems, roots). Spores must recognize the host, attach, germinate, penetrate host tissues, and proliferate by hyphae that will allow the fungus to access to nutrients from the plant for growth and reproduction.

In addition to antibiotics such as streptomycin and tetracycline, which are used for treating some bacterial infections of plants, typical antifungal treatments that could be used in combination with the compounds of the present invention include: acetylanilines such as metalazyl; benzimidazoles such as benomyl/MBC; chlorinated nitrobenzenes such as tetrachloronitrobenzene; chloroneb; chlorothalonil; dinitro derivatives such as dinitro-o-cresol; dodine; fenaminosulf; fenarimol and other sterol inhibitors; heavy metals such as copper; heterocyclic nitrogen compounds such as glyodin; oxathiins such as carboxin; quinones such as cloranil; sulfur and sulfur-containing compounds such as dithiocarbamates; terrazole; and tricyclazole. Treatment concentrations and/or contact times could be reduced when these agents are used in combination with compounds of the present invention.

Food Production and Processing

Compositions of the present invention may also be used to form antimicrobial surfaces on equipment and clothing generally used in the food processing or production fields. Compositions of the present invention may be applied by spraying, using a high-pressure washer set at low pressure or, for small areas, a knapsack sprayer.

Disinfection of transport vehicles may prove difficult because of their construction, presence of uneven surfaces, and cold ambient temperatures (Bohm R., 1999). High pressure cleaning with warm water containing the disinfectants of the present invention may be followed by rinsing with hot water. When surfaces are dry, disinfectant at the correct concentration should be applied by spraying all parts of the vehicle, including the bodywork and wheels, and left to act for at least 30 minutes. The interior of the driver's compartment, especially the floor, should be cleaned and disinfected also.

Contaminated footwear may transfer infectious agents from one location to another, especially pathogens shed in feces or urine. Footbaths should be used by all staff and visitors. Unless all personnel wear waterproof footwear, footbaths will not contribute to disease prevention.

Footbaths comprising compositions of the present invention should be changed frequently and the date of change should be recorded. If used constantly on a large farm or unit, the composition should be changed daily or more frequently if there is evidence of gross contamination. Replacement of the composition at 3-day intervals may suffice on smaller units. If gross soiling of footwear is unavoidable, a second footbath with diluted detergent should be placed alongside the footbath for washing of footwear before immersion in disinfectant.

Brief immersion of footwear in a footbath may not be satisfactory as a disease control measure. Immersion of clean footwear to a depth of about 15 cm in an effective amount of the disinfectant composition of the present invention for at least 1 minute is a minimum requirement. Footbaths, located at suitable entry points to a farm or building, should be protected from flooding by surface water or rainfall. Antifreeze compatible with the disinfectant composition may be added in frosty weather. Alternatively, footbaths may be moved indoors at entry points to avoid freezing.

Vehicles visiting farms in succession may occasionally transfer infectious agents on the body of the vehicle or on its wheels. Wheel baths are sometimes used at farm entrances as part of a disease control program.

The design construction and use of wheel baths should ensure that there is adequate contact with the compositions of the present invention for a sufficient time to ensure destruction of infectious agents on the surface of the wheels. The site for installation of a wheel bath should be carefully selected to minimize the risk of flooding, contamination by surface water, or subsidence. The dimensions of the bath should ensure accommodation of the largest vehicles entering the farm. The tire of the largest wheel entering the bath should be completely immersed in disinfectant in one complete revolution.

Wheel baths, which should be built to high specifications, should be waterproof and free of structural defects. No valves or openings that might allow accidental pollution of water courses should be included in the design. The capacity of the bath should allow for heavy rainfall or snowfall without the risk of disinfectant overflow. A depth gauge could be incorporated into the design to indicate dilution or evaporation of disinfectant.

The intervals between changing are important considerations. An advantage of the present compositions is their stability which means they need not be changed as frequently as with other antimicrobial compositions. If wheels have caked organic matter or grease on their surfaces, a wheel bath may have minimal effect.

Transfer of infectious agents from one premise to another on the wheels of vehicles, although possible, is relatively unimportant compared with other sources of infection. The contents of vehicles, including animals and their secretions and excretions, animal feed, and the clothing and footwear of drivers and passengers pose a much greater threat to healthy animals than vehicle wheels.

Antifungal and Antiprotozoan Application

Typical treatments that could be used in combination with the compounds of the present invention include: antibiotics such as avermectin for nematodes; antimony compounds such as lithium antimony thiomalate for Leishmania spp.; atabrine compounds such as quinacrine HCl for malaria (Plasmodium spp. and others); benzimidazole carbamates such as albendazole for GI nematodes; bephenium/thenium compounds such as bephenium hydroxynaphthoate for intestinal nematodes; bisphenols such as bithonol for tapeworms; chlorinated hydrocarbons such as tetrachloroethylene for hookworms; chloroquines such as aralen for malaria (Plasmodium spp. and others); cyanine dyes such as pyrvinium pamoate for pinworms; diamidines such as stillbamidine for Leishmania spp.; diodoquin for amoebae and Giardia spp.; imidazothiazoles such as levamisole for lung worm and GI nematodes; nitroimidazoles such as metronidazole for trichomonads and amoebae; niclosamides such as bayluscide for tape worm; niridazole for schistosomes; organophosphates such as trichlorphon for GI nematodes'; phenothiazine for GI nematodes; piperazines such as diethylcarbamaine for Ascarid and filarial nematodes; sulfonamides such as sulfadimidine for malaria (Plasmodium spp. and others); and suramin for trypanosomes. Treatment concentrations and/or contact times can be reduced when these agents are used in combination with the compounds of the present invention.

Antifouling Agents

A broad range of heavy metals and organic compounds have been and are currently used to minimize or prevent fouling on structures, surfaces and ships hulls exposed to freshwater, marine and brakish systems. Biofouling communities are complex and include a broad diversity of microbes, algae, fungi and invertebrates. Growth of biofouling organisms, and particularly hard foulers like barnacles, mussels and other moluscs do only deteriorate surfaces, but dramatically increase drag on surfaces were they are found. Typical treatments that could be used in combination with the compounds of the present invention include copper oxides, zinc oxides, Tributyltin, SEA Nine 211 (isothiazolones [5-chloro-2-methyl-4-isothizolin-3-one], Irgarol (N—WHNW-butyl-N-cyclopropyl 6-(methylthio)-1,3,5-triazine 2,4 diamine, certain algal derived flavones, other compounds derived from plant natural products (capsacin).

Antimicrobial Agents for Industrial Fluid Treatments

Applications include industrial fluid treatments including cooling water treatments, metal cutting fluid treatments, pulp and paper processing operations, consumer and industrial humidification systems, and fire protection systems. Chemical treatments are used to prevent or treat biological fouling activities, which include reductions in heat transfer efficiency, mechanical blockages, microbially influenced corrosion (MIC), or product contamination. Compounds of the present invention would be used in combination with an existing antimicrobial such as: isothiazolones (5-chloro-2-methyl-4-isothizolin-3-one); organo-chlorine compounds; organo-iodine compounds; peracetic acid, hydrogen peroxide; phenolic agents; quaternary ammonium compounds; sodium bromide; and sodium hypochlorite. Treatment concentrations and/or contact times can be reduced when these agents are used in combination with compounds of the present invention.

### VI. Efficacy of Treatment

The efficacy of treatment with the subject compositions may be determined in a number of fashions known to those of skill in the art.

In one exemplary method, the median survival rate of the microbe or microbial median survival time or life span for treatment with a subject composition may be compared to other forms of treatment with the particular compound of the present invention or antimicrobial agent contained in the subject composition, or with other antimicrobial agents. The decrease in median microbial survival rate or time or life span for treatment with a subject composition as compared to treatment with another method may be 10, 25, 50, 75, 100, 150, 200, 300, 400% less or even more. The period of time for observing any such decrease may be about 3, 5, 10, 15, 390, 60 or 90 or more days. The comparison may be made against treatment with the particular compound or antimicrobial agent contained in the subject composition, or with other antimicrobial agents, or administration of the same or different agents by a different method, or administration as part of a different drug delivery device than a subject composition. The comparison may be made against the same or a different effective dosage of the various agents. The different regiments compared may use microbial levels.

Alternatively, a comparison of the different treatment regimens described above may be based on the effectiveness of the treatment, using standard indicies for microbial infections known to those of skill in the art. One method of treatment may be 10%, 20%, 30%, 50%, 75%, 100%, 150%, 200%, 300% more effective, than another method.

Alternatively, the different treatment regimens may be analyzed by comparing the therapeutic index for each of them, with treatment with a subject composition as compared to another regimen having a therapeutic index two, three, five or seven times that of, or even one, two, three or more orders of magnitude greater than, treatment with another method using the same or different compound of the present invention, antimicrobial agent or combinations thereof.

### Kits

This invention also provides kits for conveniently and effectively implementing the methods of this invention. Such kits comprise any subject composition, and a means for facilitating compliance with methods of this invention. Such kits provide a convenient and effective means for assuring that the subject to be treated takes the appropriate active in the correct dosage in the correct manner. The compliance means of such kits includes any means which facilitates administering the actives according to a method of this invention. Such compliance means include instructions, packaging, and dispensing means, and combinations thereof. Kit components may be packaged for either manual or partially or wholly automated practice of the foregoing methods. In other embodiments involving kits, this invention contemplates a kit including compositions of the present invention, and optionally instructions for their use.

### EXEMPLIFICATION

### Example 1

MBEC bioFilm PA panel—Panel wells are inoculated with planktonic Pseudomonas aeruginosa using a 95 peg inoculation lid. Panels and pegged lids are then incubated at 35° C. for 18 h. Planktonic susceptibility and resistance is determined by measuring inhibition and growth in the presence of antimicrobial agents after incubation. Biofilm susceptibility and resistance is determined by measuring inhibition and growth after peg sonication, biofilm bacteria recovery, then incubation for additional 18-24 h at 35° C.

### REFERENCES

All publications and patents mentioned herein, including those items listed below, are hereby incorporated by reference in their entirety as if each individual publication or patent was specifically and individually incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention.

What is claimed is:

1. A composition comprising a compound and at least one other antimicrobial agent, wherein the compound is represented by formula I: 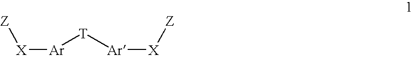
wherein
X represents independently for each occurrence a bond, O, S, or NR′;
Z represents independently for each occurrence H, S(O)₂OH, or optionally substituted alkyl, alkenyl, alkynyl, aryl, heteroaryl, acyl, trialkylsilyl, alkylsulfonyl, fluoroalkylsulfonyl, or arylsulfonyl;
Ar and Ar′ are independently selected from the group consisting of optionally substituted aryl and heteroaryl;
T represents a covalent linker connecting Ar and Ar′, wherein said covalent linker comprises at least one amide, ether, amine or ester moiety;
R′ represents independently for each occurrence H, formyl, or sulfonyl, or optionally substituted alkyl, alkenyl, aryl, aralkyl, acyl, or —(CH₂)ₘ—R₈₀;
R₈₀ represents independently for each occurrence aryl, cycloalkyl, cycloalkenyl, or heterocyclyl; and
m is an integer in the range 0 to 8 inclusive;
or a pharmaceutically acceptable salt thereof;
or wherein the compound is represented by formula II: 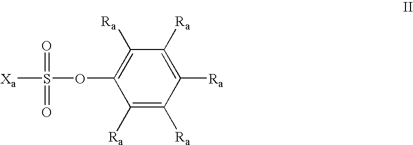
wherein, independently for each occurrence:
Xₐ represents OH, Cl, F, Br, or I; and
Rₐ represents independently for each occurrence H, alkyl, alkenyl, alkynyl, allyl, aryl, aralkyl, heteroaryl, heteroaralkyl, halo, amino, hydroxyl, alkoxyl, thiol, cyano, ester, amido, nitro, formyl, keto, or carboxyl, or pharmaceutically acceptable salts thereof.

2. The composition of claim 1, wherein the composition exhibits a synergistic antimicrobial effect compared to its individual components.

3. The composition of claim 1, wherein X represents O.

4. The composition of claim 1, wherein Z represents H, S(O)₂OH, or optionally substituted alkylsulfonyl, fluoroalkylsulfonyl or arylsulfonyl.

5. The composition of claim 1, wherein X represents O and Z represents S(O)₂OH.

6. The composition of claim 1, wherein Ar and Ar′ independently represent optionally substituted phenyl or naphthyl.

7. The composition of claim 1, wherein X represents O, Z represents independently for each occurrence alkylsulfonyl, fluoroalkylsulfonyl, arylsulfonyl, or S(O)₂OH, and Ar and Ar′ independently represent optionally substituted phenyl or naphthyl.

8. The composition of claim 1, wherein T comprises at least one amido group or at least one amino group.

9. The composition of claim 1, wherein Xₐ is OH or Cl.

10. The composition of claim 1, wherein each Rₐ is independently H, alkyl, or alkenyl.

11. The composition of claim 1, wherein the compound has formula Ia: 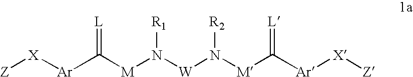
wherein, independently for each occurrence,
X and X′ represent independently a bond, O, S, or NR′;
Z and Z′ represent independently H, S(O)₂OH, or optionally substituted alkylsulfonyl, fluoroalkylsulfonyl or arylsulfonyl, provided that Z and Z′ are not both H;
L and L′ each independently represent O, NR″, or S;
M and M′ independently represent a bond, or a bivalent alkyl or alkenyl chain.
W represents an optionally substituted bivalent alkyl, alkenyl, alkynyl, cycloalkyl, cycloalkenyl, aryl or heteroaryl group, wherein the alkyl, alkenyl or alkynyl groups optionally contain one or more heteroatoms selected from O, S, or NR′″;
R₁ and R₂ represent H, or optionally substituted alkyl, alkenyl, alkynyl, aralkyl, cycloalkyl, aryl or heteroaryl; or R₁ and R₂ may be joined together to form an optionally substituted 4 to 8 membered heterocyclic ring, wherein the ring includes W and the nitrogens to which R₁ and R₂ are attached;
Ar and Ar′ independently represent optionally substituted aryl or heteroaryl;
R′, R″ and R′″ represents independently for each occurrence H, formyl, sulfonyl, or optionally substituted alkyl, alkenyl, aryl, aralkyl, acyl, or —(CH₂)ₘ—R₈₀;
R₈₀ represents independently for each occurrence optionally substituted aryl, cycloalkyl, cycloalkenyl, or heterocyclyl; and
or a pharmaceutically acceptable salt thereof.

12. The composition of claim 11, wherein X represent O.

13. The composition of claim 11, wherein Z and Z′ represent independently for each occurrence H.

14. The composition of claim 11, wherein Z and Z′ independently represent S(O)₂OH, alkylsulfonyl, fluoroalkylsulfonyl or arylsulfonyl.

15. The composition of claim 11, wherein Ar and Ar′ independently represent optionally substituted phenyl or naphthyl.

16. The composition of claim 15, wherein Ar and Ar′ are optionally substituted with at least one member selected from the group consisting of halogen, hydroxy, alkoxy, carboxy, carboxylic ester, nitro, cyano, amino, amido, alkyl, alkenyl, alkynyl, haloalkyl, cycloalkyl, aryl, heteroaryl, oxo, sulfonyl, and sulfonamido.

17. The composition of claim 15, wherein Ar and Ar′ are optionally substituted with at least one halogen.

18. The composition of claim 11, wherein M and M′ are each a bond.

19. The composition of claim 11, wherein at least one of M and M′ is —CH═CH—.

20. The composition of claim 11, wherein L and L′ independently represent O or NR′.

21. The composition of claim 11, wherein W represents a bivalent alkyl or cycloalkyl group, wherein the alkyl group optionally contains one or more heteroatoms selected from O, S, or NR′″.

22. The composition of claim 11, wherein R₁ and R₂ independently represent H, or optionally substituted alkyl; or R₁ and R₂ may be joined together to form an optionally substituted 4 to 8 membered heterocyclic ring, wherein the ring includes W and the nitrogens to which R₁ and R₂ are attached.

23. The composition of claim 22, wherein R₁ and R₂ independently represent H, methyl, ethyl, or propyl.

24. The composition of claim 21, wherein W represents a bivalent cyclohexyl group.

25. The composition of claim 21, wherein W represents —(CH₂)ₙ—, wherein n is an integer ranging from 1 to 12, inclusive.

26. The composition of claim 21, wherein W represents a bivalent alkyl containing one or more heteroatoms selected from O, S, and NR′″.

27. The composition of claim 11, wherein W represents:
—(CH₂)₂—S(CH₂)₂—, —(CH₂)₂—O—(CH₂)₂—O—(CH₂)₂—, —(CH₂)₃—N(CH₃)—(CH₂)₃—, —CH₂CH═CHCH₂—, —CH₂C(CH₃)₂CH₂—.

28. The composition of claim 11, wherein W, R₁ and R₂ together form a piperazine or homopiperazine ring.

29. The composition of claim 1, wherein the compound has formula Ib: 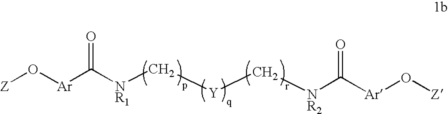
wherein, independently for each occurrence:
Y represents CH₂ or NR′;
R₁ and R₂ independently represent H, or optionally substituted alkyl or aryl, or R₁ and R₂ are joined together to form a optionally substituted 4 to 8 membered heterocyclic ring, wherein the ring includes —(CH₂)ₚ(Y)_{q}(CH₂)ᵣ— and the nitrogens to which R₁ and R₂ are attached;
p and r are 1, 2, or 3;
q is 0 or 1; and
Ar and Ar′ represent substituted phenyl or substituted naphthyl;
Z and Z′ represent independently H, S(O)₂OH, or optionally substituted alkyl, alkenyl, alkynyl, aryl, heteroaryl, acyl, trialkylsilyl, alkylsulfonyl, fluoroalkylsulfonyl or arylsulfonyl, provided that Z and Z′ are not both H;
or a pharmaceutically acceptable salt thereof.

30. The composition of claim 29, wherein R₁ and R₂ independently represent H or alkyl.

31. The composition of claim 29, wherein p and r are each 3.

32. The composition of claim 29, q is 1 and Y is NMe.

33. The composition of claim 29, wherein Ar and Ar′ are independently substituted with at least one member selected from the group consisting of optionally substituted with at least one member selected from the group consisting of halogen, hydroxy, alkoxy, carboxy, carboxylic ester, nitro, cyano, amino, amido, alkyl, alkenyl, alkynyl, haloalkyl, cycloalkyl, aryl, heteroaryl, sulfonyl, and sulfonamido.

34. The composition of claim 1, wherein the compound has formula Ic: 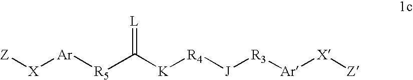
wherein:
Ar and Ar′ represent independently optionally substituted aryl or heteroaryl;
X and X′ represent independently a bond, O, S, or NR′;
Z and Z′ represent independently for each occurrence H, S(O)₂OH, or optionally substituted alkyl, alkenyl, alkynyl, cycloalkyl, aryl, heteroaryl, acyl, trialkylsilyl, alkylsulfonyl, fluoroalkylsulfonyl, or arylsulfonyl;
L represents O, NR′, or S;
J and K independently represent O, S. or NR₆;
R₆ represents independently for each occurrence H, formyl, or sulfonyl, or optionally substituted alkyl, alkenyl, aryl, aralkyl, acyl, or —(CH₂)ₘ—R₈₀;
R₃, R₄ and R₅ represent a bond or optionally substituted bivalent alkyl, alkenyl, alkynyl, aralkyl, cycloalkyl, heterocyclyl, or aryl;
or a pharmaceutically acceptable salt thereof.

35. The composition of claim 34, wherein J is NR₆ and K is O.

36. The composition of claim 34, wherein R₅ is —CH═CH—.

37. The composition of claim 34, wherein R₃ is methylene.

38. The composition of claim 34, wherein R₄ is optionally substituted bivalent alkyl, alkenyl, cycloalkyl, heterocyclyl, or aryl.

39. The composition of claim 34, wherein Z and Z′ are each independently H or S(O)₂OH.

40. The composition of claim 34, wherein Ar and Ar′ are each independently optionally substituted phenyl or naphthyl.

41. The composition of claim 34, wherein:
J is NR₆;
K is O;
R₅ is —CH═CH—;
R₃ is methylene;
R₄ is ethylene;
Z and Z′ are each independently H or S(O)₂OH;
and Ar and Ar′ are each independently optionally substituted phenyl or naphthyl.

42. The composition of claim 1, wherein the compound is selected from the group consisting of: 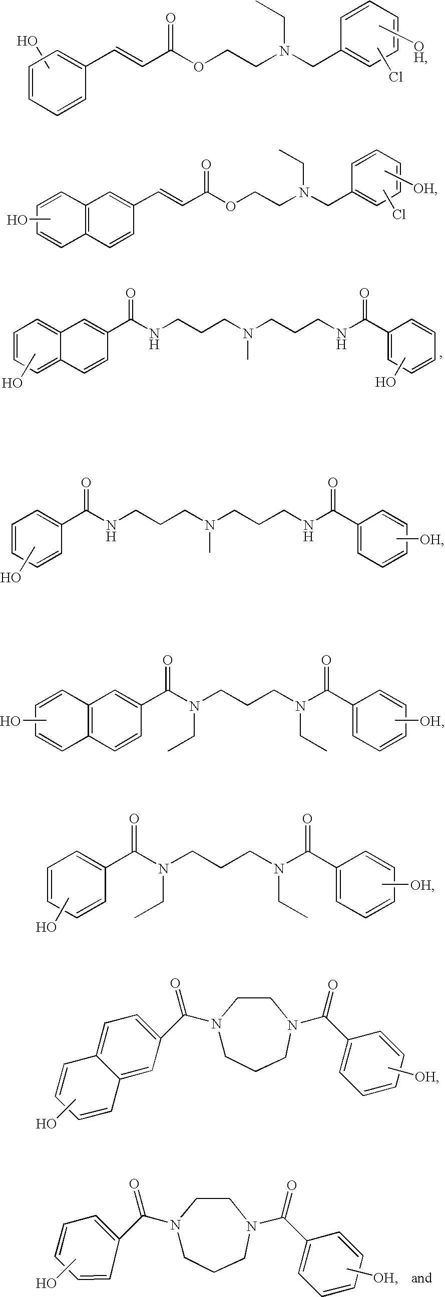
combinations thereof.

43. The composition of claim 1, wherein the compound is selected from the group consisting of: 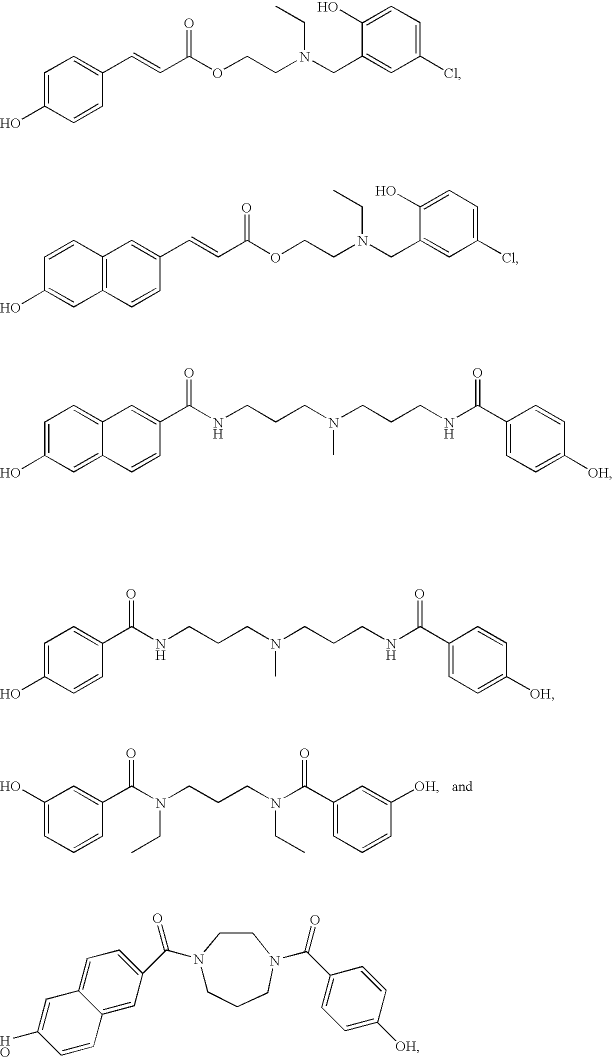
and combinations thereof.

44. The composition of claim 1, wherein at least one Rₐ represents alkyl or alkenyl.

45. The composition of claim 1, wherein at least one Rₐ represents a branched alkyl or substituted alkenyl.

46. The composition of claim 1, wherein the compound has formula Ia: 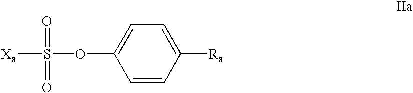
wherein, independently for each occurrence:
Xₐ represents OH or Cl; and
R₁ represents H, alkyl, alkenyl, alkynyl, allyl, aryl, aralkyl, heteroaryl, heteroaralkyl, halo, amino, hydroxyl, alkoxyl, thiol, cyano, ester, amido, nitro, formyl, keto, or carboxyl.

47. The composition of claim 46, wherein Xₐ represents Cl.

48. The composition of claim 46, wherein Xₐ represents OH.

49. The composition of claim 46, wherein Rₐ represents alkyl.

50. The composition of claim 46, wherein Rₐ represents a branched alkyl.

51. The composition of claim 46, wherein Rₐ represents a substituted alkenyl.

52. The composition of claim 46, wherein Rₐ represents a carboxylic acid substituted alkenyl.

53. The composition of claim 46, wherein the compound is selected from the group consisting of 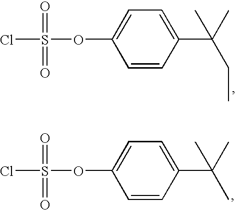 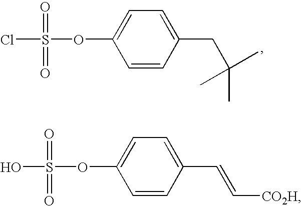
and combinations thereof.

54. The composition of claim 1, wherein the at least one other antimicrobial agent is an antibacterial, antiviral, antiprotozoan, antiprion, or antifungal agent.

55. The composition of claim 1, wherein the at least one other antimicrobial agent is an antibacterial agent selected from the group consisting of cephalosporins, quinolones, fluoroquinolones, penicillins, penicillins and beta lactamase inhibitors, carbepenems, monobactams, macrolides, lincosamines, glycopeptides, rifampin, oxazolidonones, tetracyclines, aminoglycosides, streptogramins, sulfonamides, and combinations thereof.

56. The composition of claim 1, wherein the at least one other antimicrobial agent is an antiviral agent selected from the group consisting of Acyclovir, Cidofovir, Cytarabine, Dideoxyadenosine, Didanosine, Edoxudine, Famciclovir, Floxuridine, Inosine Pranobex, Lamivudine, MADU, Penciclovir, Sorivudine, Stavudine, Trifluridine, Valacyclovir, Vidarabine, Zalcitabine, Zidovudine, Acemannan, Acetylleucine Monothanolamine, Amantadine, Amidinomycin, ATZ, Delavirdine, Foscarnet Sodium, Fuzeon, Indinavir, Interferon-α, Interferon-β, Interferon-γ, Kethoxal, Lysozyme, Methisazone, Moroxydine, Nevirapine, Podophyllotoxin, Ribavirin, Rimantadine, Ritonavir, Saquinavir, Stallimycin, Statolon, Tamiflu, Tromantadine, Xenazoic Acid, and combinations thereof.

57. The composition of claim 1, wherein the at least one other antimicrobial agent is an antifungal agent selected from the group consisting of Amphotericin B, Candicidin, Dermostatin, Filipin, Fungichromin, Hachimycin, Hamycin, Lucensomycin, Mepartricin, Natamycin, nystatin, Pecilocin, Perimycin, Butenafine, Naftifine, Terbinafine, Bifonazole, Butoconazole, Chlordantoin, Chlormidazole, Cloconazole, Clotrimazole, Econazole, Enilconazole, Fenticonazole, Flutirmazole, Isoconazole, ketoconazole, lanoconazole, Miconazole, Omoconazole, Oxiconazole Nitrate, Sertaconazole, Sulconazole, Tioconazole, Tolciclate, Tolindate, Tolnaftate, Fluconazole, Itraconazole, Saperconazole, Terconazole, Azaserine, Griseofulvin, Oligomycins, Neomycin Undecylenate, PyrroInitrin, Siccanin, Tubercidin, Viridin, Acrisorcin, Amorolfine, Biphenamine, Bromosalicylchloranilide, Buclosamide, Calcium Propionate, Chlorophenesin, Ciclopirox, Cloxyquin, Coparaffinate, Diamthazole dihydrochloride, Exalamide, Flucytosine, Halethazole, Hexetidine, loflucarban, Nifuratel, potassium iodide, propionic acid, Pyrihione, Salicylanilide, sodium propionate, Sulbentine, Tenonitrozole, Triacetin, Ujothion, undecylenic acid, zinc propionate, and combinations thereof.

58. The composition of claim 1, wherein the at least one other antimicrobial agent is a disinfectant selected from the group consisting of acetic acid, phosphoric acid, citric acid, lactic, formic, propionic acid, hydrochloric acid, sulfuric acid, nitric acid, sodium hydroxide, potassium hydroxide, sodium carbonate, ammonium hydroxide, ethyl alcohol, isopropyl alcohol, phenol, formaldehyde, glutaraldehyde, hypochlorites, chlorine dioxide, sodium dichloroisocyanurate, chloramine-T, iodine, povidone-iodine, chlorhexidine, hydrogen peroxide, peracetic acid, and benzalkonium chloride.

59. The composition of claim 1, wherein the at least one other antimicrobial agent is a crop fungicide selected from the group consisting of acetylanilines; metalazyl; benzimidazoles; benomyl/MBC; chlorinated nitrobenzenes; tetrachloronitrobenzene; chloroneb; chlorothalonil; dinitro-o-cresol; dodine; fenaminosulf; fenarimol; heavy metals; copper; heterocyclic nitrogen compounds; glyodin; oxathiins; carboxin; quinones; cloranil; sulfur; sulfur-containing compounds; dithiocarbamates; terrazole; and tricyclazole.

60. The composition of claim 1, wherein the at least one other antimicrobial agent is a biocide selected from the group consisting of isothiazolones; 5-chloro-2-methyl-4-isothizolin-3-one; organo-chlorine compounds; organo-iodine compounds; peracetic acid; hydrogen peroxide; phenolic agents; quaternary ammonium compounds; sodium bromide; and sodium hypochlorite.

61. The composition of claim 1, wherein the at least one other antimicrobial agent is an antiprotozoan agent selected from the group consisting of avermectin; antimony compounds; lithium antimony thiomalate; atabrine compounds; quinacrine HCl; benzimidazole carbamates; albendazole; bephenium/thenium compounds; bephenium hydroxynaphthoate; bisphenols; bithonol; chorinated hydrocarbons; tetrachloroethylene; chloroquines; aralen; cyanine dyes; pyrvinium pamoate; diamidines; stillbamidine; diodoquin; imidazothiazoles; levamisole; nitroimidazoles; metronidazole; niclosamides; bayluscide; niridazole; organophosphates; trichlorphon; phenothiazine; piperazines; diethylcarbamaine; sulfonamides, sulfadimidine; and suramin.

62. The composition of claim 1, wherein the at least one other antifouling agent is a heavy metal, copper oxide, zinc oxide, Tributyltin, SEA Nine 211 (isothiazolones [5-chloro-2-methyl-4-isothizolin-3-one], Irgarol (N—WHNW-butyl-N-cyclopropyl 6-(methylthio)-1,3,5-triazine 2,4 diamine, or capsacin.

63. A pharmaceutical composition comprising the composition of claim 1 and a pharmaceutically acceptable carrier or excipient.

64. The composition of claim 63, wherein the composition is formulated for intraveneous administration.

65. The composition of claim 63, wherein the composition is formulated for injectable administration.

66. The composition of claim 63, wherein the composition is formulated for topical application.

67. The composition of claim 63 wherein the composition is formulated as a suppository.

68. The composition of claim 63, wherein the composition is formulated for systemic administration.

69. The composition of claim 63, wherein the composition is formulated for oral administration.

70. The composition of claim 63, wherein the composition is formulated as a spray.

71. The composition of claim 63, wherein the composition is formulated into a coating.

72. A method of treating a subject with a microbial illness comprising administering to a subject in need thereof the pharmaceutical composition of claim 63.

73. The method of claim 72, wherein the microbial illness is otitis media, conjunctivitis, pneumonia, bacteremia, meningitis, sinusitis, pleural empyema, endocarditis, or meningitis.

74. The method of claim 72, wherein the subject is a mammal.

75. The method of claim 74, wherein the mammal is a human.

76. The method of claim 72, wherein the dosage amount comprises 2 to 30 mg/Kg/day of the antimicrobial agent and 1 to 300 mg/Kg/day of the compound of formula I.

77. The method of claim 72, wherein the dosage amount comprises 1 to 4 mg/Kg/day of the antimicrobial agent and 1 to 100 mg/Kg/day of the compound of formula I.

78. The method of claim 72, wherein the dosage amount comprises 0.1 to 400 mg/Kg/day of the antimicrobial agent and 1 to 4000 mg/Kg/day of the compound of formula I.

79. The method of claim 72, wherein the dosage amount comprises 1 to 300 mg/Kg/day of the antimicrobial agent and 5 to 5000 mg/Kg/day of the compound of formula I.

80. A method of disinfecting a surface comprising administering to the surface a composition of claim 1.

81. The method of claim 80, wherein the composition further comprises a coating material selected from the group consisting of phenolic resins, silicone polymers, chlorinated rubbers, coal tar and epoxy combinations, epoxy resins, polyamide resins, vinyl resins, elastomers, acrylate polymers, fluoropolymers, polyesters, polyurethanes, latex, silicone resins, silicone polymers, and silicone heat cured rubbers.

82. The method of claim 81, wherein the composition further comprises a coating material selected from the group consisting of silicone, polyurethane, and water.

83. A coating comprising the composition of claim 1 and a coating material.

84. The coating of claim 83, wherein the coating material is selected from the group consisting of phenolic resins, silicone polymers, chlorinated rubbers, coal tar and epoxy combinations, epoxy resins, polyamide resins, vinyl resins, elastomers, acrylate polymers, fluoropolymers, polyesters, polyurethanes, latex, silicone resins, silicone polymers, and silicone heat cured rubbers.

85. The coating of claim 83, wherein the coating material is selected from the group consisting of silicone, polyurethane, and water.

86. The coating of claim 83, wherein the coating is on the surface of ship hulls, marine and aquatic structures, power plant intakes, or aquaculture nets.

87. An article comprising on its surface the composition of claim 1.

88. The article of claim 87, wherein the article is a machine, medical device, animal, insect, or plant.

89. The article of claim 87, wherein the machine is involved in food processing.

90. The article of claim 87, wherein the medical device is a shunt, artificial heart valve, pacemaker, vascular grafting prostheses, stent, suture, surgical mesh, contact lenses, endotracheal tube, tracheal tube, gastrostomy tube, catheter, artificial larynx, or biliary drainage tube.

91. A kit comprising the composition of claim 1 and instructions for use thereof.
